(19) United States
(12) Patent Application Publication
(10) Pub. No.: US 2016/0027342 A1
(43) Pub. Date: Jan. 28, 2016

(54) MODELING THE AUTONOMOUS NERVOUS SYSTEM AND USES THEREOF

(71) Applicants: Shlomo BEN-HAIM, (US); TYLERTON INTERNATIONAL HOLDINGS INC., Road Town (VG)

(72) Inventor: Shlomo BEN-HAIM, London (GB)

(21) Appl. No.: 14/774,202

(22) PCT Filed: Mar. 11, 2014
(86) PCT No.: PCT/IL14/50246

§ 371 Date: Sep. 10, 2015

Related U.S. Application Data
(63) Continuation-in-part of application No. PCT/IL2014/050090, filed on Jan. 24, 2014.
Application No. PCT/IL2014/050090 is a continuation-in-part of application No. PCT/IL2014/050089, filed on Jan. 24, 2014.
Application No. PCT/IL2014/050089 is a continuation-in-part of application No. PCT/IL2014/050088, filed on Jan. 24, 2014.
Application No. PCT/IL2014/050088 is a continuation-in-part of application No. PCT/IL2014/050086, filed on Jan. 24, 2014.
(60) Provisional application No. 61/875,070, filed on Sep. 8, 2013.
(60) Provisional application No. 61/875,069, filed on Sep. 8, 2013.
(60) Provisional application No. 61/803,611, filed on Mar. 20, 2013.
(60) Provisional application No. 61/875,074, filed on Sep. 8, 2013.
(60) Provisional application No. 61/831,664, filed on Jun. 6, 2013.
(60) Provisional application No. 61/776,599, filed on Mar. 11, 2013.

(51) Int. Cl. G09B 23/30; G09B 5/02

(52) U.S. Cl. CPC G09B 23/30; G09B 5/02

(57) ABSTRACT

Generating, populating and/or using a model of a portion of the ANS, possibly in conjunction with a model of organ response thereto. Optionally, the model is provided with a treatment plan which indicates one or more locations in the ANS to treat. In an exemplary embodiment of the invention, the model is analyzed to determine a cause and/or possible solution or improvement of a condition, for example a chronic condition.

This application claims the benefit of priority and/or under 35 USC 119(e) of the following applications:

U.S. Provisional Patent Application No. 61/776,599 filed Mar. 11, 2013,

U.S. Provisional Patent Application No. 61/803,611 filed Mar. 20, 2013,

U.S. Provisional Patent Application No. 61/831,664 filed Jun. 6, 2013,

U.S. Provisional Patent Application No. 61/875,069 filed Sep. 8, 2013,

U.S. Provisional Patent Application No. 61/875,070 filed Sep. 8, 2013,

U.S. Provisional Patent Application No. 61/875,074 filed Sep. 8, 2013,

And PCT applications (e.g., continuation and/or priority):

“BODY STRUCTURE IMAGING” (PCT application IL2014/050088);

“BODY STRUCTURE IMAGING” (PCT application IL2014/050086);

“NERVE IMAGING AND TREATMENT” (PCT application IL2014/050090); and

“BODY STRUCTURE IMAGING” (PCT application IL2014/050089);

the contents of all of which are incorporated herein by reference in their entirety.

### FIELD AND BACKGROUND OF THE INVENTION

The present invention, in some embodiments thereof relates to generating, making, updating and/or using models of the Autonomous Nervous System (ANS) and/or treatment plans therefore.

The human body has several control systems, including the hormonal system, the central nervous system and the autonomous nervous system (ANS). As traditionally depicted, the autonomous nervous system is (mostly) not under conscious control and serves to regulate various body functions, including, life sustaining functions. For example, basal heart rate, breathing and digestion are controlled by the autonomous nervous system. In some classifications, the portion of the autonomous nervous system which relates to digestion is termed the enteric nervous system (ENS).

FIG. 1 shows the components of an autonomous nervous system (ANS) 100, in schematic form. As can be seen, the ANS includes a network of ganglions, also termed ganglionic plexi (GP). Nerve fibers meet and synapse (e.g., interact with each other, for example using synapses) at the ganglions. As described below, the terms GP and ganglion are also used herein as a general placeholder for nervous tissue where interactions between nerves and tissue (e.g., other nerves) occurs.

A spinal column 102 provides both sympathetic and parasympathetic enervation. As shown, parasympathetic enervation 106 may proceed directly to organs 114 and/or to secondary ganglia 110. Sympathetic enervation may be modulated by spinal ganglia 104 and then feed (108) into secondary ganglia 110 or organs 114. In many cases, the sympathetic and parasympathetic enervation interact at the secondary ganglia 110 (e.g., Ciliary, Celiac, etc.). Secondary ganglia 110 may be connected directly to nerve endings 112 at an organ 114. In some cases, an intermediary network or chain of ganglia exists as well (not shown).

The ANS is generally considered to include two main functional layers, the sympathetic nervous system (SNS), generally in charge of excitatory and increased responsiveness and control and the para-sympathetic nervous system (PNS), generally in charge of damping responsiveness and control. For example, heart rate is increased by increased activity of the SNS and decreased by increased activity of the PNS. In some organs, such as the heart, the nerve fibers of the SNS and nerve fibers of the PNS meet at certain ganglions. Ganglions which include both SNS fibers and PNS fibers utilize a balance between the excitations of the SNS and PNS to determine their behavior.

The ANS includes both afferent (leading towards the innerverated tissue) and efferent fibers (leading away from the innerverated tissue).

From a perspective of diagnosis, it is recognized that malactivity of the ANS can cause body dysfunction, for example, in atrial fibrillation. Furthermore, general ANS tone is considered to be related to some diseases such as high blood pressure. Damage to the ANS can sometimes occur, causing organ dysfunction, for example, in transplanted organs.

From a perspective of treatment, some examples of treating an undesired condition by ablating a part of the ANS have been suggested.

Additional background art includes U.S. Patent Application Publication Nos. 2006/0287648 and 2013/0123773.

### SUMMARY OF THE INVENTION

There is provided in accordance with some embodiments of the invention a non-transitory data storage medium having stored thereon a model or an image of a part of an ANS personalized for a particular patient, said model or image including at least one ganglion indicator.

In some exemplary embodiments of the invention, said model is organized as a spatial map.

In some exemplary embodiments of the invention, said ganglion indicator comprises a ganglion ID.

In some exemplary embodiments of the invention, the medium comprises at least one location indicator, optionally comprising a location relative to an anatomical landmark and/or a location in a body or organ coordinate system and/or an association with an organ portion or function and/or a functional connection with another ganglion.

In some exemplary embodiments of the invention, the medium comprises static data associated with at least one of said ganglions. Optionally, said static data comprises one or more of maximum or average activation level and size.

In some exemplary embodiments of the invention, the medium comprises dynamic data associated with at least one of said ganglions. Optionally, said dynamic data is stored as statistics of dynamism of the ANS. Optionally or alternatively, said dynamic data is stored as time-dependent data. Optionally or alternatively, said dynamic data is stored as a generative function. Optionally or alternatively, said dynamic data comprises data for a single ganglion. Optionally or alternatively, said dynamic data comprises data for interaction between a ganglion and one or more of an additional ganglion, organ function, body physiology and a trigger.

In some exemplary embodiments of the invention, the medium comprises link data associated with at least one of said ganglions. Optionally, said link data comprises an anatomical link. Optionally or alternatively, said link data comprises a functional link.

In some exemplary embodiments of the invention, the medium comprises input data associated with the model, which indicate inputs which affect the model.

In some exemplary embodiments of the invention, the medium comprises innervation data associated with the model. Optionally, said innervations data comprises a linkage of organ portions to a ganglion. Optionally or alternatively, said innervation data comprises an intensity of innervation of an organ portion.

In some exemplary embodiments of the invention, said ganglions are arranged as a network. Optionally or alternatively, said ganglions are arranged as a hierarchy.

In some exemplary embodiments of the invention, said indicators are stored as a set of parameters for a model of a portion of the ANS.

In some exemplary embodiments of the invention, the medium comprises a set of parameters for a model of at least a portion of an organ associated with said ganglions.

In some exemplary embodiments of the invention, said ganglions include ANS ganglions separated at least one synapse from a spinal column and brain.

In some exemplary embodiments of the invention, said ganglions include one or more ANS ganglions of a size between 1 and 10 mm in maximum diameter.

In some exemplary embodiments of the invention, the medium comprises an indication of a person from which the model was acquired.

In an exemplary embodiment of the invention, the medium is further including thereon a treatment plan including an indication of at least one target linked to said ANS model. Optionally, said indication of at least one target includes an indication of location using a map, image or anatomical coordinates.

In some exemplary embodiments of the invention, there is provided a system comprising a medium according as described herein, and further comprising a processor and a display device, said processor configured to generate a display on said display device using said indications.

In some exemplary embodiments of the invention, there is provided a system comprising a processor configured to process radioactive emission data to generate a medium as described herein.

There is provided in accordance with some embodiments of the invention a method of displaying a portion of an ANS, comprising providing a model of a portion of the ANS and rendering a display include visual markers corresponding to at least part of said model.

In some embodiments of the invention, said rendering comprises rendering with an anatomical image of an organ associated with said model. Optionally, said rendering comprises rendering with dynamic motion of said organ. Optionally or alternatively, said rendering comprises rendering in 3D. Optionally or alternatively, said rendering comprises schematic rendering. Optionally or alternatively, said rendering comprises rendering dynamically changing data. Optionally or alternatively, said rendering comprises rendering a tool location. Optionally or alternatively, said rendering comprises rendering a trigger and an effect on ANS and/or organ behavior. Optionally, the method comprises showing an ongoing simulation based on said model and on multiple triggers or inputs.

In some embodiments of the invention, said rendering comprises rendering with additional non-ANS real-time data. Optionally, said real-time data comprises electrical data.

In some embodiments of the invention, said rendering comprises calculating an affect of modifying the model and rendering said effect.

In some embodiments of the invention, said rendering comprises rendering an animation loop.

There is provided in accordance with some embodiments of the invention a method of generating body data, comprising creating, for example by a processor, a model of a portion of the ANS associated with an organ or a portion thereof. Optionally, said model includes a plurality of ganglions. Optionally or alternatively, said model includes the functionality of at least a portion of said organ. Optionally or alternatively, the method comprises stimulating said body in order to affect or assist in acquiring said model.

In an exemplary embodiment of the invention, creating a model comprises creating a model of behavior of at least one of said ganglions. Optionally or alternatively, creating a model comprises assuming a certain behavior characteristic on at least one ANS component.

There is provided in accordance with some embodiments of the invention a method of obtaining a model of a portion of the ANS, comprising:

acquiring data from a portion of the body; and

extracting data relating to the ANS from the acquired data. Optionally, said acquiring comprises acquiring radioactive emission data. Optionally or alternatively, said extracting comprises extracting data based on a model of an organ for which said model is acquired. Optionally, said extracting comprises extracting data based on a distance from a boundary of said model. Optionally or alternatively, said extracting comprises extracting data based on an expected size of ganglions. Optionally or alternatively, said extracting comprises extracting data based on an expected spatial arrangement of ganglions.

In some embodiments of the invention, said extracting comprises extracting data based on an expected temporal behavior of components of the ANS.

In some embodiments of the invention, the method comprises stimulating said ANS in coordination with said acquiring.

In some embodiments of the invention, said acquiring comprises acquiring image data and reconstructing an image.

In some embodiments of the invention, said extracting comprises segmenting said image.

In some embodiments of the invention, said extracting data base don its being outside an organ for which said ANS is modeled.

In some embodiments of the invention, the method comprises matching said extracted data to a model.

In an exemplary embodiment of the invention, the method comprises populating a model using said extracted data.

In an exemplary embodiment of the invention, the method comprises using said extracted data for one or both of modeling behavior of ANS components and modeling the relationship between ANS components.

There is provided in accordance with some embodiments of the invention a method of diagnosis, comprising:
providing a model of the ANS of at least a part of an organ; and analyzing said model to identify at least one disease condition. Optionally, said analyzing comprises identifying an abnormality in said model. Optionally, said abnormality comprises an abnormality in one or more individual ganglions. Optionally or alternatively, said abnormality comprises an abnormality in a temporal or spatial relationship between two ganglions. Optionally or alternatively, said abnormality comprises an abnormality in relative behavior of ganglions. Optionally or alternatively, said abnormality comprises an abnormality in a matching up between one or more ganglions and organ structure. Optionally or alternatively, said abnormality comprises an abnormality in a matching up between one or more ganglions and organ function. Optionally or alternatively, said abnormality comprises an abnormality in a dynamic response of one or more ganglions. Optionally or alternatively, said abnormality comprises an abnormality in a dynamic response of an organ functionality to activation of one or more ganglions. Optionally or alternatively, said abnormality comprises an abnormality in a ganglion behavior of one or more ganglions as compared to ganglions in other parts of the body. Optionally or alternatively, said abnormality comprises a lack of stability in dynamic behavior of one or more ganglions.

In some exemplary embodiments of the invention, identifying comprises identifying by comparing to one or more templates of diseases. Optionally, said one or more templates include at least one dynamic template.

In some exemplary embodiments of the invention, said analyzing comprises measuring ganglion states with high amplification.

In an exemplary embodiment of the invention, said analyzing comprises identifying ganglions which generate extra minima or high organ activity.

In some exemplary embodiments of the invention, said providing comprises acquiring said model according to a suspected disease state.

There is provided in accordance with some embodiments of the invention a method of treatment selection, comprising:

providing a model of at least part of an ANS associated with an organ;

selecting a treatment which will (a) affect at least one of the structure and functioning of the ANS; (b) affect an input to an ANS; and/or (c) affect a response of said organ to said ANS. Optionally, said treatment comprises ablating a portion of said ANS. Optionally, said treatment comprises reducing a stimulatory input to said ANS. Optionally or alternatively, said treatment comprises increasing a stimulation of a portion of said ANS. Optionally or alternatively, said treatment comprises modifying an input to said ANS. Optionally or alternatively, said treatment comprises modifying a response of said organ to said ANS. Optionally or alternatively, said treatment comprises modifying a functioning of said ANS. Optionally or alternatively, said treatment comprises modifying a structure of said ANS. Optionally or alternatively, said treatment is selected to have a long term effect of remodeling the ANS.

In some exemplary embodiments of the invention, the method comprises applying said treatment. Optionally, said treatment is applied to a plurality of ganglions. Optionally or alternatively, said treatment comprises drug delivery. Optionally or alternatively, said treatment comprises non-damaging electrical stimulation. Optionally or alternatively, said treatment is provided using an implant.

In an exemplary embodiment of the invention, selecting a treatment comprises selecting a treatment based on a functional distance a target of said treatment form a target organ and on difference in side effects determined by said distance and the degree to which the target affects efferent vs. afferent nerves.

There is provided in accordance with some embodiments of the invention a method of treatment for a patient, comprising:

providing a model of a portion of the ANS;

treating the patient;

acquiring an indicator derived from the model; and

modifying, stopping, changing or repeating said treating based on value of said indicator as compared to the model. Optionally, said indicator is acquired during treatment. Optionally or alternatively, said indicator comprises an updated model. Optionally or alternatively, said indicator comprises an updated portion of said model.

There is provided in accordance with some embodiments of the invention a method of ANS diagnosis, comprising:

administering a bioactive material or other stimulation to a patient which affects different ANS conditions in different ways; and

determining if and/or how to further diagnose an ANS of the patient by building a model, based on a reaction to said administering. Optionally or alternatively, the bioactive material comprises a beta blocker. Optionally or alternatively, the bioactive material or other stimulation is selected to directly affect an ANS component.

There is provided in accordance with some embodiments of the invention a non-transitory data storage medium having stored thereon a model or an image of a part of an ANS personalized for a particular patient.

There is provided in accordance with some embodiments of the invention a non-transitory data storage medium having stored thereon an ANS indicator used for diagnosing or treating a patient.

There is provided in accordance with some embodiments of the invention a non-transitory data storage medium having stored thereon a set of ganglion indicators and at least one location indication for a ganglion associated with a ganglion indicator.

There is provided in accordance with some embodiments of the invention a method of selecting a treatment for an ANS mediated condition, comprising:

providing a model of at least a portion of the ANS of a patient;

determining the relative or absolute merit of a potential target based on both an expected type and/or severity of side effect and one efficacy of treatment.

There is provided in accordance with some embodiments of the invention apparatus for planning a treatment for an ANS mediated condition, comprising:

an input which receives a personalized ANS model providing a model of at least a portion of the ANS; and

a planning module which evaluates a proposed plan as to ability to effect a desired treatment via an ANS mediated effect, said evaluation using said model. Optionally, the apparatus comprises a plan generating module which generates a proposed plan based on said model.

There is provided in accordance with some embodiments of the invention apparatus for diagnosis of an ANS mediated condition, comprising:

an input which receives a personalized ANS model providing a model of at least a portion of the ANS; and

a diagnosis module which evaluates a proposed diagnosis based on a fit with a behavior of said model.

There is provided in accordance with some embodiments of the invention apparatus for treatment of an ANS mediated condition, comprising:

an input which receives a treatment plan including at least one ANS target and at least one of an additional ANS target, a logic, a measurement command and an ablation parameter; and

at least one processor configured to monitor a treatment process with respect to deviation from said treatment plan.

There is provided in accordance with some embodiments of the invention a non-transitory data storage medium having stored thereon a treatment plan comprising one or both of a plurality of ANS targets and an alternative or a logic to apply. Optionally, the medium has stored thereon a time line indicating at least a partial order in time on said targets.

It should be appreciated that the above described various options. Any particular implementation may include one or more of the options and the exemplary embodiments described. In particular, each section entitled “there is provided” may be provided with any of the options and exemplary features and/or limitations following it and all combinations and sub-combinations thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic showing of the autonomous nervous system of a human;

FIG. 2A is a schematic showing of a model of an organ and an ANS thereof, in accordance with some exemplary embodiments of the invention;

FIG. 2B is a schematic showing of a model of a hierarchal or networked ANS portion, in accordance with some exemplary embodiments of the invention;

FIG. 2C is a schematic showing of a model of a multiple ANS portions, in accordance with some exemplary embodiments of the invention;

FIG. 3A is a flowchart of a method of obtaining ANS information, in accordance with some exemplary embodiments of the invention;

FIG. 3B is a flow chart of a computer-implemented method for combining the functional and anatomical images and/or locating the GPs, in accordance with some embodiments of the present invention;

FIG. 4 illustrates a method of information collection, in which a probe including a position sensor and a radiation sensor is used to identify one or more ANS components, in accordance with some embodiments of the invention;

FIG. 5 is a flowchart showing methods of using a model of the ANS, in accordance with exemplary embodiments of the invention;

FIG. 6 is a representation of a data format for a model of the ANS, in accordance with exemplary embodiments of the invention;

FIG. 7A is a block diagram of a system for acquiring and/or using a model of the ANS, in accordance with exemplary embodiments of the invention;

FIG. 7B is a block diagram of an image/data acquisition system for use together with modeling, in accordance with exemplary embodiments of the invention;

FIG. 8 is a block diagram of a model analysis and treatment planning system/unit, in accordance with exemplary embodiments of the invention;

FIG. 9 is a flowchart of a method of populating a model in accordance with exemplary embodiments of the invention;

FIG. 10A is a diagram shown a simple schematic GP model, possible behaviors of GPS and an organ and possible outcomes of treatment, in accordance with exemplary embodiments of the invention;

FIG. 10B is a chart of a prophetic example showing the effect of systemic drug provision to treat an ANS disorder, in accordance with exemplary embodiments of the invention;

FIG. 10C is a flowchart of diagnosis and treatment selection in accordance with exemplary embodiments of the invention;

FIG. 11A is a schematic showing a network of an ANS and organs illustrating the effect of various treatment options, in accordance with some embodiments of the invention;

FIG. 11B is a time line showing an exemplary treatment plan, in accordance with some embodiments of the invention;

FIG. 11C is a flowchart of a method of generating a treatment plan, in accordance with some embodiments of the invention;

FIG. 11D is a flowchart of a method of applying treatment, in accordance with some embodiments of the invention; and

FIG. 11E is a schematic block diagram of a treatment system, in accordance with some embodiments of the invention.

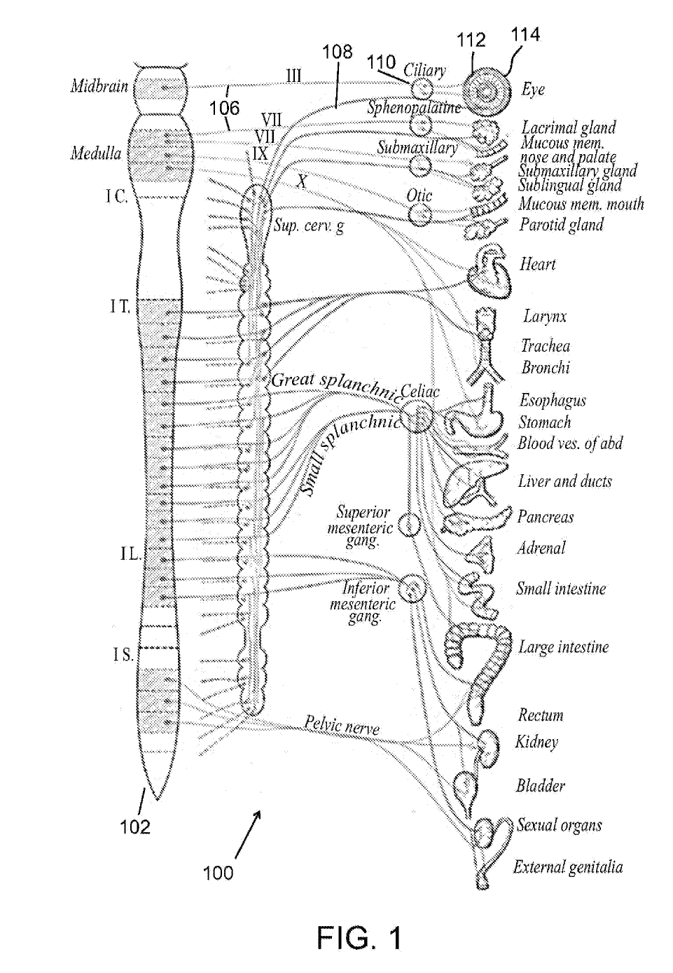

### DESCRIPTION OF SPECIFIC EMBODIMENTS OF THE INVENTION

### Overview

The present invention, in some embodiments thereof relates to generating, making, updating and/or using models of the Autonomous Nervous System (ANS), sometimes referred to below as ANS models and/or treatment plans for the ANS.

A broad aspect of some embodiments of the invention relates to obtaining structural and/or functional data about the ANS and/or ANS activity as it relates to an organ or a portion thereof. In some exemplary embodiments of the invention, this data may be used for diagnosis and/or treatment guidance. Some aspects of some embodiments of the invention relate to contrast materials including radioactive tracers and/or imaging methods and/or data processing methods used for such obtaining.

In some exemplary embodiments of the invention, while the obtained data relates to a particular organ or apart thereof, it may be modeled and/or analyzed in the context of other organs and/or other ANS portions and/or components and/or portions of the particular organ and/or other physiological components or subsystems or portions of the body.

In some exemplary embodiments of the invention, prior information regarding the ANS may be used to organize information (e.g., data collected) about the ANS, e.g., for making and/or updating the ANS model. For example, the prior information may comprise one or more of possible locations of components of the ANS, their numbers, their possible hierarchy, their possible response to stimuli, and/or other prior information for example as described below. Organization may include, for example, storage, display, analysis and/or processing.

In some exemplary embodiments of the invention, the obtained data (e.g., structural and/or functional data) may be used to generate a model of a part of the ANS (e.g., one or more components of the ANS). In some embodiments of the invention, the model may reflect propagation and/or processing of information by the ANS.

In some exemplary embodiments of the invention, the obtained information may be used to generate a model of a part of the ANS and part of the controlled organ. In some embodiments of the invention, the model may reflect the interaction between the ANS and the controlled organ.

In some exemplary embodiments of the invention, the obtained information may be used to generate a model of a part of the ANS that reflects the ANS relevant information with respect to afferent stimuli (e.g., a demonstration of an over active sympathetic ganglion in the presence of a stretched aorta, high renin levels, a depressed blood pressure and/or a low glucose level).

In some exemplary embodiments of the invention, the obtained information may be used to generate a model of a part of the ANS that reflects the ANS relevant information with respect to an efferent stimuli (e.g., a demonstration of over active sympathetic discharges on the kidney, for example, by measuring the end-organ sympathetic activity, in the presence of a stretched aorta or in a patient with high renin levels or in a patient with depressed blood pressure or in a patient with low glucose level).

In some exemplary embodiments of the invention, the obtained information may be used to generate a model of a part of the ANS that reflects the mode (or state or level of excitation) of the ANS or a part thereof, e.g., by analyzing a relationship between afferent effects and efferent stimuli. In some cases, this mode may be evaluated without directly acquiring information from the ANS itself. In one example, the model of the ANS may be generated and/or updated by studying the input/output functions of the system (e.g., organ) or part of the system and performing an analysis that will shed information on the state (mode) of the ANS. In other embodiments, such data may be used, but direct measurement of nerves, possibly nerves that are not in direct contact with the organ, is used.

In some exemplary embodiments of the invention, rather than simply define a casual relationship between an input and an output, a model of the ANS (e.g., a set of linear or differential equations) is matched with actual measurements. Optionally, one or more stimuli to the ANS are provided to provide boundary condition information and/or calibration points.

In some exemplary embodiments of the invention, the collected data (e.g., structural and/or functional data) is arranged in the form of a map and/or used to set parameters of a previously defined model. In some embodiments of the invention, the model may be correlated with a body structure, such as an organ or a portion thereof and/or optionally displayed therewith as a map.

In an exemplary embodiment of the invention, the model or map includes a location indicator, which can, for example, indicate a relative or absolute spatial and/or functional (e.g., connection) position of an ANS component relative to other components and/or anatomical landmarks (e.g., possibly a Cartesian position or a distance from one or more landmarks). In some cases a functional distance between an ANS component and another body element is indicated, for example, indicating the number and/or other measure of synaptic connections and/or interactions between the ANS component and the other component.

Some embodiments of the invention relate to visualizing information about the ANS, in particular measured and/or predicted information relating to a particular person, organ and/or physiological state. In an exemplary embodiment of the invention, visualization is used to provide or increase clarity with respect to a state of a patient and or an ANS and/or organ function thereof.

In some embodiments of the invention, such a map and/or non-spatially displayed model and/or a visualization of a model may be used for one or more of diagnosis, treatment selection, treatment guidance, device implantation guidance and/or monitoring.

In some embodiments, an ANS model may include ganglion(s), e.g., the ANS model may be based on a mapping between ganglions in a particular organ or part thereof and parts of the model. In some exemplary embodiments of the invention, ANS components for which data is acquired include specifically ganglions which are directly connected, in contact with and/or embedded in an organ of interest. In some cases, data about distanced ganglions may be acquired and/or used in a model. Optionally, the ganglions to be included in a model are ganglions in or near an organ, and, if needed, ganglions distanced from the organ. The relevant distance may depend on the organ. For example, the following numbers may be useful: for the kidney, 7-12 cm, for the heart 0.5-1.5 cm or 7-20 cm, depending on the type of ganglia and/or the function of interest.

A broad aspect of some embodiments of the invention relates to considering diseases as a dysfunction of an ANS control system. In some embodiments of the invention, a disease is considered in context of a controlling of the ANS to drive an organ in a dysfunctional manner. In some exemplary embodiments of the invention, such considering is provided by generating and using a model of the ANS and its interaction with an organ. In some embodiments, diagnosis is considered in the context (also) of ANS having an abnormal behavior due to and/or feeding back to tissue function and/or structure abnormalities.

A broad aspect of some embodiments of the invention relates to visualizing information about the ANS, in particular measured and/or predicted information relating to a particular person, organ and/or physiological state.

A broad aspect of some embodiments of the invention relates to using a representation of ANS structure, function and/or activity for diagnosis and/or treatment. In some embodiments, an ANS model may include representation of ANS structure (e.g., one or more ANS components—for example: ganglions, function and/or activity).

A broad aspect of some embodiments of the invention relates to modeling the ANS. In exemplary embodiments of the invention, the modeling includes modeling components and/or behaviors in a manner commensurate with diagnostic and/or treatment needs. In some embodiments, the modeling may be commensurate with data acquisition ability. In one example, statistical information about GP activity is collected, rather than activity about each GP. This may be easier to collect, while still providing differential diagnosis. In exemplary embodiments of the invention, an ANS model to be used is selected from several available models according to one or more of data acquisition ability, diagnostic need and/or treatment needs.

A broad aspect of some embodiments of the invention relates to the understanding that each organ and/or part of an organ has its own “wired” control system. In one example, the control system is a ganglia receiving input from the organ (or brain) and processing such input and sending the output of such processing to organ. In some cases, the control system comprises a plurality of ganglia. In other cases, the control system comprises a single ganglia. In some cases, at least some input come from outside the organ and/or some processing is outside the organ. The processing of the input can be modulated, for example, by inputs to the ganglia coming from various sources including one or more of the organ itself, input from higher or same level of the ANS (e.g., dorsal root ganglia, organ nerves), inflammatory proteins, environment (e.g., hormonal factors, such as cortisone or pharmaceuticals). The processing by a ganglion or a processing network including a single or plurality of ganglions can operate, for example, in discrete modes and/or in a manner defined by a continuous function (e.g., per mode or shared by several modes). A continuous function may be represented as a set of modes, optionally overlapping and/or otherwise having fuzzy boundaries there-between and/or as a mode with sub-modes.

As may be appreciated, modulation of a processing mode of the ganglia can dramatically change the function of the ganglia. For example, under certain conditions an increase in sympathetic afferent activity can be processed in the ganglia under a mode which causes an increase parasympathetic efferent transmission and decreased sympathetic efferent transmission. This reflex of a positive-negative feedback loop is a typical control mechanism underlying many instances of Homeostasis.

However, under certain conditions (e.g., stress, fever, alcohol ingestion . . . ) the ganglion processing mode can change to a mode where the processing will be different; an increase in sympathetic afferent activity will cause increase sympathetic efferent transmission and decreased parasympathetic efferent transmission; this reflects on what is termed a Sympatho-Sypathtetic reflex. This reflex of a positive-positive feedback loop under certain conditions will lead to continuous stimulation of the ganglia and will drive the organ away from its normal function during homeostasis. In yet another mode of processing, a decrease in sympathetic afferent activity will cause a decrease in sympathetic efferent transmission and an increased parasympathetic efferent transmission, for example reflecting a Vago-Vagal reflex. This reflex of a negative-negative feedback loop will, under certain conditions, lead to continuous attenuation of the function of the organ of the ganglia and may again drive the organ away from its normal function during homeostasis.

In exemplary embodiments of the invention, diagnosis is provided to identify such mode changes, changes in the continuous function and/or causes thereto. Optionally or alternatively, treatment may comprise treating the patient so as to change the mode of activity and/or function of the control system, for example, by control of a baseline activity level.

In some embodiments, the processing mode is identified and/or utilized at the ganglion level, at a network level and/or at multi-organ level.

In some embodiments, a processing mode of a ganglion or processing network is modified by affecting a ganglion or other input outside the network. In some embodiments, mode is affected by stimulating (e.g., including reducing a stimulation level) of afferent fibers.

In some exemplary embodiments of the invention, an ANS model and/or analysis thereof includes one or more causal relationships indicating a relationship between stimulation at one or more locations (e.g., at one or more ganglions or organ locations) and an effect on organ function and/or efferent excitation thereof.

An aspect of some embodiments of the invention relates to collecting information about mid-level portions of the ANS including, for example, ganglions (GP) of maximum diameter (e.g., extent containing 90% of synapses thereof) of between 0.01 and 20 mm in diameter, for example, of maximum diameter of between 1 and 10 mm. In exemplary embodiments of the invention, the GPs about which information is collected are at least one or two synapses/network connections removed from the spinal column (e.g., as opposed to GPs which are connected by an axon to the spinal column.

In exemplary embodiments of the invention, an ANS model (e.g., a generated model) of a portion of the ANS includes at least 2 GPs, optionally, 3, 4 or more. In exemplary embodiments of the invention, the GPs are interconnected by axons, with or without intermediate synapses. In some embodiments, the model may include additional components. For example, a model may include low-level ganglions (e.g., with diameter of between 50 and 250 microns). Optionally or alternatively, the model may include density of innervation of target tissue.

In exemplary embodiments of the invention, an ANS model (e.g., generated model of a portion of the ANS and a portion of the controlled organ) includes at least 1 GPs, optionally, 2, 3, 4 or more and, optionally, a representation of the end organ the GP is or are connected with. In exemplary embodiments of the invention, the GPs are interconnected by axons, with or without intermediate synapses.

In exemplary embodiments of the invention, a model may indicate coupling between an organ and the GPs, for example, proximity and/or innervation.

In exemplary embodiments of the invention, an ANS model includes at least two levels of GPs. In some embodiment, modeling an ANS model may include identifying one or more levels of GPs. In some embodiments, a GP of a first level may differ from a GP of a second level by its size, relative position to the controlled organ, activity level, spatial location to one or more additional GPs and/or other properties, for example, as known in hierarchical control models and network analysis).

In an exemplary embodiment of the invention, the GP is treated as part of the organ control system, for example, with signals from the organ going to the GP for processing and then feeding back to the organ, going to other GPs, other organs and/or the brain.

In exemplary embodiments of the invention, an ANS model includes both excitatory and inhibitory nerve information. Optionally or alternatively, an ANS model includes both afferent and efferent nerve information.

In some exemplary embodiments of the invention, an ANS model may represent for at least one of the GPs, contribution, optionally, relative contribution from two or more of efferent, afferent, sympathetic and/or parasympathetic nerves.

In some exemplary embodiments of the invention, an ANS model may be a 4D model representing a change in activity as a function of time. In some exemplary embodiments of the invention, such a model is visualized in 2D or 3D. Optionally, this change is associated with additional data, such as an identity of an external trigger and/or identification of an internal trigger (e.g., organ function). Optionally, the change as a function of time includes sympathetic and/or parasympathetic information.

In some exemplary embodiments of the invention, change as a function of time includes one or both of responses to a trigger event and responses to stable stimulation.

Optionally or alternatively, the model may include additional dimensions of information, for example, the activity of linked parts of the ANS, hormone levels, activity levels and/or other physiological parameters. In some cases, this information is not part of the model, per se, but is displayed therewith.

In some exemplary embodiments of the invention, the model includes tag information for various layers, for example, identification of GPS that resonate together (e.g., in phase or out of phase). In some embodiments, tagging is provided as part of visualization and not as part of the model.

In some exemplary embodiments of the invention, the model includes information about particular GPs, for example, an estimation of their excitation state, an estimation of their transfer function (which may be state dependent), a degree of nearby physical stimulation (e.g., inflammations, pressure), and/or damage (e.g., due to trauma or intentional ablation).

While in some embodiments of the invention the model may be visualized in an anatomically correct or partially correct manner (e.g., showing real distances between GPs, shown overlaid on a 3D structure of an organ), in other embodiments, the visualization may be additionally or alternatively functionally. In some cases, the visualization is a 2D schematic showing the connection between various parts of the ANS and/or with various parts of an organ or portion thereof. Optionally, the organ may be shown schematically or other low information view and/or in a projection or cross-sectional view. In another example, the organ is shown in gray scale, and the ANS model and/or functionality shown in color.

In general, various parts of the model may have different levels of confidence, for example, a part may be measured, estimated, assumed in one condition and predicted for a different condition. In some embodiments, the model may include an output that defines rules for the expected behavior of the organ given alterations in the organ function or the controller function or state (mode).

In general, a state (e.g., general functional behavior, such as positive-positive) of a part of the ANS may be derived, for example, by one or more of measuring the activity of the ANS directly or indirectly, by measuring the effect of the ANS on a function or an organ it controls (e.g., measuring the function) and/or by measuring the function of its commanding centers. In one example, it is assumed that an organ controller (e.g., GP or GP network) adjacent to an organ reports to a higher command center(s), so looking at the function of such center either directly or indirectly such as by measuring its activity or its effect on other controlled organs can supply information about the state of the controller in question.

It should be noted that while the focus of the description of the model is on ganglions, the model need not include ganglions and/or may include other ANS components, for example, axons and end-receptors.

In exemplary embodiments of the invention, the brain is treated as a part of the ANS model, for example, by considering the ANS system as a nested controller system. Different scaling factors may apply, as well as locality, for example, individual GPS may be more useful for analyzing local activity. Some organ activity may have measurable effect in the brain, while brain stimulation may be used to modify or detect (e.g., using synchronous detection) organ activity. Optionally or alternatively, the brain and/or parts thereof and/or associated systems are treated as an organ being controlled by a part of the ANS.

An aspect of some embodiments of the invention relate to visualization of an ANS model as a spatial display and/or generation and/or analysis of an ANS model which may then be visualized. In exemplary embodiments of the invention, while the display is spatial, the visualization may be of functional nature, arranged spatially. Optionally or alternatively, the display reflects anatomical features and/or association with anatomical features such as organs.

In some embodiments, the visualization portrays functional information of one or more components of the ANS, optionally to the exclusion of structural and/or anatomical information. In one example, the information relates to traffic of information (e.g., as reflected by one or more measurable parameters such as electrical activity of the ganglia or the nerves, neuro transmitter secretion and/or uptake, and/or to surrogate measures that relate to ANS function. Some examples of surrogate measures include the effects on target organs or the activity of higher command centers and/or controlled (by the body) variables, such as oxygenation, pressure, temperature, and/or pain and/or vibration and/or other sensors in the body.

In some exemplary embodiments of the invention, the model may be constructed from the measurements. Optionally, the construction uses an existing model template which is, for example, populated, tuned, modified and/or selected based on the measurements. Optionally, there may be provided a plurality of model templates and one is chosen, for example, according to one or more of the target organ or organ portion, trigger, physiological information and/or other patient data.

An actual visualization may be of some or all the data in a model, or may be the result of an analysis of such a model. For example, a visualization may show a phase relationship between activities of two separate nodes of the ANS, such a phase relationship may indicate the presence of a “communication” between these nodes, which may in turn be related to certain medical conditions, such as health or disease states. In another example, a visualization may show a phase relationship between activities of a node of the ANS and the controlled organ (such a phase relationship may indicate the presence of a “communication” between the node and the organ, which may in turn be related (or its degree or other properties be related) to certain medical conditions, such as health or disease states.

In exemplary embodiments of the invention, the analysis comprises detecting and/or identifying temporal correlation (possibly with a delay) between parts of the ANS model. It should be noted that in other embodiments of the invention, the data acquisition process may be used to detect such correlations. In one example, cross correlation and convolution of the data and/or acquisition and analysis of the data in the frequency domain may be used. Optionally, GP size is used as a surrogate for GP level and optionally assist in deciding what correlations to looks for. In one example, a detected relationship may include one or more of the following: a relationship between breathing and heart-rate variability, between cold exposure and blood pressure, between pain and heart rate, between mental activity and vasomotion and/or dilation, between the time of day and temperature, between food ingested and blood sugar, between gastric motility and milk ingestion, between levels of K T lymphocytes and NE transmission, between temperature and sweating, between blood sugar and hormone level and/or between blood sugar and fat metabolism.

Optionally or alternatively, a phase or causal relationship between two different organs or organ parts may be displayed. It should be noted that various casual relationships between ANS and organ activity and/or between ANS and ANS activities may be extant in the body (healthy or ill). Various parameters of such relationships may be used, for example, for diagnosis. For example, the existence of an expected relationship or lack thereof, the type of relationship and/or various other parameters, such as intensity, stability and delay. Examples of types of relationship include cyclic relationships (A causes B which causes A), for example, self sustaining or decaying, periodic relationships (A repeats every t time units), correlated relationships (A and B occur at temporally correlated times), triggered relationships (A causes B) and/or combinations of the above.

It should be noted that while the visualization may use a structural or anatomical representation of an organ as a basis for display, this is not essential for all embodiments. For example, some data may be scalar or vectoric and reflect, for example, the presence of a phenomena occurring with or between one or more components of the ANS. In one example, the presence of a very active ganglion (e.g., significantly higher than normal value for a ganglion activity—in a given state of the person, such as higher by 25%, 90%, 150%, 200% or intermediate or higher percentages) may indicate the presence of an ANS primary disorder. This may be simply listed as a textual data (e.g., “there are 2 ganglions more than 50% above an expected activity threshold”). A further analysis is optionally provided (e.g., “this indicates a 64% chance of overactive ANS as a primary disorder and with a 70% chance of abnormal organ feedback as a secondary disorder”).

In some exemplary embodiments of the invention, the level of activity is state-correlated with a physiological state of the subject. For example, level of “normal” activity may be correlated to one or more physiological parameters, such as blood pressure, heart rate and/or sleep/awake state. It should be noted that even at a given physiological state, some ganglions may be expected to have a range of activity levels and/or a certain temporal pattern and/or other statistics (e.g., standard deviation, distribution). Change in such statistics, even if maximum, minimum and/or average activity do not change, may be of interest, for example, as described herein.

In general, the visualization may be used as a depiction of a phenomenon that describes and/or is associated with the state of the ANS in a specific person. The visualization may, for example, show information useful for the diagnosis, prognosis, therapy and or monitoring specific patient with a disease state or a health state. Such information may have different qualifiers including, for example, spatial or temporal or functional or any possible combination of these qualifiers or even just the information present with the fact that certain qualifiers exist or have a certain relationship between them.

In a minimalist visualization example, the information shown is that a component of the ANS has an abnormal qualifier in a patient. In a more complex visualization a relationship between components of the ANS or relationship between parts of or whole organs that are controlled and/or are controlling the ANS or any combination of the above.

In some cases, the identification, or organ section association and/or organ functional association of the ganglion is provided. In other examples, the location of the ganglion may be indicated on an organ or ANS spatial display map. It should be noted that in some cases ganglion overactivity or hypoactivity or a ganglion state may be detected independently of (or without) actually identifying which ganglion is overactive, for example, by detecting general uptake of a radio-tracer without spatial differentiation into individual ganglions.

In another example, the detection may be of a reverberation between two ganglia or nerve fibers or ganglia and an organ, which oscillates at the same, similar or with correlation of frequency. In one example, reverberation is observed in the blood pressure of a person (e.g., with respect to ANS activity. One type of reverberation may be a reentrant circuit where a nerve indirectly (or directly) stimulates itself, during a time where the nerve should be less sensitive to such stimulation, in effect, a reentrant circuit. In some exemplary embodiments of the invention, such reverberation may be treated by a drug that slows neural communication to reduce reverberation (e.g., by reducing neural conduction velocity between the two inflicted members to a point where reentrant activation is less likely.

Abnormal activity, such as focal or re-entrant activity is optionally detected by analyzing activity in an ANS model.

In one type of abnormal activity, a disease condition is caused by a part of the ANS firing faster than needed and captures the conducting pathways to activate other ANS members and organs.

In another type of abnormal activity (which may be coexistent with the first type), Reentrant activation of the ANS, two members of the ANS or a member of ANS and a tissue activate one the other. In some cases this is provided by direct neural conduction—where a signal transmitted by the neural system activates another member of the ANS to activate the originating source to create a reentrant activation. In some cases, indirect reentrant activation, is provided by, for example, the combination of the effects of the ANS on an organ and having that effect generate an input to the neural system to generate a reentrant situation. One example might be that Arial Fibrillation increases Left Atrial volume; the increase left atrial stretch activates sympathetic stretch receptors fibers in the atrium that send a signal to the Ganglion indicating increased stretch. Such a Ganglion under state “3” (positive-positive) sends increased sympathetic stimuli and decreases the parasympathetic stimuli to the atrium, which can sustain Atrial Fibrillation and the atrial stretch may increase further.

An aspect of some embodiments of the invention relates to collecting information about networks of GPs, where the GPs act as nodes. In some exemplary embodiments of the invention, the information includes correlation between activity levels of nodes of the network. Optionally or alternatively, the information may include relative activation of different parts of the network. In some embodiments, an ANS model may include a network of GPs. In some embodiments, generating an ANS model may include identifying networks of GPs.

An aspect of some embodiments of the invention relates to analysis of a model of the ANS. In exemplary embodiments of the invention, such a model may include one or both of structure (e.g., 3D structure and/or structure relative to organ structures) and functional data. In some exemplary embodiments of the invention, a model of an organ is provided which includes structural and/or functional information about the organ. In some exemplary embodiments of the invention, analysis includes analyzing a correlation between the ANS model and the organ model. For example, such a correlation may show dysfunction of an organ echoed in a dysfunctional ANS structure and/or an ANS function. In general, for various embodiments, one or both of ANS structure and function may be correlated with one or both of organ structure and function.

An aspect of some embodiments of the invention relate to a data format and storage of a model and/or a visualization of an ANS. In some exemplary embodiments of the invention, the model may be provided in portable form. Optionally, the model is provided in rendered form, for example, in the form of a visual map. In some exemplary embodiments of the invention, the model includes one or more indicators which map portions of the model to anatomical structures, for example, a physical or functional association between the model and a body part and/or a stellate ganglion. In some exemplary embodiments of the invention, the model is provided as a plurality of layers, optionally hierarchical. Optionally or alternatively, the model may include one or more code segments or formulas which define time based activity. Optionally or alternatively, the model may include an indication of a template of activity of the ANS to be used when interpreting the model. Optionally or alternatively, the model may be provided as a set of models corresponding to a same ANS structure but matching different starting conditions and/or different times. Such a set may be a set of snapshots, optionally rendered visualizations or semi-rendered visualizations which indicate which are fixed in content but may be further processed by a rendering engine to a final form.

In some exemplary embodiments of the invention, the visualization includes at least schematic illustration of additional “actors”, for example, direct innervation or inflammation. In one example, the visualization may show the balance of sympathetic to parasympathetic transmissions or the absolute value of a transmission. In another example, the visualization may score members of the ANS by the role they are having (e.g., primary or secondary) or score them by the mode they are functioning in.

An aspect of some embodiments of the invention relates to storage of a representation of a model and/or other ANS related information. In exemplary embodiments of the invention, a data storage medium is provided having an ANS model (or visualization) stored thereon. In some exemplary embodiments of the invention, the stored information is not merely an image, rather includes ganglion related data, such as size and/or intensity of activity. In some exemplary embodiments of the invention, the stored information may be a non-image representation (e.g., text) of the model information, which may include ganglion related data, such as size and intensity of activity. In some embodiments, what is stored is a manipulateable data structure, such as a scalable map.

In some exemplary embodiments of the invention, a map is structured, unlike an image which is only an array of pixels. In one example, the structure may include segmentation which identifies certain features (e.g., ganglions, axons). In some examples, the structure may include additional data associated with parts of the image and/or segments.

In some exemplary embodiments of the invention, the representation includes location indications, for example, an anatomical location, body coordinates and/or a functional location. Optionally or alternatively to static data, dynamic data per ganglion may be stored, for example, a time based activation profile, correlation with organ data and/or other dynamic data, for example, as described herein. In some cases, dynamic data may be provided as a table or function or time linked data. In other cases, dynamic data may be provided as statistics. Optionally or alternatively to ganglion data, what is stored is links between ganglions, for example, anatomical links (e.g., relatedness to a same body structure), physical links (e.g., connecting axons) and/or functional links (e.g., functional relationship between activation at one and activation at the other). Optionally, the medium may include indications of relevant input sources to the ganglion structure, for example, body function and blood hormone levels.

Optionally or alternatively, the medium stores data relating to ANS innervation and/or activity in target organs. In one example, such data is provided as location indications, size/shape indications and/or static and/or dynamic data regarding activity in such locations.

In some embodiments of the invention, ganglion existence, links and/or data and/or input sources are stored as parameters for an ANS model-template, with the actual model-template, for example, being stored separately.

It should be noted that while, in some exemplary embodiments of the invention, an ANS model is based on data acquired from a patient, such a model can also be, at least in part, a processing of such data, a prediction of a desired state and/or an artificially generated data, possibly based on data from multiple patients, and/or data acquired from the same patient previously. In some embodiments, one or more parts of ANS model (e.g., one or more components) may be based on data acquired from a patient, and other part(s) may be, at least in part, a processing of such data, a prediction of a desired state and/or an artificially generated data, possibly based on data from multiple patients, or data acquire from the same patient previously.

An aspect of some embodiments of the invention relates to generating information about an ANS using a model-representation of the ANS. In some exemplary embodiments of the invention, data acquisition may comprise acquiring data about the ANS and matching it to such a model. Optionally or alternatively, acquisition may comprise analyzing the function of one or more components of the ANS.

It should be appreciated that a model of the ANS may be used for things other than visualization. In one example, such a model may be used to guide data acquisition. In another example, such a model may be used as an input to a CAD (computer aided diagnostic) system, as input to a navigation system, as input to a catheter manipulation system (e.g., a surgical robot), as input to biopsy machine and/or as input to a stimulation generator.

An aspect of some embodiments of the invention relates to using a stimulation to decide on further analysis of an ANS. In some exemplary embodiments of the invention, the stimulation directly activates the ANS, for example, being a suitable bioactive material or electrical stimulation. Optionally, the response of the body and/or ANS components thereof to the stimulation may indicate what state the ANS is in, and/or indicates which of a particular situation is more likely. Further diagnosis, for example, using an ANS model, may be pursed based on such response. For example, asthma patients react to beta blockers in a way that indicates ANS involvement. Testing an asthma patient for beta-blocker response may be used to decide which parts of the ANS to analyze. In some embodiments, data is collected on ANS member function during a stimulation that invokes an asthmatic attack.

An aspect of some embodiments of the invention relates to using a model based understanding of the role of the Autonomic Nervous System in disease generation. Optionally, there is provided the ability to search and identify members of the Autonomic Nervous System that their interactions that can cause or sustain a disease state. Optionally or alternatively, there is provided the ability to design therapies based on modulation of the Autonomic Nervous System members such that a disease process will be avoided. In one example, heart failure is diagnosed and/or treated by highlighting the role of sympathetic blockade in treating HF patients (e.g., indicating if such blockage is causative and/or may be assistive. In one example, in ischemia, the role of Sympathetic system in response to local ischemia by increasing local metabolic rate and increasing ischemia, as a causative or contributive element is diagnosed and/or treated.

A broad aspect of some embodiments of the invention relates to treating the ANS as a control system, using control theory methods, optionally to overcome ANS disorders, that is disorders caused by, mediated by and/or remediable by modifying ANS activity. An ANS-mediated condition is, for example, a condition which can be changed (or a physiological effect and/or symptomology and/or quality of life thereof changed) by affecting the way the ANS acts. An ANS-mediated effect is an effect on a patient caused by modifying the functioning and/or structure of an ANS so that a physiological effect is achieved.

An aspect of some embodiments of the invention relates to treating ANS disorders by ablation or other therapy which increases noise in the system so that a target area falls within the control range which is enlarged by noise. So while accuracy may be reduced, the control loops are closed such that a control area overlaps and/or includes the target area and more reliable and/or reasonable control may be applied.

An aspect of some embodiments of the invention relates to treating the ANS by adding noise or otherwise interfering with the ANS so that locking to a local minimum is overcome.

An aspect of some embodiments of the invention relates to treating an ANS by filtering some of the afferent and/or efferent traffic. In one example, this reduces noise so as to allow a system to stay near a control point thereof. Optionally or alternatively, this reduces the ability of the ANS to drive the system to further damage.

An aspect of some embodiments of the invention relates to treating ANS disorders by modifying, for example, interfering with intra-organ or near-organ closed loops. For example, some disorders are at least mediated by a closed loop in which an organ output causes an ANS component to further drive the organ behavior away from a desired state (e.g., towards abnormally high and/or abnormally low activity). In some embodiments of the invention, one or more ANS components are modified so as to prevent or reduce the frequency and/or magnitude of such closed loops.

Optionally or alternatively, the closed loop causes the organ system to reach a stable state at too high or too low an activity level, for example being stuck in a local minima. Interfering with the closed loop is optionally used to move and/or reduce the stability of such local minima.

An aspect of some embodiments of the invention relates to modeling an ANS by assuming a behavior on the ANS components. In some embodiments of the invention, the assumed behavior is that each (or many) ANS component process an input into an output and do so in a state which tends to a resting condition or in a state which tends to extremes. Optionally or alternatively, the assumed behavior is that one or more ANS components act as processors which generate a signal which is stronger when there is a greater difference between an input and a reference value therefore.

In some embodiments of the invention, the ANS modeling includes modeling a transfer function of an ANS component such as a GP.

In some embodiments of the invention, a diagnostic/treatment/analysis method includes identifying which ANS component if modulated as provided by the treatment will cause/allow the organ/ANS complex to achieve behavior within desired parameters.

A board aspect of some embodiments of the invention relates to planning treatment and/or a treatment suitable for complex therapies and/or multiple-choice therapies.

It is noted that being a control system, the ANS can be modulated in many ways. In some embodiments of the invention, a tradeoff is made between modulations which affect more organs and a modulation which has a stronger effect. Optionally or alternatively, a tradeoff is made between a modulation which affects afferent signals and a tradeoff which affects efferent signals.

Optionally or alternatively, in some embodiments of the invention, a tradeoff is made between efficacy of treatment and type and/or magnitude and/or treatability of side effects form treatment.

Optionally or alternatively, in some embodiments of the invention, a treatment plan includes alternative treatments. Optionally or alternatively, a treatment plan includes a logic to select between options based on a result of a previous treatment step and/or an actual measurement.

Optionally or alternatively, in some embodiments of the invention, a treatment plan includes instructions for an ablation system and/or other machine readable data for controlling an aspect of the treatment and/or generating feedback to a user. Optionally or alternatively, the plan includes a measurement command and/or measurement parameters (e.g., location, type of measurement, gain, dynamic range and/or timing).

Optionally or alternatively, a treatment plan includes an image and/or an ANS model for a user.

Optionally or alternatively, in some embodiments of the invention, a treatment plan includes a plurality of target locations, one or more of which is optionally in the ANS. Optionally the treatment plan includes a time line, optionally including delays and/or required interim steps for ordering a plurality of targets.

Optionally or alternatively, in some embodiments of the invention, a treatment plan includes both targets for acute treatment, for example, using ablation and targets for long term treatment, for example, drug dosing information for periods of over 1 day one week and/or one month.

In some embodiments of the invention, there is a provided apparatus which can generate a treatment plan based on a model and user information. Optionally or alternatively, there is provided apparatus which can carry out and/or monitor a treatment plan which is provided to it and/or provided with it. Optionally, the apparatus include a catheter with a mechanically coupled memory unit, which unit includes treatment plan details and/or an authorization to access a treatment plan. Optionally, the unit includes data for catheter control in association with treatment plan locations and/or measurements made during the treatment.

In an exemplary embodiment of the invention, a system may include one or more of an imaging control module (which controls imaging and/or reconstruction so as to obtain useful information), a model generating module (which generates an ANS model and/or populates and/or modifies an existing model), a diagnosis module (which generates a diagnosis based on a model and/or reaction of a patient as compared to that shown by a model), a planning module (which generates a treatment plan) and/or a treatment module (which monitors, supports and/or carries out a treatment. Such modules may be, for example, stand alone systems and/or software components in a larger system.

As used herein, in some embodiments of the invention the phrase functional imaging modality means an imaging modality that is designed to or otherwise configured to produce functional based data and/or images (e.g., of an intrabody organ or a part thereof), for example, a nuclear based modality such as single-photon emission computed tomography (SPECT), positron emission tomography (PET), functional magnetic resonance imaging (fMRI), or other modalities. The images may be based on changes within tissues, for example, chemical composition (e.g., at nerve synapses), released chemicals (e.g., at synapses), metabolism, blood flow, absorption, and/or other changes. The images may provide physiological functional data, for example, activity of nervous system tissue.

As used herein, in some embodiments of the invention the phrase anatomical imaging modality means an imaging modality that is designed to produce structural based data and/or images (e.g., anatomical image), for example, X-rays, ultrasound (US), computed tomography (CT), such as x-ray or gamma-ray, magnetic resonance imaging (MRI), or other modalities. Organs, tissues and/or other structures may be detected by the anatomical image.

In some embodiments, functional data may allow localizing tissue (e.g., nerve structures) that cannot be localized by anatomical imaging alone. For example, hidden functional portions of an organ may be localized by visualizing their functionality. In some embodiments, this may be combined with enhancing the resolution of functional imaging, for example, by focusing the functional imaging on regions expected to include the anatomical imaging hidden functional portions. These regions may be identified, in some embodiments, based on structural imaging.

Optionally, anatomical data is used for instructing the reconstructions of functional (e.g., using an mIBG tracer) activity mapping functional images in a manner that the resolution of areas wherein the nerve structures (e.g., GP, ganglia) are located is increased. Optionally, reconstruction is performed with anatomically varying gating, for example, anatomically varying image masks.

For example, nervous tissues in the atria, such as individual ganglia, are commonly surrounded by fatty connective tissue closely adjacent to epicardial muscle. Other ganglia in the atria are imbedded in the fat pad overlying the posterior surface of the left atrium and/or in the atrioventricular groove. The close proximity of these ganglia to a fat layer may prevent an operator (manually) or a processing module (automatically) from localizing the ganglia based on the anatomical data. The combination with the functional data provided by the SPECT data (for example) however, may allow separating between the ganglia and the surrounding tissues based on the uptake rate of the imaging agent, kinetic data and/or dynamic behavior.

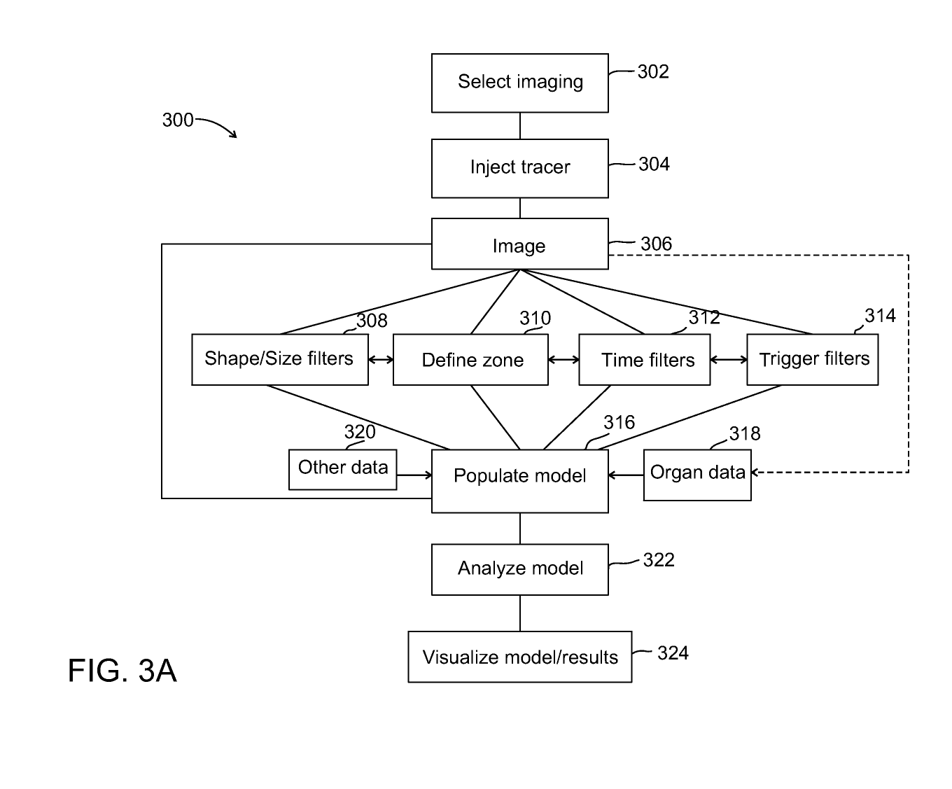

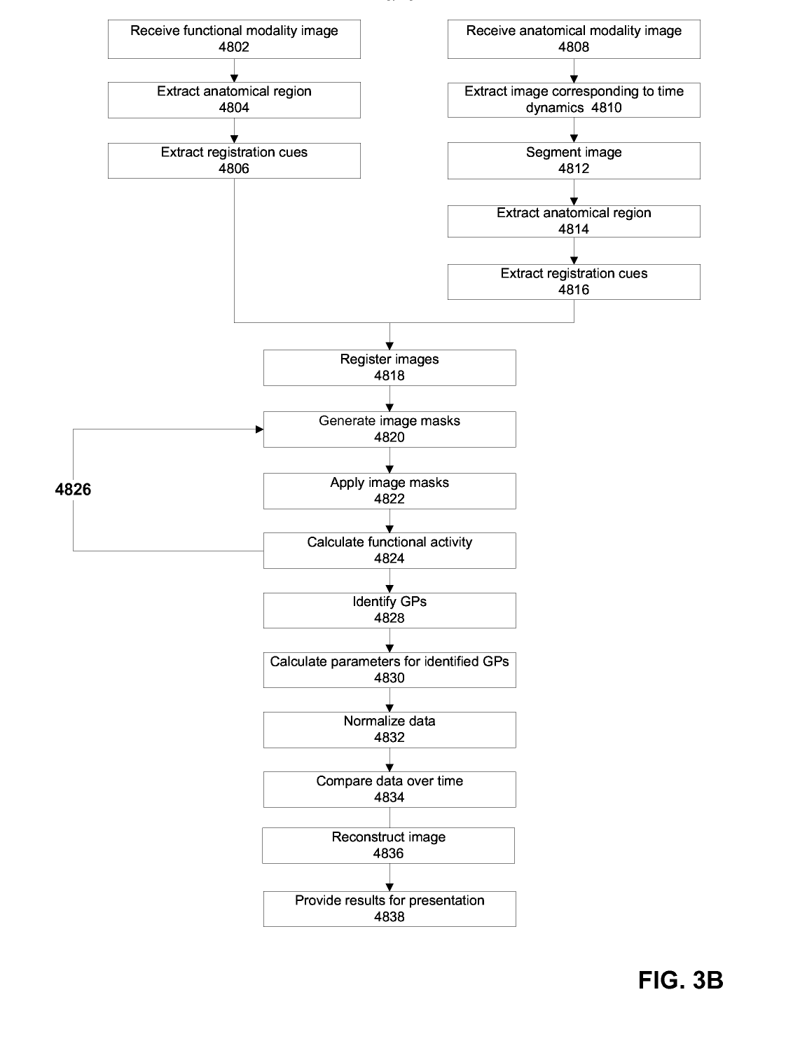

Optionally, the nerve structure (e.g., GP) is identified, rather than the fat pad. Optionally, the nerve structure itself is identified within the fat pad, rather than identifying the fat surrounding pad. Alternatively or additionally, the fat pad is used as an anatomical guide for detecting the GP within the fat pad, for example, with reference to the image mask method described below (e.g., FIG. 3B), image masks may be generated using anatomical images to correspond with the fat pad. The GPs within or next to the fat pads are then identified within functional data based on the application of the image masks to the GP.

Optionally, during ablation or other treatment, the GP within the fat pad is targeted for ablation. Optionally, the ablation is selected to ablate the GP, rather than the surrounding fat pad. The surrounding fat pad may not be entirely removed, for example, most of the fat pad may remain, or some of the fat pad, for example, no more than about 25%, or about 50%, or about 70%, or about 90% of the fat pad. The fat pad ablation may be performed as required to ablate the GP inside and/or near the fat pad. The entire fat pad may be removed, for example, as a secondary effect of ablating the GP, rather than being the primary target.

In some embodiments, what is ablated are nerves interconnecting GPs, for example, imaged nerves or nerves whose position is guessed based on them being on a straight line (e.g., and/or along tissue boundaries and/or blood vessels) interconnecting two ganglia.

An aspect of some embodiments of the present invention relates to a method of processing functional images to identify and/or locate nerves (e.g., GPs) within tissues (e.g., heart, stomach, intestines, kidney, aorta, or other organs or structures). Optionally, anatomical images used to reconstruct the functional image and/or process the functional data are combined with the functional images, the combined image may be used as a basis for locating GPs. The method may comprise generating image masks corresponding to regions of the anatomical image contain the GPs and/or the innervations of the organ. Typically, the GPs are not visible on the anatomical image, for example, cardiac GPs are usually not visible on a CT scan that includes the heart. In some embodiments of the invention, the selected image masks are applied to corresponding locations on the functional image, for example, by a registration process. GP characteristics within the functional image are reconstructed, instructed by the applied mask. GPs within the selected image mask applied to the functional image may be identified, based on predefined rules, for example, size of active spots and/or intensity of the active spots relative to surrounding intensity (e.g. relative to an average value). In this manner, anatomical information is used for reconstructing the activity of GPs within the functional image. The anatomical information, in the form of the mask, may be used for guiding the processing to certain regions of the functional image, to help in locating the GPs of interest. The identified GPs may be displayed on the anatomical image or a combined functional and anatomical image, and/or may be registered with a navigation system for patient treatment such as an electrophysiological catheter navigation system for treating diseases (e.g., cardiac disorders such as arrhythmias). In this manner, the anatomical image may serve as a guide for where to look within the functional data to identify the relevant nerve structures, where the rough location of the nerve structure within the body is known before hand, for example, based on a predefined anatomical atlas.

Optionally, the image mask method may be used to decide where the innervated organ is located and/or to define where to look for objects of interest.

The size and/or shape of the image masks may be defined, for example, by the ability of software to segment the anatomical image, by the resolution of the anatomical and/or functional images, by the resolution of the ablation treatment, by the size of the structure being identified, or other methods.

The image mask method is not limited to detecting nerve structures (e.g, GPs). The image mask method may be used to detect other small structures, for example, small cancer lumps and/or lymph nodes near tissue.

Optionally, image masks are generated for an organ with one or more lumens, fluid and/or air filled and/or potential spaces (e.g., bladder, heart, stomach, intestine, aorta). Optionally, the image masks are generated to identify structures (e.g., nerves, GPs) in the tissue itself, rather than within the lumen and/or space. Optionally, the contour of the organ and/or tissue is identified based on the anatomical image, for example, the inner wall of the heart chambers, stomach, bladder, aorta, or other organs. Optionally, the image masks are generated based on the anatomical image, to guide searches within the functional data to identify the nerve structures.

While some embodiments of the invention are specifically directed at nervous tissue in the form of ganglions, in other embodiments, other types of nervous tissue organization are imaged, mapped, treated and/or modeled. In general, embodiments that are not otherwise indicated and describe ganglions, may be used with respect to (e.g., detecting, modeling and/or treating) of synaptic centers in general. Herein, the term “synaptic center” refers to a region in the body, outside the central nervous system, characterized by a high concentration (e.g., relative to the surrounding tissue) of synapses (e.g., ANS synapses). Examples of a synaptic center include, without limitation, a ganglion, a ganglionated plexus, a neuromuscular junction and any other aggregate of synapses innervating an organ. In some cases, the center is a “ganglionated plexus” or a “ganglionic plexus”, which may be used refer to a region with a plurality of interconnected ganglia.

According to some embodiments of the invention, the region has a diameter of no more than 20 mm. In some embodiments, a maximal diameter (e.g., in at least one cross-sectional dimension) of an identified synaptic center (e.g., ganglia) is between 1 and 20 mm. In some embodiments, centers having a maximal diameter of less than 13 mm, 7 mm, 5 mm, 3 mm or intermediate sizes are considered (e.g., imaged, modeled and/or treated).

In some embodiments, the imaging comprises identifying the nervous tissue comprising at least one synaptic center and/or specifically identifying such a synaptic center. In some embodiments, the nervous tissue comprises at least one ganglion. In some embodiments, the nervous tissue comprises at least one ganglionated plexus (GP).

In some embodiments, the imaging comprises identifying at least one synaptic center.

According to some embodiments of the invention, the method comprises identifying ganglia. In exemplary embodiments, the method comprises identifying autonomic nervous system ganglia.

Herein, the phrase “identifying . . . 1 ganglia” encompasses identifying one or more synaptic centers, wherein each synaptic center may be an individual ganglion and/or comprise a plurality of ganglia (e.g., a ganglionated plexus). In some cases, the difference between an individual ganglion and a synaptic center comprising a plurality of ganglia (e.g., a ganglionated plexus) is merely semantic (e.g., wherein different people in the art use different terminology) and/or of no significant medical importance.

According to some embodiments of the invention, the synaptic center is selected from the group consisting of an autonomic ganglion and an autonomic ganglionated plexus. Herein, the terms “autonomic ganglion” and “autonomic ganglionated plexus” refer to a ganglion or ganglionated plexus, respectively, which is a part of the autonomic nervous system. The adrenal medulla is considered herein as an autonomic ganglion.

As used herein, the phrase nervous tissue can include, for example, one or more of Ganglia (e.g., ganglionic plexi, GP), neural fibers, neural synapses, neural sub systems, and/or an organ specific nervous tissue. Examples of neural subsystems include, a peripheral subsystem, and/or an autonomic sub system, such as the sympathetic and the parasympathetic autonomic sub systems. Examples of organ specific nervous tissue may include, a carotid body, aortic arch, pulmonary, renal, splenic, hepatic, inferior mesenteric, superior mesenteric, muscular and/or, penile nervous tissue. It should be noted that the localization or detection may be performed with and/or without reconstruction of an image based on the functional data. For example, localization or detection may be performed by identifying an imaging agent signature, in the functional data without reconstructing the functional data to form a spatial image. Nevertheless, an image reconstructed from the functional data may be analyzed to localize and/or detect the nervous tissue. In such embodiments, the functional data may be processed to identify an imaging agent signature of a target nervous tissue. This target tissue signature may be indicative of the location of the target nervous tissue and/or of its behavior within a model. The imaging agent signature may include kinetic information, uptake information of one or more imaging agent(s), washout information of one or more imaging agent(s), and/or one or more combination(s) thereof. The target nervous tissue signature may be measured relative to a background in an intrabody volume (e.g., as provided by an image mask) and/or using previously captured functional data of most probable location, number, size, and/or the like.

In the below description, some structural components are described as functions. In some exemplary embodiments of the invention, such functions are carried out using software and/or hardware. Optionally, each act described is provided by a different module. In some embodiments, multiple acts are provided by a single module.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary Models of the ANS

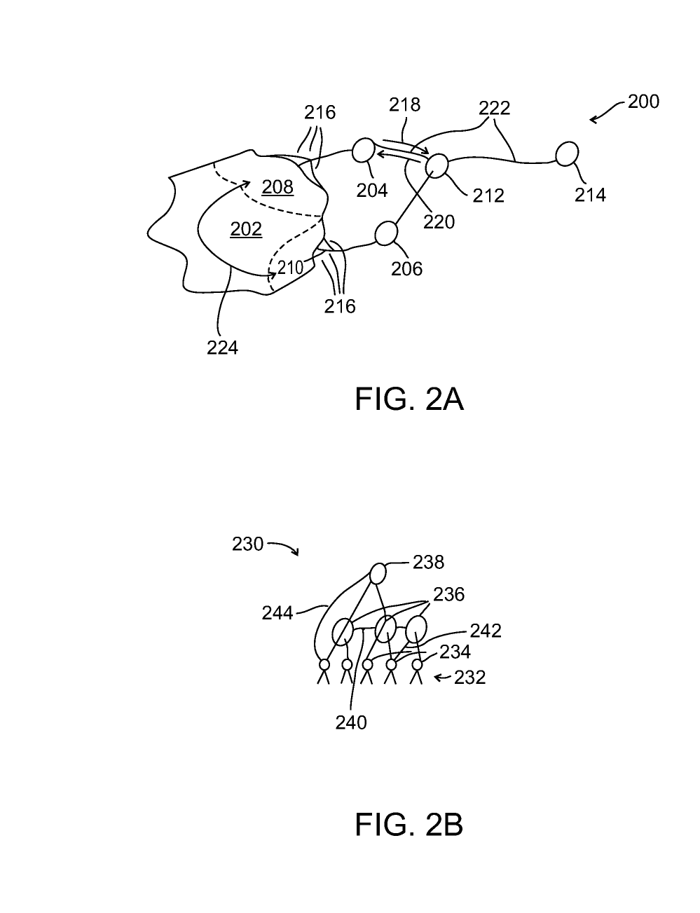

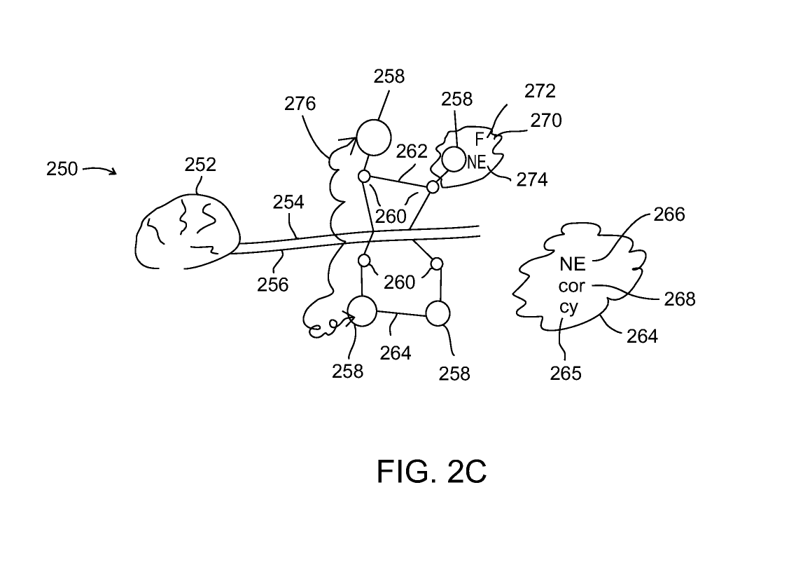

FIGS. 2A-2C show various models of the ANS or a part thereof, in accordance with exemplary embodiments of the invention. As can be appreciated, such models may be idealized versions of what the underlying physiology, for example, with modeling using as units ganglions (e.g., above a certain size), innervated areas and/or transmission trunks. In some embodiments of the invention, however, the underlying physiology is modeled with a high fidelity, for example, at the level of individual axons or nerves.

FIG. 2A shows a model of a portion of an ANS 200 associated with an organ 202, in accordance with some embodiments of the invention. Each of two (a model may have more, for example, 3, 4, 5, 6, 8, 100 or intermediate or greater numbers) ganglions 204 and 206 is coupled to different, corresponding, parts 208 and 210 of organ 202. In some embodiments, the model allows an overlap between parts 208 and 210. A higher level ganglion 212 may be functionally or physically coupled to both ganglions 204 and 206 and also be connected to a ganglion 214, for example, a dorsal ganglion. In general, while it may be useful to view the ANS as hierarchical, a connection between non-adjacent “levels” is possible, at least in a model representation of the ANS, in some embodiments of the invention.

Each of ganglions 204 and 206 may be coupled to organ 202 using a plurality of nerve endings 216, each nerve ending innervating a corresponding portion (208, 210) of organ 202. In exemplary embodiments of the invention, the location of connection of nerve endings 216 is not modeled spatially. Optionally or alternatively, a density model is used indicating the relative density of nerve ending in different parts of organ 202. In some embodiments, only a statistic of such density is modeled and in some embodiments, some spatial information is modeled, for example, location relative to an organ. In some embodiments, also the ganglions are modeled statistically and do not represent and/or are linked to particular parts of the organ and/or locations thereon.

In some exemplary embodiments of the invention, the model may represent the ANS as a plurality of nodes (e.g., ganglions and organ 202, 204, 206, 212, 214) interconnected by links (e.g., axons 222). In some exemplary embodiments of the invention, the model allows each “axon” to transmit in one or both of two directions 218 and 220. Optionally, some axons are limited to transmission in only one direction. Optionally, the intensity of transmission in different directions on a same connection is asymmetric. In some exemplary embodiments of the invention, the intensity of transmission is calculated using a ganglion-oriented input output function which calculates outputs for each outgoing link based on the incoming link and optionally additional parameters, such as excitation state or blood hormone levels. In some exemplary embodiments of the invention, the model uses intensity of signal for modeling communication between ganglions, however, in other embodiments, other indications are used, for example, frequency, spike timing and/or coding, in addition to or instead of intensity.

In some exemplary embodiments of the invention, the model also includes the reactivity of the organ. For example, a link 224 may indicate how activity in part 208 affects activity in part 210. In another example, the model may include a modeling of organ behavior, for example, with respect to a stomach, how a change in excitation level will modify the signals passed back to the ANS, in the presence of food in the stomach (which may be different than if the stomach is empty).

While not shown, a plurality of links may be provided between two ganglions, modeling, for example, sympathetic and parasympathetic nerves and/or axons with different transmission functions and/or modeling connections from/to different parts of a ganglion.

In summary, for example, a model may include ganglia, functional direct links between the ganglia and some indication of the mapping by the ganglia of its input to its output.

FIG. 2B shows an ANS model 230 including a network structure, optionally organized in a hierarchy, in accordance with some exemplary embodiments of the invention. A plurality of low level ganglions 234 are modeled as each including one or more nerve endings 232 (e.g., which may act for effecting or for sensing). These low level ganglions may be connected to higher level ganglions 236, which may be connected to even higher level ganglions 238. Additional inputs, such as organ inputs as described above may be modeled as well. In some exemplary embodiments of the invention, each level of ganglion has a different modeling. For example, the interaction between ganglia, the higher one goes in the system the more the “global” state becomes a significant determinant of a response, the lower one goes in the system the more the input of localized “states” becomes important. For example, in a running person. The muscles of his legs require more oxygen as they are performing exercise locally at the level of the single cell—the need for more oxygen is reflected by the generation of more CO2 and the acidification of the intercellular space and the reduction of the O2 pressure, as exercise continues and oxygen supply will not increase K+ level rises and many other intra-cellular components become present in the inter cellular space. These alterations cause a stimulation of nervous sensors located adjacent to the cell and their activation create a neuro signal to be transmitted across the sympathetic afferent pathways (coming out of the organ), these inputs are modulated while traveling through the tissue to meet intra tissue Plexi of nerves that bring stimuli from other regions or process the input information to decide on how to respond to the local inputs. The response can happen at the local level (vasodilation such that more blood arrives at the tissue level). This response will generally be modulated by the state of the control system.

Each of the connections may be modeled, for example, as described with reference to FIG. 2A. In some embodiments, at least part of the model (e.g., a level) is modeled as a network, for example, lateral links 240 interconnecting ganglions 236. Optionally or alternatively, links may skip one or more levels, for example a link 244 connecting low and high level ganglions 234 and 238. Optionally or alternatively, links may connect a single ganglion in one level to multiple ganglions in a higher level, for example, link 242. In some embodiments, each ganglion has its own “level”, for example, representing a number of synapses therein and/or a number of incoming and/or outgoing links or axons.

FIG. 2C shows a model 250 of the ANS at a different level of detail, which model optionally includes other models as sub-components thereof. In this model, a brain 252 may act as a controller and is optionally included. It is noted, however, that the brain is also an organ with its own ANS which affects and senses its functioning. A pair of nerves 254 and 256, representing sympathetic and parasympathetic links, are shown. One or more organs 258 may be included as well. One or more organs may have an ANS network 260, here shown as a single node. Organs may also be directly linked (e.g., the pancreas is also activated by mechanical and chemical signals from the GI tract). Optionally or alternatively, ANS networks may be directly linked, for example, with a link 262, thereby defining a multi-organ network. It is noted that such models may, but need not model all the nervous plexus found in the body or in the portion thereof being modeled. Optionally, a general environment 264 may be modeled which may include, for example, levels of blood hormones such as norepinephrine 266 and cortisol 268 or other signaling molecules such as cytokines 265 (e.g., interleukins, and/or chemotaxic factors. Optionally or alternatively, a local (e.g., organ) environment 270 may be modeled for one or more organ and/or ANS portion 272. This more local environment may model for example conditions such as food contents (e.g., for GI tract) or local levels of various chemicals such as norepinephrine 274. It is noted that such environments may include an indication of a pharmaceutical provided to a modeled patient.

Optionally or alternatively to nervous links, one or more chemical links 276 may interconnect two organs or the brain and an organ. For example, such a chemical link may include hormones excreted by the stomach or brain or other glands, or other chemicals, such as blood glucose levels. Optionally, a component of the model may include a function which translates a body level of a chemical to the level experienced by the component, for example, by modeling a delay effect.

The above are just three general examples of what a model might look like, structurally. It is noted that each component of such a model may also include modeling information.

For example, a model of a ganglion may include, for example one or more of, the chemical sensitivity profile (e.g., reaction of functioning to changes in chemical environment) of the nerves, the type of nerves (e.g., sympathetic, parasympathetic or both), number of synapses, number of activity levels and an input-output function or table, link analysis (e.g., a multidimensional table relating one member (be it a synapse or a ganglion or a brain to other members) to any other member), members contain members and links can be within a member as well as within and between members. In some exemplary embodiments of the invention, each ganglion may have one or more behavior equations, which can mathematically link input and output optionally including a modulation by environment and/or state, associated therewith.

It should be noted that in some embodiments of the invention the ANS system is treated as a nested hierarchy. Such a system may be analyzed at any level of interpretation as a system with a main controller in the brain and as system with 2 sub division Sympathetic and Parasympathetic or with a more detailed description. The common design element is the element of:

A. Input

B. Processing

C. Output

The system is optionally modeled to have this structure at any level of analysis. So in general, a model may assume that the ANS is a System with a nested design, in which one may detect a state of the controller, identify proper and/or improper action of the controller and/or relate controller function and malfunction with organ function and malfunction.

In some embodiments, this modeling method is applied at multiple levels including the enter ANS, networks of organs, networks of plexi and individual organs.

According to some embodiments of the present invention, the methods described as being applied to ganglions are applied to other ANS or tissue components, such as the Brain, Spinal cord, Ganglia, Nerves, Synapse Neurotransmitters, Terminal synapse and end organs (or functionality thereof).

For example, a model of an axon (or other nervous link) may include, for example one or more of a transfer function, fidelity of transfer of signals, a delay, relative contribution to a ganglion it is connected to and/or a modulation thereof by an environment, such as a chemical.

For example, a model of an organ may include one or more of a function or set of equations interrelating processing thereof (e.g., food, blood, air, urine) and nervous and/or chemical inputs and outputs.

In some exemplary embodiments of the invention, the brain may be modeled as a controller, for example, defining one or more scripts that act on input and generate output.

In some exemplary embodiments of the invention, the environment (e.g., blood, intracellular fluid) is modeled using, for example, one or more of a set of chemical equilibrium or transitory equations.

In some exemplary embodiments of the invention, the rest of the body may be modeled as a component, for example, using a set of equations. Optionally or alternatively, the mechanics of the body are modeled as well, for example, indicating a time-related change in pressure on one or more organs.

It is noted that while some models may use mathematical modeling, this is not the case for all models. For example, in some cases the knowledge that a link exists and the knowledge that there is a stimuli that the link should respond to and the identification of a response might be enough to determine sufficient information on the presence of a link and its significance to a state. Optionally, Bayesian analysis is used to analyze such behavior.

In some exemplary embodiments of the invention, the anatomy of the body is modeled, for example, indicating cross-connection between organs and/or ANS components. In one example, inflammation in a nearby organ may have a greater effect on nearer ANS components. In another example, (modeled) mechanical movement of one organ may affect a nearby ANS component.

The amount of detail provided in a model can vary, for example, depending on quality of data collection, complexity of behavior and/or need. For example, between 1 and 30 ganglions may be modeled, or more, or, for example, between 2 and 15 ganglions. In another example of possibly useful ranges, between 1 and 50 nervous connections (e.g., axons) are modeled, for example, between 3 and 15 such connections.

In another example of possibly useful ranges, each ganglion has between 1 and 6, for example, between 3 and 5 different operational modes. In another example, one or more (e.g., 2, 3, or more) levels of ganglions may be modeled.

The above models shown in FIGS. 2A-2C use a graph-like representation (nodes and links), however, other model structures can be used, including one or more of the following and/or combinations thereof. In one example, the model is a listing of code. In another example, the model is a set of object-oriented code listings. In another example, the model is a set of equations, optionally in matrix form, optionally linear, differential, partly differential and/or including delays. In another example, the model is a neural network. In another example, the model is provided as hardwired circuitry, optionally with updatable locations for various parameters. In another example the model is provided as a hidden Markov model.

In an exemplary embodiment of the invention, the model includes a linking between discrete and continuous data (e.g., blood pressure and/or temperature linked to thresholds, refractory period and existing/missing links). In an exemplary embodiment of the invention, such linkages are analyzed using simulations. In some embodiments, discrete variables are modeled as continuous. In some models, continuous variables are modeled as discrete.

In an example of a patient with peripheral vascular disease, where the disease affects medium to small vessels in his lower extremities, the presence of narrowing of the medium arteries of his extremities is demonstrated by angiography, and using flow measurement one can deduct that there is a significant resistance in the small vessels. In an exemplary embodiment of the invention, therapy is sought to help the patient increase the reduced blood flow to his legs. Opening of the narrowing of the medium arteries using stents doesn't not solve the patient's problem and study of the control of his peripheral arteries (e.g., as described herein), may be provided. The model that is used for the first test optionally assumes the presence of a single ANS controlling ganglia (not a physical one) that receives signals from the tissue (they report the state of perfusion, e.g., levels of ADP/ATP, 02 levels, CO2 levels, Ph level, K+ level . . . ) these inputs are received by the ganglion, processed and result in an output back to the pre-arteriolar sphincters that control ANS component of the peripheral vascular resistance. The transfer function (TF) between input to output of the ganglion is optionally modeled as being set by a second ganglion. The second ganglion receives input from first ganglion and sends an output to affect heart rate (for example). In an exemplary embodiment of the invention, an ANS test to this patient is performed in a way to evaluate the:
1. Existence of pathology e.g., Hypertension
2. In the presence of Pathology—we expect to see a negative TF of the first ganglion
3. The TF is optionally measured by watching the response of heart rate to pressure variation within the breathing cycle. Or as a response to tilt maneuver, or other blood pressure changing maneuvers.
4. The slope of the TF is optionally determined to be positive—this indicates that the ANS is not responding in an appropriate way.

The results of this test are optionally presented to the operator of the test as: “knowing certain priors (specifically the structure of the control system) the TF was analyzed and found it to be abnormal—therefore an intervention on ganglion 1 is likely to benefit the patient”. In some embodiments, the system used will identify the location and measure the activity (e.g., via tracking communication in the synapse) of ganglions.

In accordance with exemplary embodiments of the invention, the above models are characterized by them being selected, populated, tuned and/or modified based on measurements from a particular patient, including, optionally, using imaging studies. Optionally, imaging studies may be used to provide one or more of structural information (e.g., number of ganglions), functional information (e.g., intensity of activity) and/or causal information (e.g., which ganglion affects which other ganglion). The measurements may include, for example, measurements taken at different times, e.g., a patient may be measured several times—e.g., for modeling different organs, and a single model may be generated based on the several measurements.

In some exemplary embodiments of the invention, the organ for which the ANS is modeled may include a whole organ or a part of one (e.g., a segment, a lobe or a chamber). Example organs which may be modeled (and/or for all or part of which an ANS section may be modeled) include, and are not limited to heart, liver, spleen, stomach, pancreas, prostate, intestine (large, small and/or duodenum), brain, glands, lungs, arteries, veins, bone marrow, skin, ovary, testicles, penis, thyroid and/or kidneys.

### Example Model Representations

Following are examples of models which may be used for representing the ANS, ANS-organ interaction and/or other body systems, in accordance with some exemplary embodiments of the invention. A model may also include features from different models presented herein. As noted below, some or all of the information used and/or provided by the model may also be displayed to a user and/or an expert diagnostic system.

In some exemplary embodiments of the invention, the model may be selected according to the need, for example, to convey information on the role of the ANS in a disease condition (e.g., known or suspected).

In some exemplary embodiments of the invention, the model has even as few as two identifiable states, one disease related and one not (e.g., normal condition). In some cases, the model has additional internal states, but only two external (e.g., displayed) states.

In one example, a patient suffers from Thyrotoxicosis (hyper activity of the thyroid gland). This patient is subjected to an ANS test using a model that assumes the following: The thyroid gland is under the control of a ganglion X; ganglion X receives input about the over activity of the thyroid and can either reduce its stimulatory output and increase its inhibitory output (State II) or increase its stimulatory output and decrease its inhibitory output (State III). However, ganglion X can also be suffering from a primary disorder of Ganglion Hyperactivity (increase its stimulatory output and decrease its inhibitory output) without (or with reduced) a relationship to its input. For practical matters, ablation of ganglion X will address State III and the case of Ganglion X hyperactivity, but will worsen the case of State II. The ANS model used may have three internal states, but the display for the interventionalist is simplified to a two state representation (indicating that elimination of ganglion X will be helpful, or not). Moreover, there is no need to identify the three internal states, as action for two states is only needed.

Another example of a model may include more information, for example, one or more of:

1. Messaging traffic (e.g., number of messages per unit time and/or number of changes in spike rates, reuptake of MIBG, or other NE analogs, spill over of neuro transmitters from the synaptic cleft) through a member of the ANS (e.g., ganglion or axon). This can be provided, for example, by direct measurement of activity or indirect based on a known relationship between the traffic and the effect on an end organs and/or an activity of a higher controlling center.

2. One or more physical properties of the member of the ANS (e.g., size, relative size to surrounding members, location, association to adjacent structures—e.g., spatial distance between one or more GPs).

3. One or more correlative properties of a member of the ANS, for example, the relationship between its function and the function of one or more other members of the ANS and/or the function of other systems, such as an organ.

4. One or more characteristics of the ANS activity. In one example, the information portrayed is descriptive and/or quantitative to the involved members/components of the ANS. In one example, the relative activity of the Sympathetic and the Parasympathetic systems is used. In another example, the model may use the type of Neuro-transmitter used. In another example, the functional effect on an end organ is used (e.g., refractory period in excitatory tissue, blood pressure, triggered activity).

In some embodiments, the model includes (for one or more ANS components or controlled organ) anatomical information, such as size, location and/or association with tissue. In some exemplary embodiments of the invention, the model includes navigation data (e.g., fiduciary marks, relative location, navigation instructions) to allow the member to be reached by one or more methods (e.g., during treatments). For example, catheter instructions (e.g., nearest blood vessel) or line of sight (e.g., for linear ablation which should avoid important organs) may be provided. In some cases, this information is not part of the model, per se, but may be provided with the model, optionally as a consequence of a same or different imaging study as used to collect information for the model. In some embodiments, information is provided on one or more of:
1. ANS activity in real time—to guide the effect of his intervention—this information can be direct ANS information and/or surrogate information informing of ANS activity (e.g. HR, absolute refractory period (ARP), conduction velocity, local temperature, Local metabolic rate, Ammonia Production, Blood pressure).
2. Tissue activity/properties in real-time. This can help define the exact location for delivering therapy (e.g. temperature, impedance, contractility).

In some exemplary embodiments of the invention, navigational information to a target is provided individually, for example, as a trace in a 1D or 2D or 3D tissue representation and/or as a 4D (e.g., 3D+time) or 5D (e.g., 3D+Functional measure (e.g., MIBG specific activity)+time) presentation of a procedure and/or path of a probe (e.g., a catheter) or energy to the target. It should be noted that multiple targets may be associated with a model, some of which may have different effects (e.g., even for a same treatment). Optionally, a physician may choose which target to treat, according to a desired effect or a desired treatment. Optionally, the model may indicate for at least two targets and/or treatments what the effect on the target and/or ANS and/or organ will be (e.g., based on previous data, and/or based on previous data collected from the same patient).

In some exemplary embodiments of the invention, the anatomical information represented by the model includes a mapping of parts of the ANS model to parts of an organ, for example, linking a ganglion to a certain part of the organ, for receiving input therefrom. One example is mapping stretch receptors in an artery to one of several small ganglions. Optionally or alternatively, the model may represent the type and/or other parameters of the sensors, for example, one or more of mechanoreceptors, stretch receptors, vibration receptors, pressure receptors, pain receptors, temperature sensor, Ph receptors, K receptors, specific protein receptors, specific amino acids receptors, hormone receptors, enzyme receptors, inflammatory protein receptors, bradikinin receptors, and/or other intrabody sensors. In some cases, the mapping is not spatial but statistical, for example, 20% of receptors (without indicating location) are mapped to one ganglions and 40% to another. Other types of mapping may be used, for example, to parts of an organ. In one example, ganglions may be linked to functional parts of an organ, for example, in the heart, to epicardial or myocardial portions thereof, and in other organs, for example, to paravertebal or mediastinal portions. In any case, it is noted that a same organ portion may be mapped/linked/connected to one or more components of the ANS, at least with respect to the model. This may allow the model to simplify the real anatomy.

In some exemplary embodiments of the invention, the type of mapping used depends on the application. For example, the mapping may be chosen so as to distinguish between diseased (or normally and abnormally acting) and healthy parts of the organ. For example, a high enough level of mapping is used so that some or all of the healthy parts of the organ map to one (set of) ganglion and diseased parts to another. In an exemplary embodiment of the invention, choosing the model resolution relates to identifying potential diagnosis or therapy targets. Optionally, these targets should be specific enough to contain the information needed for making the diagnosis (e.g., in the case of a diagnosis focused model) or contain the information needed for making the therapy (e.g., in the case of a diagnosis focused model). For example to diagnose if a patient will respond to a specific drug that blocks the B-Receptors of the ANS one may use a model to test if a disease process involves a sympathetic pathway.

Optionally or alternatively, a mapping of parts of the ANS to an organ may be used to link commands from the ANS (e.g., one or more components of the ANS) to activation of various parts of an organ. Optionally, the model may include the location and/or density of terminal synapses in an organ.

In some embodiments, the model is static. The model may only include static values and provide a static result (e.g., an equation that converts an input to an output). In other embodiments, the model may have static values but due to, for example, feedback, changes over time. In some embodiments, the value of various model parameters (e.g., one or more of transfer function, delay, intensity; and/or of properties that are of a higher level such as remodeling of the ANS and/or remodeling of the organ) are also dynamic and may change, for example, as a function of time, state, treatment, duration of the disturbance or the pathology or the genetics of the patient or the environment of the patient (e.g. strenuous physical activity, exposure to high carbohydrate diet, etc.). A visualization and/or an output of a model and/or an input thereto may consist of a time line of values and/or sets of values and/or images or other snapshots of the model state. In an exemplary embodiment of the invention, the model adapts itself to the real interaction between the ANS and the organ or between the pathology of the organ and the ANS or between the pathology of the ANS to the organ, for example, by varying one or more of the above properties.

In some exemplary embodiments of the invention, the model represents the collection and distribution of sensory information. For example, the model may represent as a hierarchical network how data is collected from nerve endings connected to the organ and fed up to a more central ganglion. Optionally or alternatively, the model may model gates, whereby input from two sources that try and go upstream through a ganglion interfere with each other. Optionally, reducing hyperactivity due to one source, may also input from the other ganglion to go upstream as needed. Such a model may also represent how different ANS components modify and/or aggregate sensed information.

In some exemplary embodiments of the invention, the model represents the distribution of commands via an ANS network. In some exemplary embodiments of the invention, the modeling is via a hierarchical network, in which each node receives the commands and generates commands to lower level nodes and/or tissue. In some exemplary embodiments of the invention, the model represents the transfer function used by an ANS component to convert a nervous command into lower level commands to lower level components. Optionally, such a representation (e.g., an equation or lines of code) takes into account history, other input, activation state and/or sensed signals from the tissue.

In some embodiments of the invention, the model is provided as a network map, which may or may not be anatomically correct (e.g., with respect to number of members, which may be missing and/or combined, and/or with respect to anatomical layout and/or distances). In some exemplary embodiments of the invention, the model is functionally correct. In some exemplary embodiments of the invention, such a model may be used to evaluate the relationship between input and output (e.g., Afferent/Efferent) and/or connectivity to other parts of the body, e.g., ANS members or organ members and/or parts. In some exemplary embodiments of the invention, such a network map enables the detection of connectivity between members and/or assists understanding and planning therapies which, for example, operate by acting on a site remote from the affected organ.

In some embodiments of the invention, the model represents casual chains, for example, a casual relationship between ANS member(s) and other ANS member(s) and/or organ(s) (or part(s)). In some exemplary embodiments of the invention, such models indicate feedback states, for example, one or more of Positive-Positive, Positive-Negative and/or Negative-Negative feedback relationships. Such relationships may be, for example, qualitative and/or quantitative (or mixed). In one example, the model models the gain and/or delay of each transmission node in the control system. In some embodiments, the model represents phase relationships rather than and/or in addition to casual relationships. For example, a model describes a control loop that is active in the control of the glucose in the body. The model may represent a relationship between the rise of blood sugar and the secretion of gastrin hormone. The phase between the rise of blood sugar and the rise of gastrin is diagnostic for the presence or absence of Diabetes in a patient.

In some exemplary embodiments of the invention, the model includes both information about the patient and reference information (e.g., from a same or different patient and/or normal values and/or ranges). Reference data may, for example, refer to a same physiological state or to a different such state. When using data from other people, data may be selected to match the patient, for example, with respect to disease state, age, other functional information such as information regularized or normalized to blood pressure, weight, thyroxine activity, cortisol level, time of day, respiratory rate and/or other significant variables that comparing ANS function between same patient at different times or between different patient will invalidate the comparison (or at least reduce its value). In some exemplary embodiments of the invention, such reference data is stored in and extracted from a database which may be, for example, stored locally or remotely. In some cases, the reference data is not generated from actual measurements, but rather by a model. Optionally, such data is generated in real-time (e.g., by a remote server) in response to a specific request by a computer using the model. It should be noted that, in general, the ANS and organs operate in multiple states and are highly dynamic, interaction between each of them (ANS and organs) or between themselves (ANS and ANS members) or between organ and other organs or between part of an organ to another part of an organ are often non-trivial in effect and such interaction is often non-linear.

In an exemplary embodiment of the invention, a model for the ANS takes into account that interactions between ANS components and/or organs may be non-linear. Optionally, analyzing the data acquired is done in a state specific manner. Optionally or alternatively, the modeling of components incorporates such non-linearity. Typically, however, dividing up behavior into discrete states can assist in simplifying a modeling activity and/or data collection (while optionally allowing the state to change, as needed).

When using a graph notation, various dimensions of a model may be provided. For example, in some cases, the model is simple enough to be described as a one dimensional graph (e.g., a linear graph), optionally with feedback. In some examples, the graph may be laid out in two dimensions. In some cases, the model is complex enough that it may need to be represented in a 3D space (e.g., to avoid links crossing each other). In a related, but not identical manner, the anatomical representation of the model and/or the visualization may also be 1D, 2D or 3D (or 4D or higher, for example as described herein). For example, an organ may be represented as an elongate object, each part controlled by a different ganglion (1D). In another example, the surface of the organ is modeled, with a 2D corresponding ganglion network. In another example, the hierarchy or other multi-level representation of ganglions leads to a 3D anatomical model and/or visualization. Such models or visualizations may, in fact, be incorrect anatomically, but still use a 2D or 3D representation to provide a spatial understanding.

### Higher Dimension Models

In some exemplary embodiments of the invention, models are enhanced using non-spatial dimensions. In one example, the model may include dynamics. In another example, the model may include multiple states and/or simultaneous states (e.g., per network, network part and/or ANS component). For each state, one or more of the parameter values of the model may change.

A particular type of dynamics is when the model represents reactivity to external stimuli (e.g., heart rate to exercise). Another type of dynamics is when the model interacts with external stimuli (e.g., also affects the stimuli, for example, nausea causing a reduction in food input).

In another example, additional dimensions may include non-ANS input, for example, physiological state, or ANS input from other, possibly unmodeled, ANS networks. In another example, an additional dimension may relate to different states of the body, for example, running, eating, resting or sleeping.

In some cases, multiple models may be synchronized to each other, for example, a structural and/or functional model of the heart and a model of the ANS thereof, and/or a model of the ANS of the GI tract. An example of synchronization is showing a relationship between cardiac cycle and intensity and ANS activity pattern and intensity.

Such modeling may also include redefinition of model behavior and/or may not include modeling of input. For example, for some organs, such as the heart, a ganglia in a certain location may be known to be non-functional if the right ventricle response to left ventricle input is of a certain form. In such an example, the model may apply this knowledge as a rule to inhibit a ganglion based on behavior. The behavior may be, for example, inputted by a user or detected using imaging. For example, when applying the model, the user may be asked to provide not only input and states of the patient/ANS (e.g., activity levels, eating/sleeping), but also answer certain questions. Based on such answers, the model starting state may change, or a different model matching the inputted conditions may be selected or the model itself may be modified.

Optionally, identifying such behavior in the target tissue or a model thereof may be used for diagnosis and/or to provide a feature for differential diagnosis. In this and other embodiments, even if diagnosis is made directly on an image of ANS behavior, processing, such as application of rules and identifying relationships may be carried out on a model. In some cases, the model is explicit, but in others, the model may be implicit in the code. Thus, embodiments described herein may also be implemented without a distinct model being provided, for example, a stand-alone software module.

It should also be noted that while a model may represent absolute behavior, in some cases, the model may only represents changes in behavior. This last may be used, for example, for networks operating in a center or within a parameter space thereof and/or where the provided input is noisy and/or lacks a good baseline.

Exemplary Methods of Generating a Model and/or Information for a Model

In some exemplary embodiments of the invention, the information used in a model (also referred as ANS information) may be generated or obtained using a functional imaging modality, such as nuclear medicine imaging. The ANS information may be used for generating and/or updating and/or modifying an ANS model.

FIG. 3A is a flowchart of a method 300 of obtaining ANS information, in accordance with some exemplary embodiments of the invention.

At 302, an operator, for example, a physician, may select an imaging and/or modeling type (for example: nuclear imaging, such as: SPECT). Optionally, this is based on a desired diagnosis.

At 304, if nuclear medicine methods are used, a radioactive tracer with selective uptake by nerves, such as MIBG, may be injected into the patient.

At 306, emitted radiation may be captured and reconstructed into an image. In some embodiments, no actual image is reconstructed, rather the emission radiation may be used to determine parameters for a model or to generate the ANS model.

In one example, for example if the location of the target under investigation (e.g., ganglion or part of an organ) is known, the radiation coming from that target is useful for determining the activity within the target. Significant information is optionally acquired from the presence, intensity, phase and/or temporal relationship of the ANS activity in relationship with other variables and/or a baseline. In some cases, image reconstruction is applied when there is a need to distinguish multiple sources.

In some embodiments, a same acquisition method (e.g., nuclear medicine or electrical) is used for both ANS function and organ function. In some embodiments, one or more acts, such as 308-314, may be carried out as part of reconstructing.

At 308, a size and/or shape filter may be used to identify blobs (radiation emitting regions) having a size and/or shape of ANS components which are being imaged, for example, ganglions. In some exemplary embodiments of the invention, the shape of a ganglion is assumed to be spherical or almond shaped and has, for example, a diameter of between 2 and 10 mm. It should be noted that the expected size and/or shape and/or activity level may depend on the location in which the ANS component is being searched for. In some embodiments, the blobs may be identified according to their corresponding activity levels, e.g., a blob may include regions of activity level in a certain range.

At 310, a zone in which to look for ANS components may be defined. Optionally, multiple zones are defined, for example, with different components being searched for in different zones. Optionally, within the zone, other methods for finding ANS components may be applied.

In some exemplary embodiments of the invention, the zone is defined based on an organ associated with the ANS components being imaged. In one example, the ANS components of interest are assumed to lie a certain distance from the outer wall of an organ, for example, between 0.1 and 20 mm. In some cases, a ganglion may be assumed to be partly or completely embedded in an organ wall and/or a specific part thereof. In one example, nerve endings at an organ surface are selectively imaged by defining a region of, for example, 3 mm inwards and outwards of the expected organ surface, for identifying nerve endings. Optionally, nerve endings are identified as densities of nerve endings, rather than as individual nerve endings. In some cases anatomical landmarks on the organ or other tissue are used to define the zone. Optionally, each organ has an imaging protocol indicating zones. In some cases, the probability of a blob being identified as a GP depends on the location thereof, which may be specific to each organ and/or based on a previous image of the patient or other patients with similar characteristics.

In some exemplary embodiments of the invention, geometric regions are targeted by providing a geometrical model of the organ of interest and then correlating it with the imaging volume of a nuclear medicine camera used for detecting radiation. Thereafter, radiation counts that fit in a region of interest relative to the organ may be analyzed for relating to the ANS. Optionally, the correlation uses a known radiation-emitting behavior of the organ, which may be used to provide a reconstruction thereof, at least with sufficient detail to be used for scaling and/or rotating a model. In some cases, the model of the organ is provided using CT imaging. In some cases, the organ model is a mathematical model which is modified according to a specific imaging. In some exemplary embodiments of the invention, the model defines relative locations of interest for, for example, ganglions of certain sizes.

In one example of an anatomical-functional link, the model has several ganglia that are inter-connected. The distance between the ganglia is patient specific and once the patient is imaged and the ganglia are identified, the model calculates the conduction speed, which may be parameter used to diagnose a disease state in that example.

In another example, where the ganglia are suffering from a “reentrant” activation mode. The mathematical model is modified based on the image acquired (e.g., if the acquired image shows such reentrant activity) and the model is modified to incorporate that finding, for example by changing the parameter of the conduction velocity.

In some exemplary embodiments of the invention, a zone is defined based on surrounding tissue type. For example, a region which emits as fat is assumed to also include ANS components of interest. In another example, the zone is defined to be a vascular structure of a certain diameter.

In some exemplary embodiments of the invention, one or more temporal filters (312) may be used to detect ANS related tissue and/or emissions. In some exemplary embodiments of the invention, a known sympathetic cycle such as caused by breathing is used to detect tissues whose emission includes a significant component that varies as a function of time matching, for example, breathing or heart beat. In another example, the model relates the intestinal motility to the presence of Lactose in the food ingested. Therefore, ingesting Lactose and measuring the emitted radiation will identify the circuitry that responds to Lactose in the intestinal tract.

In some exemplary embodiments of the invention, one or more trigger filters (314) may be used. In some exemplary embodiments of the invention, a triggering event is selected which is known to have an effect on the ANS, for example, sudden shock or pain (e.g., placing a hand in cold water). The emission data acquired by the imager may be analyzed so as to selectively identify as ANS-related tissue, e.g., those tissues which show a response to the triggering event.

In some exemplary embodiments of the invention, trigger filters may be used to distinguish between nerve signals traveling towards an organ and away from an organ. When a stimulation is applied at one side of the network, identifying the progression of excitation shows if a certain nervous connection is upstream or downstream. Similarly, stimulation may be provided at the target organ and/or in a center of an ANS network.

In some exemplary embodiments of the invention, the presence of one type of ANS component is guessed from the presence of another. For example, the presence of axons may be inferred from the detection of ganglions. In another example, the presence of feedback with the afferent pathways suggests the existence of an efferent pathway (which can be added to the model even if not directly imaged).

In some exemplary embodiments of the invention, one or more of the above methods of ANS component identification may be used iteratively. After a method is applied to identify potential ANS components, the method may be reapplied, e.g., to fine tune or correct the identification and/or to support better diagnosis.

In an exemplary embodiment of the invention, image analysis and/or search for ganglions is guided by a desired or existing functional understanding. In one example, a hierarchic mode of exploration is applied, whereby, the investigator identifies the main sub system that is normal or pathologic, and in each iteration he keep refining the identification of the pathology to a more discrete and manageable target. The hierarchic exploration process stops when the investigator identifies the level within which the pathology is clearly defined and the identified target is specific enough to guide specific diagnosis and/or treatment (meaning that there are no other targets within the level that can sway the diagnosis or be affected by the therapy in an unwanted way. Optionally or alternatively to a top down hierarchic exploration model, one can use a bottom up diverging exploration method. By starting with a target that is the final target or part of it and trying to expand the search to identify other parts of the system that is pathological and contain no unwanted targets within it.

In one example, an investigator records an electrical signal (or other) representative of sympathetic ganglion activity. A patient with hyperhidrosis is studied and the anatomically most proximal ganglion to the pathological hand is studied (it may known that this ganglion is hyperactive as the hand is wet). Recording the activity enables the investigator to calibrate his tools to identify an hyperactive sympathetic ganglion. The hyperactive sympathetic ganglion may be expected to send its signals both upward (to higher levels in the ANS) and downwards (in this case the end organ). The question for the exploration may be to identify how many more higher ganglions are affected by the hyperactive ganglion that was just identified. The investigator keeps recording his signal while searching for known locations (or target areas within which they may be found) of higher ganglia. The investigator may stop the search once he reaches one of three finding: a. no more hyperactive ganglia; b. hyperactive ganglia that one cannot rely on their signal (as they are getting inputs from other underlying hyperactive members; c. ganglia that cannot be simply ablating or otherwise treated usefully with the desired therapy method as their role in control other body functions is significant and/or expected side effects unacceptable.

In some exemplary embodiments of the invention, different types of nervous tissue may be distinguished based on their different behavior. For example, sympathetic and parasympathetic tissue differently uptake different tracers, and can generate different images, for example, if a multi-energy imager is used to acquire radiation data. Optionally or alternatively, different types of nervous tissue have different temporal cycles and/or different responses to triggering events (e.g., different delays and/or different half-lives). In some exemplary embodiments of the invention, the data analysis system used to analyze the acquired radiation data (e.g., a computer) has a memory storing thereon different properties of various tissue types of interest. Optionally or alternatively, (radiation from) nervous tissue is distinguished from non-nervous tissue based on such differences.

In some embodiments of the invention, there is provided a method of localizing and/or detecting and/or identifying, for example imaging and/or mapping, nervous tissue in an intrabody volume by combining functional data (e.g., SPECT data) and optionally anatomical data. It is noted that in some cases, localization, detection and identification are used interchangeable, for example, when referring to generating data denoting the position of nerve structures. In other cases, localization, detection and identification are not interchangeable, during the process of generating the data of the position of the nerve structures, in which case the terms may denote different stages of the process.

Optionally, synchronization data collected for correlation with the dynamic cycle is used to better match intensity readings of the functional data to tissue structures (e.g., to the heart wall). Optionally, the image mask method of FIG. 3B may be used with the synchronization data. Optionally, in the case of a single anatomical image (obtained at some point during the cycle) the model allows migration of the detected intensity points to the relevant tissue points (e.g., nearby heart wall). For example, the heart wall moves during the cardiac cycle. Functional data may appear within the heart chamber, even though the intensity is actually related to GPs in the nearby wall. For example, sestamibi data may be migrated. Optionally or alternatively, mIBG data that is co-registered with the sestamibi data may be migrated. The migration may provide for both data registration and image construction.

Optionally, one or more ROIs are identified in the functional data, for example based on the implied and/or indicated mIBG uptake, a size and/or shape of segments in the functional data, for example based on a match with one or more reference items, for example predefined models of the respective ROI(s) and/or by filtration of known organ(s), such as the ventricle. Additional details of identifying ROIs are described herein, for example, with reference to FIG. 3B. Optionally, one or more ROIs are identified by the anatomical image, e.g., by defining one or more image masks.

Reference is now made to FIG. 3B which is a flow chart of a method for processing functional images to identify and/or locate one or more ANS components (e.g., ganglions), in accordance with some embodiments of the present invention. It should be noted that method of FIG. 3B is not limited to identification and/or localization of ANS component(s), for example: it may be used for extracting other information from functional and anatomical images or data based on application of image masks, for example, as will be discussed below.

It should be noted that method of FIG. 3B may be used for obtaining data for generating and/or populating an ANS model or ANS information, for example, an ANS model or information may be or otherwise include or be generated based on an image reconstructed according to the method of FIG. 3B (e.g., in block 4836).

Optionally, the method may combine the functional and anatomical images. Alternatively, the anatomical image may provide a basis for reconstructing selected parts of the functional image that contain the GPs. The method may be performed, for example, by a data combining module and/or other processor, an image data processing unit, or other modules and/or systems and/or processing systems and/or modules as described herein. The method may use images from the anatomical imaging modality (which show organ structure, but not GPs in sufficient detail or at all) to reconstruct images from the functional imaging modality (which may show ANS components—e.g., GPs or activity level, but not the organ structure in sufficient detail or at all). Reconstructed functional images may show the GPs overlaid on the organ structure.

Optionally, the method provides (as an output) the general region where GPs are located. Alternatively or additionally, the method provides regions where the GPs are not located. The precise location of GPs may vary anatomically between different patients. The specific location of the GP may be identified during an ablation procedure, for example, using high frequency stimulation (HFS). Alternatively or additionally, the method provides the precise location of the GP, for example, using a coordinate system. In some embodiments, there may be a minor deviation from the GP actual location (e.g., due to noise in image, registration) to the location of the GP which provided by the method which may be corrected by the operator during the ablation procedure.

In some exemplary embodiments of the invention, the number and/or relative size and/or activity of the GPs are used as input into model building, for example, as described below.

Optionally, the functional activity (e.g., mIBG activity) is identified in preselected tissue regions. The image masks are defined based on the preselected tissue regions within the anatomical image that correspond to the functional activity that is being detected. For example, in the heart, GPs are located within the heart wall or nearby, and/or in fat pads. Optionally, the fat pad size and/or shape is used to define the search window and/or image mask. Distribution of mIBG within a fat pad may be of interest, with or without GP detection (e.g., may show a generally active or inactive nervous system component and/or relate to innervation of nearby tissue). Image masks are defined for the anatomical image to look for the GPs within the heart wall or nearby. The generated image masks are then applied to the functional data, to identify the GPs based on activity within the mask—e.g., within the heart wall or nearby.

Optionally, the reconstruction is directed to anatomical regions where functional activity (e.g., from GPs) is expected, for example, based on a predefined anatomical atlas, for example, based on the location of GPs in normal anatomies. Such data may be collected from several patients, for example, by imaging and/or autopsy dissection.

Optionally, the image masks are defined to identify some or all activity of nerves, for example, GPs, synapses, axons, nerve bodies, or other nerve structures and/or different types of nerves. Image masks may be different and/or the same.

In this manner, the image masks may serve a guide for directing the identification of the nerve structures to certain regions within the functional image and/or data. There may be many regions of intensity within the functional data, only a small subset of which may be relevant for identifying ANS components location—for example: to be used in ablation. As the rough location of the nerve structures relative to body organs and/or tissues may be known (e.g., by the atlas) but not visualized on the anatomical image, the search for the nerve structures may be directed to the corresponding regions on the functional image. The search may be focused to regions having a large percentage of intensity readings that denote relevant nerve structures.

The method may be used to detect different types of GPs, at different locations of the body (tissues, organs), for example, as described herein.

The method may improve system performance, by performing calculations within the region of interest to identify the neural tissue. Calculations may not need to be performed in regions without neural tissue.

The method may reduce radiation exposure to the patient. Additional radiation may be applied to regions containing the neural tissue for imaging to provide higher resolution at the regions. Less radiation may be applied to regions not containing the neural tissue.

The method may improve analysis results and/or images. Neural tissue within selected regions may be analyzed and/or imaged. Neural tissue outside the selected regions may not be analyzed and/or imaged. Interference and/or image complexity from the neural tissue outside the selected regions may be reduced or prevented. In this manner, neural tissue that is not contributing to the medical condition of the patient and/or neural tissue that is not a target for ablation therapy may be excluded from further analysis. Alternatively, the non-targeted neural tissue may be identified separately from neural tissue targeted for ablation.

Optionally, at 4802, functional imaging modality data and/or images are received, for example, a D-SPECT image or other images. The images may be of a body part, for example, a torso, an abdomen, a heart, or other body parts (e.g., based on scanning protocols). The body part includes the nerve tissue to be images and/or the innervated organ, for example, GPs of the heart, intestines or other organs. Optionally, the functional images includes regions of activity that denote nerve tissue (e.g., GP), for example, from uptake of the radiotracer (e.g., mIBG).

Optionally, functional data is collected from a body part that has regions where nerve activity is expected, and regions where nerve activity is not expected. For example, during imaging of the heart, data denoting nerve activity is expected from the heart wall and/or surrounding tissues, and no nerve activity is expected from inside the hollow chambers (containing blood). Noise may be received from areas corresponding to the inside of the heart chamber, even though no activity is expected. Optionally, the noise is removed from the functional data based on the corresponding anatomical image (e.g., after image registration). Optionally, intensity denoting noise within blood (or other fluid) filled chambers and/or vessels is removed. For example, intensity readings of the functional data corresponding to heart chambers and/or surrounding blood vessels are removed, e.g., by applying one or more image mask on functional image.

Optionally, at 4804, an anatomical region is extracted from the image. Optionally, the tissue (which may contain nerve structures) is separated from hollow spaces (which do not contain nerve structures, but may contain fluid). For example, to image the heart, the wall of the left ventricle (LV) may be extracted. Alternatively or additionally, the hollow space within the LV may be extracted. It is noted that the extracted region may be a layer of tissue, such as the tissue layers forming the LV wall, instead of, for example, the LV including the hollow chamber inside the LV. For example to image the kidney, the walls of the renal artery may be extracted and/or the inside of the artery may be extracted. When imaging other organs, dominant portions of the organ may be selected.

Optionally, at 4806, one or more registration cues are extracted from the image. The registration cues may be from the organ of interest, and/or surrounding anatomical structures, for example, LV axis, liver, heart septum, RV, torso. Registration cues may be used to match anatomical images with functional images, and/or to match anatomical images during a physiological cycle (e.g., cardiac cycle).

Optionally, at 4808, anatomical image modality data and/or images are received, for example, from a CT, MRI, 3D US, 2D US, or other modalities. The anatomical image denotes the structure of the tissue and/or organ innervated by the nerve tissue (e.g., GP). The anatomical image denotes the tissue and/or organ structure corresponding to the location of the nerve tissue (e.g., GP). The anatomical images may contain the same nerve tissue to be imaged and/or the same innervated organ.

Alternatively, anatomical data is received that is not personalized to the patient, for example, from a general anatomical model.

Optionally, anatomical data from an anatomical imaging modality is received to reconstruct an anatomical image of a region of a body of a patient. Optionally, the region comprises a portion of at least one internal body part which borders on a target nerve tissue.

The anatomical images and the functional images denote corresponding regions of the body containing the GPs for identification and/or localization. For example, both modalities may take pictures of the heart, kidney, or other organs.

For example, to image GPs of the heart, anatomical and/or functional images of the heart are obtained. For example to image GPs of the kidney, anatomical and/or functional images of the kidney, renal artery and/or aorta are obtained.

Optionally, at 4810, images corresponding to different times during a dynamic cycle are extracted and/or acquired. For example, for the heart, images are extracted along the cardiac cycle, for example, the end diastolic volume (EDV) and/or the end systolic volume (ESV). In another example, for the bladder, images may be extracted for a full bladder and an emptying bladder.

The average image may be computed, for example, (EDV+ESV)/2.

Optionally, at 4812, one or more images are segmented. Segmentation may be fully automatic and/or may require manual user intervention.

Optionally, at 4814, an anatomical region is extracted. Optionally, the anatomical region corresponds to the anatomical region extracted at 4804. Optionally, the anatomical region is extracted from the segmented image of block 4812.

Optionally, at 4816, one or more registration cues are extracted from the image. The registration cues may be from the organ of interest, and/or surrounding anatomical structures, for example, LV axis, liver, heart septum, RV, torso.

Optionally, at 4818, the functional images or data and the anatomical images or data are registered. Optionally, the images are registered based on alignment of the extracted anatomical regions of blocks 4804 and 4814. Registration may be performed manually, automatically and/or semi-automatically.

Optionally, the registration is performed to take into account the dynamics of the organ, for example, movement of the heart. For example, anatomical images during the dynamic cycle may be aligned together, and/or functional data may be corrected for the dynamic movement, for example, intensity readings within the heart chamber may be corrected to the nearby moving heart wall.

Optionally, at 4820, image masks are generated based on the anatomical image and/or data. Optionally, the image masks direct processing and/or visual display of the nerve tissue to specific locations of the image located within the image masks. For example, GPs are displayed and/or processed within the volume of an applied image mask. GPs outside the volume of the image mask may not be processed and/or displayed. GPs outside the volume of the image mask may be processed and/or displayed differently than those GPs inside the image mask.

Optionally, the anatomical images are processed to generate the image mask corresponding to dimensions of at least one internal body part, for example, the walls of the chambers of the heart. For example, dimension of internal body part of the specific patient may be calculated and used to define the mask.

Optionally, the image masks are selected and/or defined for tissue surrounding a hollow chamber, for example, the image masks are defined based on the shape of the heart chamber walls and do not include the hollow region within the chambers, the image masks are based on the shape of the arterial wall and do not include the hollow region within the artery, the image masks are based on the shape of the bladder wall and do not include the hollow region within the bladder. It is noted that the nerve structures may exist within the tissues defined by the image masks, but may not exist within the hollow spaces (which may be filled with fluid such as blood, urine or other fluids). The image masks may include tissue surrounding the organ of interest.

The image masks are defined, for example, based on image segmentation (e.g., according to the ability of the system to segment the image), based on tissue types (e.g., muscle vs. connective tissue), based on organ size, based on sub-structures within the organ (e.g., heart chambers, liver lobes, kidney parts), or other methods.

Different image masks may be generated for different tissue types, and/or for GPs at different locations within the organ. For example, for GPs within the epicardium one set of image masks is generated. For GPs within the myocardium another set of image masks may be generated. Image masks may be generated for fat pads.

The image mask may be a 2D and/or 3D volume with a shape and/or size selected based on tissues and/or organ parts within the anatomical image. The image mask may correspond to anatomical parts believed to contain the neural tissue for imaging (e.g., GPs), for example, corresponding to the walls of the four heart chambers, corresponding to the intestinal wall, bladder wall, renal artery, aortic branch region of the renal artery, kidney, or other structures. In some examples, the image mask may be generated to contain GPs within the epicardial and/or myocardial tissue of the heart. In another example, the image masks may be generated to contain kidney innervating GPs at the aorta-renal artery junction. It is noted that the image masks may be generated based on an estimated location of the GPs (e.g., normal patient anatomy and/or an initial model of the ANS for that patient and/or known previous ablation or other medical data, such as indicating missing or ablated nervous tissue), as the GPs may not be visible on the anatomical image. The image masks may be generated based on an estimated location of the GPs and based on dimension of internal body part as may be inferred from the anatomical image.

Optionally, the generated image masks correspond to the segments of the anatomical image. For example, the heart is segmented into some chamber walls (e.g., having the GPs for ablation), and the generated image masks correspond to the chamber walls of interest.

For example, a first image mask is generated for the walls of each chamber of the heart. It is noted that the thickness of smaller chambers may be difficult to measure in certain images (e.g., CT). In such cases, the thickness of the first image masks for each chamber may be based on a measurable anatomical region such as the LV. Alternatively, the thickness of the chamber is measured using another imaging modality (e.g., US, MRI) and/or estimated. The measurement may be performed using the anatomical image, for example, the thickness for the image mask may be based on the thickness of the LV as measured on the CT image. Exemplary image mask thicknesses for the chambers may then be estimated based on the LV measurement, for example: 0.3 to 0.5×LV thickness for the image masks of the LV, right ventricle (RV), right atrium (RA) and left atrium (LA). Or, for example, the multiplication factor may be, 0.3, 0.7, 1.2, 1.5, 2.0, or other smaller, intermediate or larger values. The zone for searching for GPs may be a function of LV thickness away from the wall, and/or in mm Different walls make have different masks. The image mask may be positioned to contain the GPs and/or surrounding tissue. The image mask may be centered on the wall, or may be positioned towards one end of the wall. For example, to search for epicardial GPs, the mask may be at the outer edge of the wall. To search for myocardial GPs, the mask may be at the middle.

Optionally, the image masks are generated and/or applied based on templates. The templates may define: the location of the innervated organ (or tissue) and/or the location of the GPs within and/or in proximity to the innervated organ, outside of the organ. The templates may be generated, for example based on a predefined anatomical atlas that maps nerve structures to tissues and/or organs of the body.

Optionally, the generated image masks are adjacent to one another. Alternatively or additionally, the generated image masks overlap with each other. Alternatively or additionally the generated image masks are spaced apart with respect to one another. The template may define the location of the GPs at a distance of greater than about 1 mm, or about 2 mm, or about 3 mm, or more from the heart wall.

Optionally, the generated image masks are adjacent to one another. For example, to cover a large area in searching for GPs. Alternatively or additionally, the generated image masks overlap with each other, for example, to improve matching of GPs to tissue type, and/or when identifying GPs in a moving organ such as the heart. Alternatively or additionally the generated image masks are spaced apart with respect to one another, for example, when searching for GPs in different areas, for example, to prevent false identifications between the areas.

Optionally, at 4822, the image masks are applied to the functional image. Alternatively or additionally, the image masks are applied to the functional data. Alternatively or additionally, the image masks are applied to combined functional and anatomical images and/or data, for example, overlaid images.

Optionally, the image masks are applied based on the registration process (block 4818). The anatomical information serves as a guide, using the selected image masks, for selective reconstruction of GP related data within the functional image. The image masks may be correlated with the image to contain anatomical structures having the neural tissues. The application may be based on the image registration, for example, applied based on a common coordinate system. The image masks may be applied to a certain type of tissue containing neural tissue. For example, the image masks may be applied to the epicardium of the heart. The image mask may be applied to have its inner surface aligned with the epicardial surface of the chamber wall, such that the image mask contains the epicardial space encompassing the chamber.

Optionally, the generated image mask is correlated with the functional data for guiding the reconstruction of a functional image depicting the target nerve tissue.

Optionally, at 4824, functional activity is calculated within the applied image mask space. Optionally, the average functional activity is calculated. Optionally, the standard deviation of the functional activity is calculated. For the heart example, the functional activity is calculated around each chamber separately, and around the entire heart. Average activity for the chambers may be denoted by A1LV, A1RV, A1LA, A1RA. Average activity for the heart may be denoted by A1H. Standard deviation of the activity may be denoted by SD1LV, SD1RV, SD1LA, SD1RA, SD1H. Optionally, average activity and/or standard deviation may be calculated for the entire functional image or data. Optionally, average activity and/or standard deviation may be pre-set, e.g., based on previous imaging of the same patient, based on “normal” patient activity etc.

Optionally, at 4826, one or more of 4820, 4822 and/or 4824 are repeated. Alternatively, one or more of 4820, 4822, 4824, 4828, 4830, 4832, 4834, 4836 and/or 4838 are repeated. Alternatively, one or more of all blocks in FIG. 3B are repeated. Optionally, additional image masks are generated for different anatomical parts (e.g., for different heart chambers, for different tissue layers), optionally for different tissues types containing neural tissue. Optionally, additional image masks are generated for anatomical tissues and/or anatomical parts that are nearby and/or adjacent to the earlier analyzed anatomical parts. Different image masks may be generated, and then applied together to identify the GPs innervating the organ. For example, different types of GPs may innervate different tissues. Alternatively, different image masks are processed separately, for example, to differentiate between different GPs (e.g., located within different tissues of the organ).

Alternatively or additionally, image masks are generated for different time frames, optionally on each image of the dynamic cycle (e.g., cardiac cycle). The mask may be dynamic. The mask may change over time after temporal registration.

Optionally, the mask is a spatiotemporal mask. The dynamic image masks may correlate with the anatomical regions of interest during the cycle. For example, the image masks may move with the heart during the cardiac cycle, but maintaining the same relative position. For example, image masks applied to the LV wall move back and forth (and/or become smaller and larger) as the heart contracts and relaxes, but maintain the relative position against the LV wall.

Alternatively or additionally, image masks are generated for both the anatomical and the functional images. For example, image masks are generated based on the combined and/or registered images, which may form a single image, or two separate (optionally linked images).

Optionally, the anatomical images are obtained during a cyclic physiological process (e.g., cardiac cycle, bladder emptying, intestinal peristalsis). Optionally, different spatiotemporal image masks are selected for different images obtained during the physiological process. Optionally, the different spatiotemporal image masks are synchronized with the physiological process to correspond to the same location of the tissues. In this manner, the location of the tissues may be maintained as the tissues move during the physiological process.

For example, at 4820 (repeated) additional image masks are generated to detect neural tissue within the myocardium. The size and/or shape of the myocardial masks may be different than the size and/or shape of the epicardial masks and may correspond to different regions within the heart. For example, epicardial image masks may be aligned with the epicardial surface of the chamber wall, such that it will contain the epicardial space encompassing the chamber. The myocardial image masks may encompass the walls of each chamber.

Exemplary myocardial image mask thicknesses include: 1.2×LV thickness for the image masks of the LV, 0.7×LV thickness for the RV, 0.4×LV thickness for the RA, 0.4×LV thickness for the LA, or other multiplication factors (for each thickness) for example, 0.4, 0.7, 1.0, 1.2, 1.5, or other smaller, intermediate or larger values.

In another example, neural structures are identified within the septum. Image masks may be created for the septum.

For example, at 4822 (repeated) the image masks are applied to the image to correlate and/or contain myocardium.

For example, at 4824 (repeated) the average and/or standard deviation of the functional activity may be calculated for the myocardium image masks. Average activity for the chambers may be denoted by A2LV, A2RV, A2LA, A2RA. Average activity for the heart may be denoted by A2H. Standard deviation of the activity may be denoted by SD2LV, SD2RV, SD2LA, SD2RA, SD2H.

Optionally, the calculated activity levels are normalized, for example, to a point or volume in the body, to a point or volume within the image mask space, or other methods. The normalization may allow for identification of the GPs for example, within the mediastinum.

Optionally, at 4828, GPs are identified within the applied image mask space. It should be noted that ‘GP’ term is used for ease of discussion and that the method may be applied for identifying ANS component(s) or for extracting or identifying other information relating to neural activities, or other tissues. Alternatively or additionally, GPs are identified within the organ volume and/or nearby tissues. Optionally, GPs identified within multiple different image masks that are combined into a single image of all the identified GPs, for example, the identified GPs within the organ. Alternatively or additionally, GPs identified within corresponding image masks of multiple frames (e.g., all image masks of the LV myocardium during the cardiac cycle) over time are combined.

Optionally, the GPs are identified by adjusting the position and/or size and/or shape of the image mask. Optionally, the image mask is adjusted based on the corresponding anatomical image. Optionally, the image mask is adjusted to exclude regions that may not physically contain GPs. Optionally, the functional data is adjusted instead of, and/or in addition to, and/or based on the adjusted image mask. For example, functional intensity data obtained from anatomical regions which may not include nerve structures, for example, inside the hollow (e.g., fluid filled) space, such as heart chambers and/or blood vessels. The chamber itself may not contain nerves. When intensity readings are detected in the chamber (e.g., next to the heart wall), the image data and/or image mask may be adjusted to reflect the estimated position of the intensity readings. Mask adjustment may be required, for example, when registration between anatomical image data and functional image data is imprecise and/or incomplete. For example, the anatomical image data and functional image data were obtained at different angles.

Optionally, the GPs within the image mask and/or organ volume are located. The relative position of one GP to another may be calculated, for example, in 2D and/or 3D.

Optionally, the GPs are combined together into an ANS map or ANS data. Optionally, connectivity between GPs is determined Connected GPs may be within the same image mask, within different images masks at different spatial locations, and/or within different image masks at different points in time (but at the same corresponding location). Optionally, the spatial relation between GPs is determined. For example, the relative location between a first GP with respect to the location of a second GP.

Optionally, areas of extreme activity are identified. For example, epicardial GPs (EGP) and/or myocardial GPs (MGP) are identified based on extreme mIBG activity.

Optionally, GPs are identified based on one or more predefined thresholds and/or rules. Optionally, GPs are identified based on size. Alternatively or additionally, GPs are identified based on activity level in reference to average activity and/or surrounding activity. Alternatively or additionally, GPs are identified based on connectivity between GPs.

Optionally, the GP may be identified as an object with a size of at least about 4×4×4 millimeters (mm) (e.g., for an EGP), or about 2×2×2 mm (e.g., for an MGP). Alternatively or additionally, the GP may be identified by comparing calculated activity (e.g., image intensity) of a certain region to surrounding activity in the same image mask. Alternatively or additionally, the GP may be identified by comparing calculated activity (e.g., image intensity) within the image mask to activity in another image mask. For example, the EGP may be identified as satisfying the rule that the total activity of the EGP is a predefined factor times the standard deviation (SD1 and/or SD2), above average activity (A1 and/or A2), and/or the adjacent activity surrounding it is lower than half of the EGP activity (e.g., correlated for volume). Optionally, the user may select and/or modify the predefined factor. For example, the MGP may be identified as satisfying the rule that the total activity of the MGP is another predefined factor times the standard deviation (SD1 and/or SD2), above average activity (A1 and/or A2), and/or the adjacent activity surrounding it is lower than half of the MGP activity (e.g., correlated for volume). Optionally, the user may select and/or modify the predefined factor.

Optionally, identification of GPs is performed per frame, optionally per frame of the dynamic cycle (e.g., cardiac cycle).

Optionally, the identified GP is automatically related to a tissue type. Optionally, the identified GP is related to the tissue type based on the applied image mask. Alternatively or additionally, the identified GP is related to the tissue type based on the characteristics of the intensity readings, for example, large sizes (denoting large GPs) may only be found in certain tissues. Optionally, different types of GPs are related to different tissues. For example, myocardial GPs are related to the myocardium and/or epicardial GPs are related to the epicardium.

Optionally, at 4830, one or more parameters are calculated for the identified GPs (also referred to herein as GP parameters). Examples of parameters include: average size, specific activity (e.g., counts per voxel of GP/average counts in the corresponding image mask volume), power spectra (e.g., power below 1 Hz, power between 1-5 Hz, ratio of high to low frequencies), normalized power spectra, GP connectivity map (e.g., connectivity and interaction between different GPs), number of GPs per predefined area (e.g., GP density number/square centimeter).

For example, for identified EGP, one or more of following parameters may be calculated: EGP size, EGP specific activity, EPG power spectra graph, EGP normalized power spectra (i.e., the difference between the EGP power at different frequencies minus the power of the total counts from the myocardial image mask space), EGP connectivity map.

For example, for identified MGP, one or more of the following parameters may be calculated: MGP number in an area and average size for each predefined area (Marshal ligament, left inferior LA wall, right inferior LA wall, other areas), MGP specific activity, MGP power spectra, MGP normalized power spectra (i.e., the difference between the MGP power at different frequencies minus the power of the total counts from the myocardial image mask space).

Optionally, calculation of GP parameters is performed per frame, optionally per frame of the dynamic cycle (e.g., cardiac cycle).

Optionally, at 4832, the calculated and/or other parameters may be normalized. Normalization may take place at one or more blocks of the method, for example, during and/or after acquiring the functional and/or anatomical images, upon calculation of functional activity, upon identification of GPs, upon calculating parameters for the GP, upon comparison of data over time, or at other blocks.

Examples of one or more normalization techniques include: raw data, raw data divided by the raw data value in a known fixed anatomical location acquired at roughly the same time (for example, the activity of the tracer in the patient's mediastinum), normalization to a normal patient data set, normalization to a value of the activity at the first or the last image acquisition from a sequence of acquisitions, normalization to value acquired at different physiological state (e.g., rest, stress), a combination of some or all of the above, and/or other methods.

Alternatively, the normalization of 4832 is performed instead of and/or in addition to, before a different block in the process, for example, before GPs are identified in block 4828. The normalization may help in identifying the GPs. For example, activity level (e g, mIBG level) at a local region is compared to an average value and/or standard deviation across the organ volume, within the image mask space and/or relative to a predefined threshold.

Alternatively or additionally, the calculated data (e.g., blocks 4824, 4828, 4830) and/or measured functional intensity are corrected for sensitivity. Optionally, sensitivity correction is performed within each image mask and/or in related image masks. For example, some areas may have relatively higher sensitivity to uptake of the radioagent, and some may have relatively lower sensitivity to the uptake of the radioagent. Optionally, the anatomical data is correlated to the sensitivity. Optionally, the image masks are generated (block 4820) based on different sensitivity levels, for example, one set of image masks for higher sensitivity nerve structures, and another set of image masks for lower sensitivity nerve structures. Optionally, the different sensitivities are normalized to a common baseline.

Alternatively or additionally, measurements of the functional data are normalized, for example, measurements of uptake of the radioagent are normalized to the level of corresponding chemical in the patient. Optionally, intensity measurements are normalized according to the level of activity of GP being identified. Optionally, measurements denoting activity of the GPs are taken. For example, in the case of mIBG, measurements may be normalized to the level of norepinephrine (NE) (and/or adrenaline and/or epinephrine) in the patient. For example, the level of NE is measured in the blood (e.g., by blood sample), urine, or other body fluids. The intensity of mIBG uptaken is normalized based on the measured NE. Additionally or alternatively, mIBG measurements may be normalized to a decay function of mIBG over time (e.g., from the injection of the mIBG). In another example, the level of activity is measured by non-chemical methods. For example, normalization of mIBG is performed based on measurements taken during a cardiac stress test (e.g., based on ECG measurements, heart rate, cardiac output, or other measurements). The measurements may be correlated with levels of activity of the GPs being identified (e.g., by a table, mathematical equation, or other methods).

Optionally, at 4834, data is compared over time. Optionally, changes in GP parameters over time are identified. Optionally, dynamic changes of the calculated parameters between different acquisition times are determined. For example, the changes in GP (e.g., EGP) activity over time may be calculated, from injection till 6 hours post injection, by repeating the image acquisition several times during this time window. The functional images may be acquired at more than one time after the tracer injection.

Optionally, at 4836, a functional image is reconstructed based on the mask applied to the functional data and/or image. Alternatively or additionally, an image is reconstructed based on the mask applied to the combined functional and anatomical data and/or images. The reconstructed image may contain the identified GPs, for example, as regions of increased intensity. The reconstructed image may be overlaid on the anatomical image, illustrating the physical location of the GPs.

Alternatively or additionally, the characteristics of the GPs within the functional image are reconstructed. The reconstruction is instructed by the image mask.

Optionally, at 4838, the calculated results (e.g., block 4828, 4830, 4832 and/or 4834) and/or reconstructed images (block 4836) are provided for presentation or otherwise provided to the operator. For example, presented on a monitor to a physician. Additionally or alternatively, the calculated results and/or reconstructed images may be stored in a memory for future use (e.g., diagnosis). The calculated results may help in diagnosing the patient and/or in guiding treatment.

Optionally, the results are provided for presentation on a certain frame, for example, the end systolic frame. Alternatively, results are provided for presentation on multiple frames, for example, a video of the cardiac cycle.

Optionally, the reconstructed functional image or combined functional and anatomical image is provided for registration during a treatment procedure. The reconstructed functional image may be overlaid on and/or registered with anatomical images obtained during the treatment procedure. The overlaid and/or registered images may be used by the operator to physically determine locations of the GPs during the treatment.

The method of FIG. 3B has been described with reference to the heart. The method is not limited to the heart, and may be used for other organs, hollow fluid filled organs (e.g., stomach, aorta, bladder) and/or solid organs (e.g., kidney, liver). GPs and/or nerve endings may be identified in the other organs. For example, the aorta may be segmented based on surrounding structure (bones, muscles, branching arteries) and image masks generated accordingly. For example, the liver may be segmented based on anatomical liver lobe divisions.

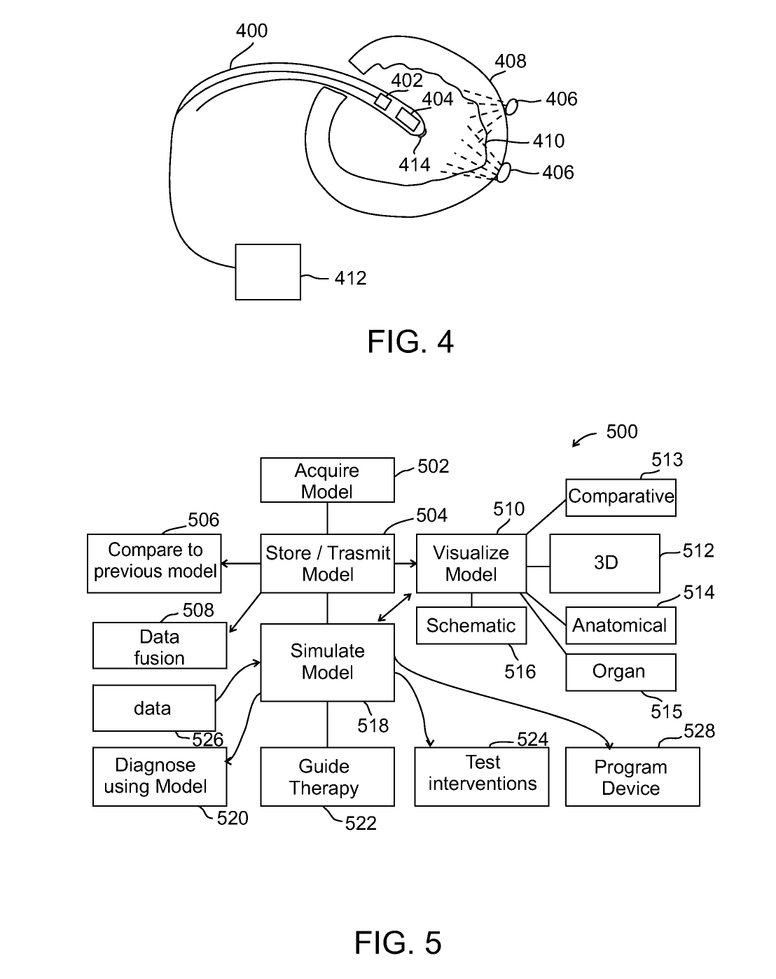

FIG. 4 illustrates an alternative method of ANS information collection, in which a probe 400 including a radiation sensor 404 (e.g., radioactivity detector) and optionally a position sensor 402 may be used to collect ANS information—e.g., to identify one or more ANS components 406, in accordance with some embodiments of the invention. In some exemplary embodiments of the invention, position sensor 402 may be an electromagnetic position sensor, such as the Carto® system by Biosense-Webster. Optionally or alternatively, other sensors are used. In some cases, the probe may be detected using an external position sensor, for example, x-ray imaging may be used to detect the probe. In some exemplary embodiments of the invention, the probe is a catheter or an endoscope.

In some exemplary embodiments of the invention, one or more ANS components 406, associated with an organ 408, emit radiation 410. Detector 404 is optionally directional (e.g., includes a lead collimator) and generates a signal indicative of the direction of an emitting source. A controller 412 optionally correlates such directions with positions sensed by position sensor 402, to generate a 3D representation of radiation emission, or at least an indication of the relative locations of ANS components 406 (e.g., ganglions).

Optionally, detector 404 has an attenuating member position in front of it, such that is will detect radiation with energy above a set threshold (e.g., overcoming scatter rays and eliminating information of remote targets). Optionally or alternatively, signal processing, such as energy windowing is used for scatter reduction.

Optionally, detector 404 has an side viewing window (opening in its collimation (if any)) that enables it to detect radiation emitted just lateral to the sensor, which may be useful when searching for ganglion from within a blood vessels, for ganglions that are located in close proximity to the outer vessel wall.

Optionally or alternatively, tissue may be identified as ANS related using one or more of the acts described above as 308-314.

Optionally or alternatively, to generating a 3D representation, in an exemplary embodiment of the invention, a probe such as 400 is used to detect a single ANS component, such as a ganglion and/or confirm its location and/or collect information therefore, such as activity level. In an exemplary embodiment of the invention, a therapeutic function 414, for example, one or more electrodes for RF or DC ablation, may be provided on probe 400 and is optionally used to treat (e.g., ablate) the ANS component.

Optionally or alternatively to using radiation detection, electric, magnetic and/or electromagnetic detection may be used to detect nervous activity of ANS component 406.

In some embodiments, a position sensor is not provided. Rather, for example, the ANS component detector 404 may be used to assess proximity to an ANS component.

In some embodiments, intensity of signal is used as a proxy for direction. For example, a signal is expected to be strongest when detector 404 (even non-directional) is closest to an ANS component 406.

Referring back to FIG. 3A, at 316 an ANS model may be optionally generated, populated, refined and/or adapted with data based on the image acquisition, and optionally used for display (324). For example, the image data may provide the number and/or relative intensity of activity of different ganglions.

In one example, a study of the upper gastro intestinal system is carried out on a patient with diabetes mellitus. In this patient, the investigator is trying to test the possibility that the diabetes is caused/worsened by the presence of a positive feedback loop connecting a first controlling ganglia with a second controlling ganglia; e.g., with the first ganglia responding to signal relating to the presence of hyperglycemia by sending a stimulatory signal to second ganglia which causes reduction in Insulin secretion and further rise of blood sugar. The model used is optionally a generic template based on prior information (e.g., optionally normalized for patient age, sex, disease state and/or ethnicity). Optionally, the generic model expects that there are two or three possible locations (e.g., anatomical locations or locations from among possible ganglions) for first ganglion and there are two to four possible locations for the second ganglion. In one example, the investigator uses an opto-accoustic signal generated after an acoustic signal (ultrasound) hits the ganglia that are electrically active, with the ganglia pre treated with a specific tracer. The investigator searches for the presence of the first ganglion (there may be more than a single first Ganglion); once identified, the investigator may seek a nearby second ganglion that has the closed loop activation connection between the two. For confirmation, the investigator performs a dynamic test, and keeps recording activity of first and second Ganglia. A fast infusion of concentrated glucose solution raises sugar blood level, causing increased activity of first ganglion and with a phase shift an increased activity of second ganglion and a documented rise in blood insulin.

In some exemplary embodiments of the invention, a model of the ANS is not generated, per se, rather, the collected information is matched to a set of existing models to determine a most useful model to use (e.g., and populate using the collected data).

In some exemplary embodiments of the invention, adapting/refining the model may also uses data about the organ (318) (also referred as organ data). In some exemplary embodiments of the invention, data about the organ is provided using nuclear medicine (NM) imaging of the organ, optionally done simultaneously, optionally with a same tracer, as used for the ANS. In some exemplary embodiments of the invention, the organ data includes functional and/or anatomical data about the organ which may be correlated, for example, as described herein, with ANS functionality and/or anatomy. Optionally or alternatively, to using an NM modality, a CT modality may be used to detect organ structure and/or mechanical behavior, including, optionally, changes over time and/or as a function of other behaviors.

In some exemplary embodiments of the invention, functional data about the organ may include electrical data which is collected, for example, using an ECG, EEG and/or EGC sensing system, as appropriate. In some embodiments of the invention, one or more components of the ANS is identified and/or measured using an external electrical (e.g., hi-res EEG like system) and/or magnetic (e.g., SQUID) sensing system.

Exemplary data acquisition techniques which may be used in some embodiments of the invention to collect ANS and/or organ data include, TPM and MRI (e.g., diffusion MRI), photoacoustic and optical photoacoustic microscopy.

Optionally or alternatively to collecting organ data, other data (320), such as blood hormone levels may be collected and provided to the modeling activity (e.g., of collecting data and generating and/or modifying a model to match the data).

Data for the ANS model may be re-acquired and/or updated, for example, within a few seconds, minutes, hours or days, depending on the application. For example, in a case of mapping the response of a ganglion to a stimulus, ganglia activity is measure before/during and/or after the delivery of the stimulus. There are stimuli that can be delivered within seconds (e.g. light flashes) or minutes (e.g. Glucose infusion) or hours (e.g., rapid atrial pacing for causing atrial fibrillation) or prolonged (e.g. physical training in an athlete or the effect or remodeling of the myocardium after revascularization).

At 322, the model is optionally analyzed and at 324 the model (e.g., static or dynamic) and/or analysis results are optionally displayed to a user and/or sent to a further analysis system and/or storage.

It should be noted that model information (e.g., information collected or otherwise received for generating, modifying and/or otherwise updating an ANS model) may be generated also from non-imaging studies. For example, if a model of the ANS predicts certain behavior under certain circumstances, measuring the circumstances and the results may be used to calibrate an existing model. Optionally, such an existing model may use anatomically generated networks of ANS components (e.g., using normal arrangements of tissue of a general population).

Optionally or alternatively, an analysis of an ANS model and/or disease may be used to guide data acquisition, for example, a database may store the association of certain malfunctions with certain ANS parameters. Identifying a malfunction, such as prostatic hypertrophy, may suggest to collect data about certain parts of the ANS. It is well known that transecting the sympathetic input to the prostate will cause a reduction of its volume by around 30%. In patients with benign prostatic hypertrophy one may use the generic model of the ANS enervation of the prostate gland. An imaging modality is optionally used to co register anatomical information (e.g. ultrasound, CT, MRI etc.) and functional information (e.g. MIBG Spect Mapping, or MIBG 1124 PET mapping).

In some embodiments, the model is mainly functional. For example, a known input, such as breathing, is correlated to behavior in different parts of the ANS, for which information is then collected.

Referring back to acts 308-314, in some embodiments of the invention, model building (e.g., generating, modifying and/or otherwise updating an ANS model) may be interactive. In one example, a part of the ANS is deactivated (e.g., by cooling, chemical or using a suitable electrical signal) or stimulated (e.g., using a chemical or electrical signal) and the effect on the ANS may be determined.

In an example of acquiring data for atrial fibrillation, a simple model (e.g., single hyperactive ganglion) may be used to collect data. If this model predict patient response which stimulating the patient, this model may be used for treatment, otherwise, a more complex model (e.g., several ganglions forming a feedback loop) is used. In an exemplary embodiment of the invention, such changes in modeling are applied during an ablative procedure. For example, a catheter is inserted into the atrium and a ganglion is ablated or ablated in part, then a determination is made to see if the resulting effect is what was expected. If not, the model is modified to match the new data. Optionally, an automated search over possible parameter spaces for the model and/or for several alternative models is made and a best matching model/parameter set is used.

A model may also be used to predict non-immediate effects of therapy, for example, by the model also modeling (e.g., having stored expected effects) healing and/or adaptive/post-therapy changes. In an exemplary embodiment of the invention, when an expected and desired effect is achieved and the model indicates that this effect predicts a desired outcome, ablation is stopped, even if the immediate effect is not the desired final effect.

### Using a Model

FIG. 5 is a flowchart 500 showing methods of using an ANS model, in accordance with exemplary embodiments of the invention.

At 502 an ANS model is acquired, generated, updated and/or otherwise provided, for example, as described herein (e.g., in accordance with method 300).

At 504 the model may be stored and/or transmitted. Storage may be used, for example, for later comparison with the model and/or for physical transmission and/or for processing thereof. Various data formats may be used for the ANS model, for example, matrixes of variables and XML files.

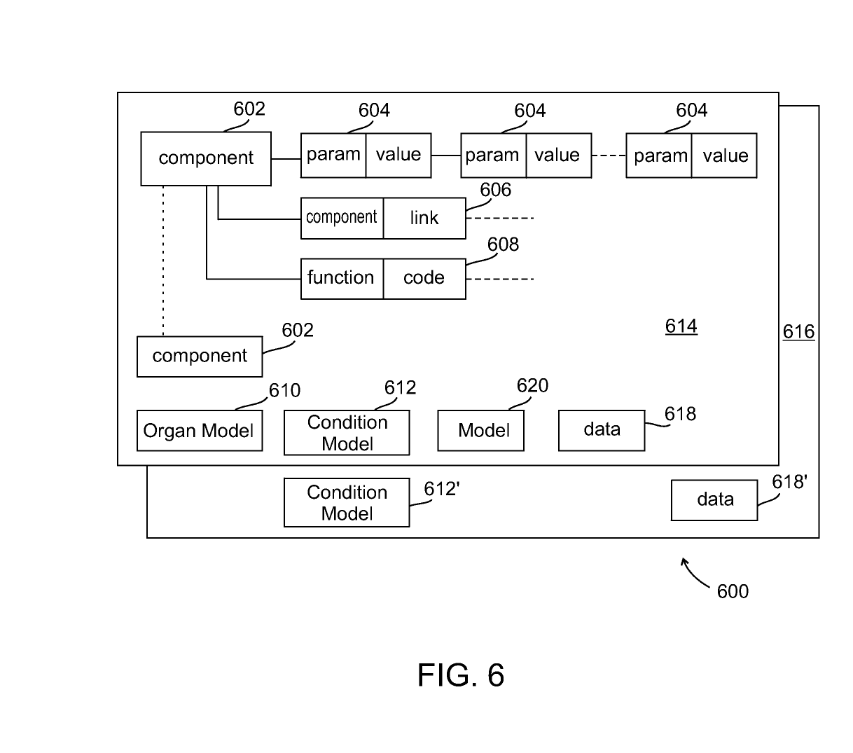

FIG. 6 is a representation of a data format for an ANS model 600 of the ANS, in accordance with some embodiments of the invention. In this example, a model of the ANS includes an indication for one or more components 602, each associated with a plurality of parameters and values (604). In some exemplary embodiments of the invention, each component may be also associated with one or more other components to which it is linked (606). Optionally, such a link is also a component and may include one or more parameters and/or values.

In some exemplary embodiments of the invention, a component 602 may include one or more functions 608, which can include, for example, code which when executed carries out the function. In some cases, code and/or values are stored as links or IDs to a central database (which may be stored remotely) which has the actual data (e.g., the code). Optionally, the central database may be accessed by a network, e.g., internet.

In some exemplary embodiments of the invention, a model unit 620 includes the physical model to which the functional model matches. Optionally or alternatively, some of parameters 604 indicate a matching with an anatomical model (e.g., association of ANS model components with real ANS components).

In some exemplary embodiments of the invention, a model includes between 1 and 40 components, for example, between 3 and 10 components, for example, between 3 and 8 ganglions.

Optionally, the model format also includes non-ANS model information. In one example, an organ model (anatomical and/or functional) 610 is provided. Optionally or alternatively, a condition model (e.g., blood chemical levels) 612 is provided.

Optionally, model 600 may include original data 618, optionally linked to one or more parameter values 604. This may allow a reprocessing of the data to provide model parameters, for example, using different algorithms.

In some exemplary embodiments of the invention, the model is provided as a plurality of models 614, 616, for example, each one associated with different conditions (e.g., as data or as models) 612, 612′ and/or different data 618, 618′. Optionally or alternatively, multiple models are provided for other reasons, for example to provide multiple interpretations of acquired data, for example, for different diseases and/or different assumptions and/or to reflect the effect (real or projected) of different treatments. In some cases, multiple models, or a same model with different parameters-taken from the same patient at different time—are provided, e.g., to allow a user (e.g., a physician) to identify changes over time in one or more ANS components (e.g., before and after a treatment is applied).

Not shown, an ANS model format optionally includes personal information such as age and social security number or other ID. Optionally or alternatively, the ANS model includes medical data such as medical history. Optionally or alternatively, the model includes acquisition data, such as imaging type, tracer used and imaging protocol.

Referring back to 504, in some exemplary embodiments of the invention, the ANS model is stored on a data carrier, optionally in an encrypted form. Optionally, the encryption prevents at least part of the model or its data from being read without a key. Optionally or alternatively, the model data is write-protected at least in part, for example, using a checksum or digital signature. In some exemplary embodiments of the invention, the model is encrypted at least in part and provided with a reader which can display relevant data about the model but cannot be used to modify write-protected parts of the model. Optionally, different parts of the model have different types and/or degrees of protection.

In an exemplary method of use, a patient is imaged—e.g., by nuclear imaging—(or data, e.g., model information, is otherwise collected) at a first location (e.g., imaging clinic or hospital) and data for a model (e.g., data for generating an ANS model) or the ANS model itself are packaged and provided in physical form, to the patient, for delivery to another user of the ANS model (which may be on the same site—e.g., same hospital, or at another site). Optionally or alternatively, the data for a model or the ANS model is electronically transmitted to the other site. In one example, the other user is a medical image-based navigation system where the model is overlaid on a navigational image. In some exemplary embodiments of the invention, payment for using the model is required to unlock the model for usage by the navigational system.

In some embodiments, the results of the model are communicated to the patient verbally and/or used to decide on optimal drug therapy such that the ANS diagnostic step actually is not reported per se to the patient nor to the practicing doctor. Optionally, the diagnosis is automatically fed into a machine learning tool adjacent to the ANS diagnostic machine as an input. With the ANS test results and possibly with ancillary information the machine learning tool optionally matches optimal therapy recommendation to a specific patient. The information generated by the ANS model is used to modify and/or confirm or test an ANS optimized medical prescription or therapy.

In an exemplary embodiment of the invention, information collected about the ANS and/or its effect on body organs is used for diagnosing a disease which may be part of a process of treating a patient. In an exemplary embodiment of the invention, the data collected and analyzed by the ANS system can be analyzed with the model as described herein and the results of the model used as the input for an optimization algorithm for matching the optimal therapy for the patient, or the data regarding the ANS can be fed in its raw form and let a machine learning algorithm build the optimal classifiers of predicting groups.

Typically, machine learning based diagnosis and optimal therapy recommendation is powered by a large volume of controlled data. This “learning data set” is used to train the machine to sort through multiple inputs per patient and find the combination of those that predict the wanted outcome. In an exemplary embodiment of the invention, the learned data set or tagged data set is provided by stimulating a patient and measuring reaction of his ANS thereto.

In an exemplary embodiment of the invention, the ANS (of the patient) is evaluated with an ANS test as described herein. In an exemplary embodiment of the invention, the ANS test is a model based test as there is often a prior understanding of the ANS in the system, for example, including prior information of any one or combination of the following: location, size, activity, connectivity, functionality, mode of activity, mode of operation, mode of control, ancillary information reading the organ the connectivity, the dynamic situation, the state the information is sampling, demographic information on the patient, patient historical information (e.g., ANS and/or non ANS related).

In an exemplary embodiment of the invention, based on the model the way to best to acquire information (e.g. static, dynamic, over the head or over the abdomen, for 1 minute, or for a day, absolute or relative values, etc.) is selected. Optionally, a list of exemplary methods and/or parameters is available and a computer can indicate which method or combination thereof is (most) likely to provide useful information (e.g., based on machine learning techniques and/or user programming).

Next, some or all the acquired information is fed into the machine learning program. Optionally, also the outcome to be predicted is inputted (e.g., selected from a list, e.g., drug response, ablation response, a specific prognosis of the patient). The machine is trained the machine to identify this response (e.g., in the collected data). Optionally, the machine learning algorithm or module uses the model for learning and/or classification, but this need not be the case in all embodiments.

At such other site, the data may be used in various ways. In one example, a model is constructed at the site and the constructed model or a transmitted model are compared (506) to a previous model, for example, a previously stored model of the patient or a normative model. In some exemplary embodiments of the invention, by comparing the models and efficacy of a treatment may be estimated and/or treatment modified, as needed. In some embodiments the comparison is manual. In some embodiments, the comparison is graphic. In some embodiments, the comparison is automatic.

At 508, optional data fusion is carried out, for example fusing the model information with anatomical information.

At 510, the model (and/or comparison and/or fusion) is optionally visualized. In some exemplary embodiments of the invention, the visualization uses a 2D or 3D display, or even 4D or 5D, for example as discussed above. The model itself may be, for example, displayed as a plane, as a 3D space (512) and/or optionally as a manipulatable 3D object. Optionally, multiple layers of information are available which are optionally selectively controllable for visualization purposes. In some exemplary embodiments of the invention, the visualization is static. In other embodiments, the visualization shows temporal effects, for example, being at real-time speed, or faster or slower. Optionally, an operator can control the speed of “playback”.

In some exemplary embodiments of the invention, the visualization is schematic visualization (516). A most schematic visualization simply indicates a disease state. A more elaborate visualizations indicates all the ANS members and pathways between them, optionally including pathways that are not abnormal and/or not targets of treatment. It is noted that for some treatments ablation of a normal pathway may cause an abnormality in a different part of the ANS section to become more normal.

In some exemplary embodiments of the invention, the visualization is anatomical (514). In one example, the true 3D layout of model parts is shown.

In some exemplary embodiments of the invention, the visualization is with reference to an organ (515). In one example, a 2D or 3D visualization of an organ or part thereof is used with reference (e.g., mapping) to one or more ANS model portions. In some exemplary embodiments of the invention, the visualization is as an overlay over a 3D (or 2D or 4D) image data set of an organ. Optionally, such a visualization may be useful when a physician performs both navigational and therapeutic and/or diagnostic tasks, which relate to the ANS. In one example, the image navigation system is a Biosense-Webster Carto® system.

In an exemplary embodiment of the invention, when the user interface allows the selection of various data layers and/or resolutions, for example, of the model and/or of an anatomical image and/or schema and/or organ functional data.

In some exemplary embodiments of the invention, the visualization is comparative (513). In one example, two models (e.g., two ANS models of the same patient taken at different time, ANS model of a patient with a disease and ANS model of normal patient without such disease) are shown side by side or overlaid. In some embodiments, differences may be highlighted or otherwise conveyed to a user (e.g., physician).

At 518, the model is optionally simulated. For example, the model may be executed at real speed, faster than real speed or slower than real sped. In some embodiments, the model is provided in a visualized and/or simulated form and visualization and/or simulation comprise display and/or usage of such provided form. In some exemplary embodiments of the invention, additional data (526), for example physiological state and/or a simulation of other body systems are used as an input into the model simulation.

In some exemplary embodiments of the invention, visualization (510) uses a simulation of the model to generate data therefore. In some other embodiments, the model is visualized as is without simulation.

In some embodiments, the visualization and simulation are carried out on different devices. In some embodiments, a local computer uses one or more remote servers for model simulation and/or analysis and/or display generation.

In some exemplary embodiments of the invention, a user interface is provided to modify one or more of variables, display parameters and/or model parameters. In one example, the UI comprises an input GUI for setting one or more variables. Optionally or alternatively, the UI includes a display showing the effect of such changes, on the model and/or a diagnosis. In an exemplary embodiment of the invention, the UI is set up so that the display can show an ANS member input and output traffic and its connectivity. Optionally, a touch screen is provided to allow a user to indicate that a certain pathway be disabled (e.g., in a model or in real-life, for example, by ablation with an external source, such as focused ultrasound or another energy transducer, such as catheter based energy delivery system). Optionally or alternatively, a user can indicate corrections to the model and the system will calculate a new “best” model to match the extracted data and any constraint applied by the user.

At 520, a diagnosis (e.g., manual, automatic and/or machine assisted) is optionally carried out using the ANS model, for example, using visual analysis of the simulation results and/or using automated analysis of the model (e.g., static or structural information) and/or simulation results thereof. In some embodiments, the model is not used for direct diagnosis, but is used to select a further procedure and/or tool (e.g., ECG, NM imaging) for such diagnosis. In some exemplary embodiments of the invention, a diagnosis (and/or visualization results and/or simulation results) is bundled with the model, for example, on a data carrier. Optionally, the diagnosis (and/or visualization and/or simulation results) is protected from change, for example, using a digital signature on the diagnosis and the model.

In some exemplary embodiments of the invention, model simulation is used to predict what measurements are to be expected during a real diagnostic procedure, optionally a diagnosis carried out after therapy or a different diagnostic procedure.

Optionally or alternatively, to diagnosis, the model simulation is used to guide a therapeutic procedure (522), optionally in real time. In one example, the model is used to identify a part of the ANS to ablate. In another example, one or more therapies are “test driven” (524) on the model by applying the therapy to the model and then rerunning the simulation under one or more conditions. Optionally, such testing (e.g., with a set of conditions, such as “rest”, “meal”, “running”) is carried out automatically. In some embodiments of the invention, real-time display of an immediate and/or projected effect of an ongoing therapy is displayed. Optionally, by automatically trying out several treatment locations and/or several potential treatments and/or several parameter value sets, a single or several best or acceptable treatment options may be automatically determined. Optionally, what is displayed is a best location to treat and/or a desired treatment location. Optionally or alternatively, what is displayed is a score of an immediate or expected effect of treatment.

In some exemplary embodiments of the invention, a display is provided during an interventional treatment, for example, overlaid on an image used for navigation—e.g., an ANS model may overlay the image used for navigation.

In some exemplary embodiments of the invention, therapy may use implanted devices and/or usage of pharmaceuticals. In some exemplary embodiments of the invention, simulation is used to plan and/or program such devices and/or drug regimes. In one example, a user can indicate a desired effect and/or response to various situations and a search program can use the simulation and a set of variable parameters to determine which parameter values to apply to achieve the desired results.

In some embodiments of the invention, an implantable device (or other treatment device) is programmed (528) to include a model and optionally circuitry to execute the model, so as to enable determination of desired treatment parameters by the device or using circuitry associated with the device. Optionally or alternatively, the device is programmed to apply a therapy, for example, taking into account the model or on the basis of the model and/or other concurrently applied therapies.

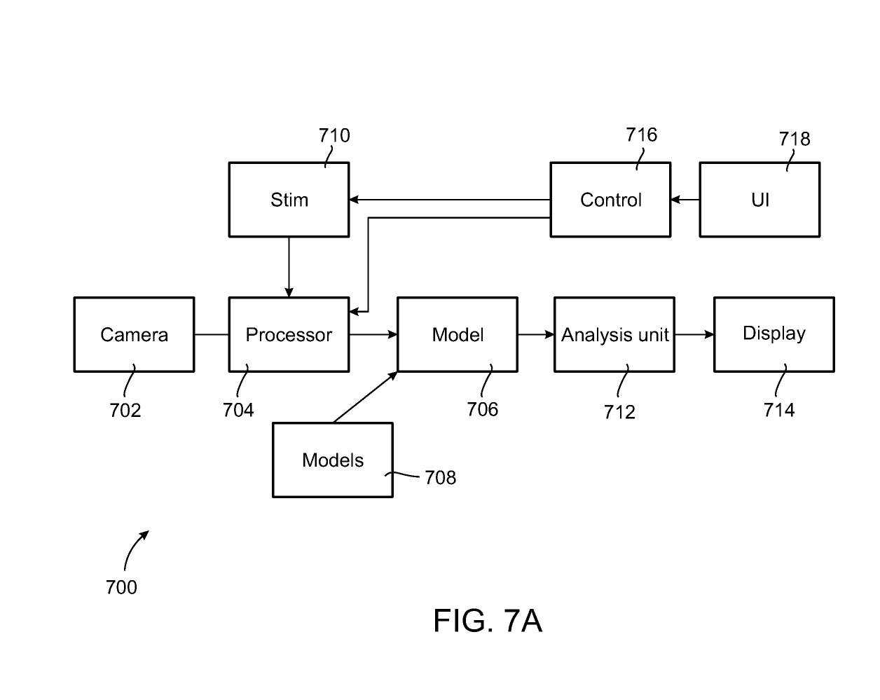

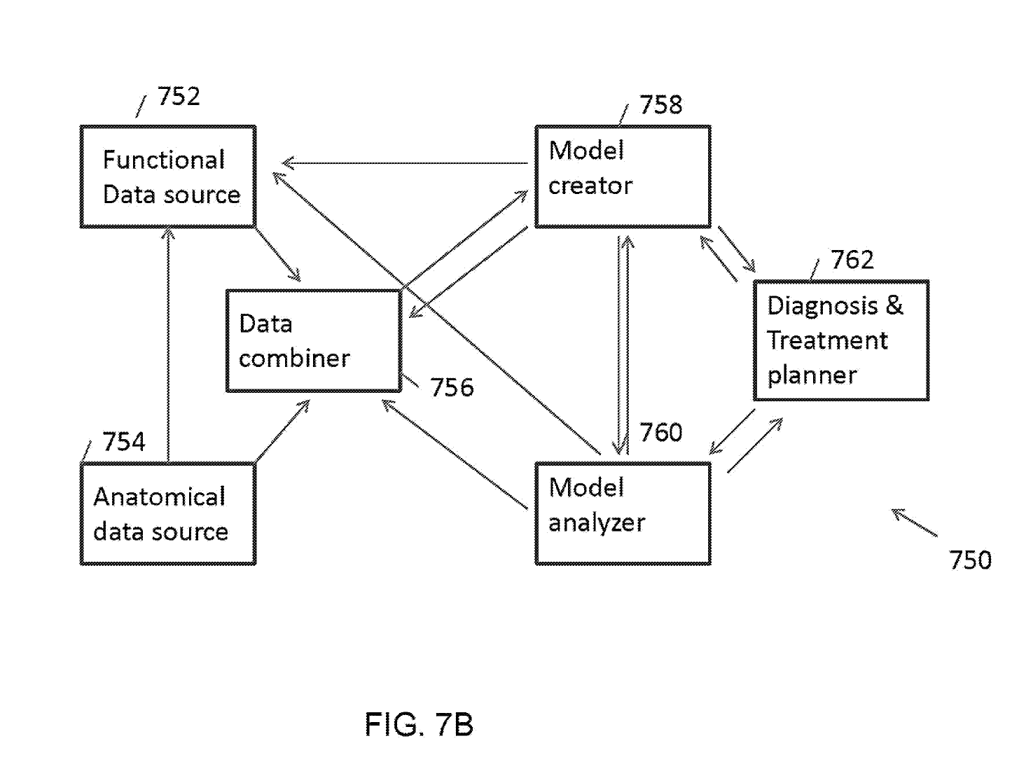

FIG. 7A shows a system 700 for acquiring and/or using a model in accordance with an exemplary embodiment of the invention. Such a system may include one or more non-transient memories including code and/or using circuitry to provide function as described herein.

A camera or other image or data acquisition subsystem 702 is used to acquire data. In an exemplary embodiment of the invention, the camera is a nuclear medicine camera, for example, the D-Spect camera available from Biosensors group. A processor 704 controls the camera, for example, guiding acquisition to coincide with stimulation and/or tracer injection and/or according to an acquired image and/or an ANS model which is being populated.

A model 706 is optionally populated using data extracted by processor 704. Such extraction may be carried out at a remote server. Optionally, one or more models 708 are provided in storage and selected therefrom is the model used in 706.

In an exemplary embodiment of the invention, the model is analyzed using an analysis unit 712, for example, using methods described herein and a display 714 is optionally used to display the model and/or analysis results. A UI 718 is optionally provided to control the display and/or model and/or usage of the model. For example, a controller 716 (e.g., in an implanted device) may be used to provide a stimulation (e.g., by ablation or by electrodes 710). Optionally, processor 704 modifies and/or times the imaging and/or data collection to such stimulation. Optionally or alternatively, the UI is used to directly and/or indirectly modify data collection and/or extraction, for example, by selecting a model to be populated and/or disease to be tested for.

### Example of Model Acquisition System

FIG. 7B is a block diagram of an image/data acquisition system 750 for use together with modeling, in accordance with some embodiments of the invention. A functional data source, for example, nuclear medicine data, for example, provided by a nuclear medicine imager is combined with anatomical data from an anatomical data source 754, such as a CT imager, by a data combiner 756. In some embodiments of the invention, the methods described for FIGS. 3A and/or 3B are used for such combining so that data regarding GPs can be extracted. In some embodiments of the invention, data combining includes extracting nervous system related information. Optionally or alternatively, data combining comprises determining locations of nervous system components. In some cases, the anatomical data is used to assist in reconstructing and/or guiding the acquisition of functional data (e.g., to guide imaging to acquire information about heart rather than liver).

A model creator 758 is optionally used to build (e.g., and/or populate) a model of the ANS and/or associated tissue, such as organ tissue, from the combined data.

A model analyzer 760 is optionally provided to analyze the model. Optionally, such analysis can determine inconsistencies and/or missing portions. For example, as shown, if a model suggests that a certain GP is of interest, additional functional data may be desirable and functional data source 752 may be guided to acquire and/or reconstruct existing data accordingly. For example, the noise level in parts of the model may suggest that a different reconstruction scheme (e.g., smaller or larger GPs, other GP positions) and/or different views (e.g., not blinded by liver) may be desirable. Optionally or alternatively, data combination may be carried out differently depending on the model being created and/or various properties thereof (e.g., noise levels, reliability, completeness, coverage of extreme and/or potentially dangerous conditions). In some cases, a human is requested to obtain additional data. It is noted that functional data may come from several modalities, for example, imaging and electrophysiological measurement.

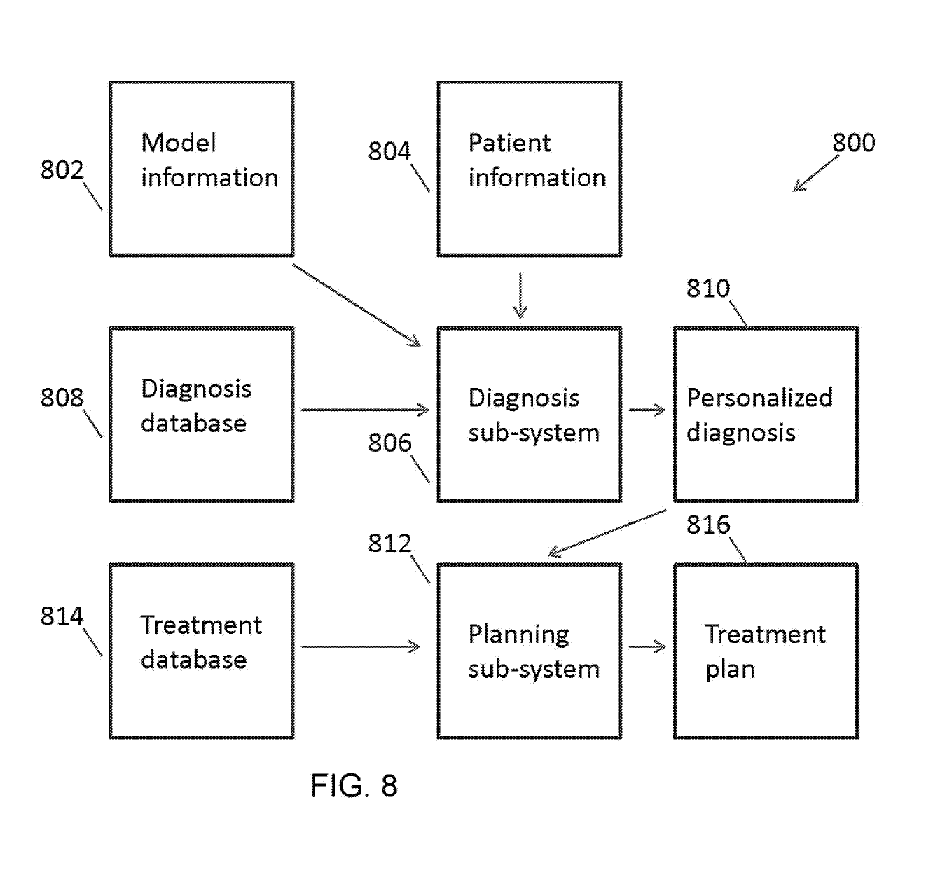

A diagnosis and/or treatment planner 762 is optionally provided. In one example, the model and/or various properties of the model may be used to determine a diagnosis of a patient (e.g., as described herein and/or with reference to FIG. 8). Optionally or alternatively, a treatment plan for the patient may be automatically created and/or created with human intervention (e.g., a computer suggesting one or more alternatives and a human selecting plans and/or parts thereof and/or suggesting changes. Optionally or alternatively, a human may create a treatment plan to be vetted, simulated and/or changed by planner 762.

In some embodiments of the invention, the treatment plan and/or diagnosis may suggest that a different model be created and/or that different data in the model be analyzed. For example, if the treatment plan includes the ablation of a certain GP, it may be desirable that reliable data be available regarding that GP and/or its effect on different conditions and/or its behavior in various circumstances. In some cases the model analyzer uses information provided form a database of models and/or model behaviors, for example, of previous patients of the instant patient at other times.

### Exemplary Diagnosis and Treatment Sub-System

FIG. 8 is a block diagram of a model analysis and treatment planning system/unit 800, in accordance with some embodiments of the invention. Once a model is available, it may be, for example as noted above, used for diagnosis and/or planning a treatment. Unit 800 may carry out the functions of various model analyses described herein. In some cases, unit 800 is integral and/or co-located with imaging and/or treatment systems. In some embodiments, however, it is remotely located and/or distributed and may be provided as a service. In exemplary embodiments of the invention, rather than provide a user with a model of the ANS, what is provided is a combination model and treatment plan or possibly just a treatment plan. Some exemplary treatment plans are described below.

In a first stage, diagnosis, model information 802 (e.g., the GPs and their interconnection and/or activity level) and patient information 804 (e.g., patient demographics, history and/or previous response to therapy) may be provided to a diagnosis sub-system 806. Optionally, diagnosis sub-system 86 uses a diagnosis database 808 (e.g., rules, example diagnoses, machine learning data) to assist in providing a diagnosis. Optionally or alternatively, diagnosis sub-system 806 may include one or more modules which apply processing on the model to extract diagnose. In some exemplary embodiments of the invention, the diagnosis database is updatable and/or parts thereof are available at different and/or additional cost. The result may be a personalized diagnosis 810. In an exemplary embodiment of the invention, the diagnosis database includes a plurality of templates, each one optionally associated with one or more possible diagnoses and/or including instruction for missing data to assist in diagnosis. Optionally or alternatively, at least one dynamic template is used. Such a template may be useful, for example, if a disease is characterized by a temporal pattern of behavior. Such a template may include, for example, multiple snapshots with a time indicator or define a function of change over time and/or in response to a trigger.

In exemplary embodiments of the invention, personalized diagnosis 810 is provided to a planning sub-system 812. In exemplary embodiments of the invention, planning sub-system 812 generates a treatment plan suitable for the patient, base on the diagnosis and/or best practices. Optionally, a treatment database 814 (e.g., exemplary treatments, rules) are used to aid in treatment planning. Optionally or alternatively, planning sub-system 812 uses modules to plan various parts of the treatment and/or to determine if parts of the treatment are reasonable and/or safe. Information(s) 802 and/or 804 may also serve as input for the treatment planning, for example, to help determine what effect a treatment may have on a patient. The result may be a treatment plan 816.

In some exemplary embodiments of the invention, treatment plan 816 includes one or more of: a plurality of locations to be treated, an expected measurement for the effect of treatment of a location, treatment parameters for one or more of the location treatments and/or alternatives for one or more of the locations. Optionally, the plan includes a time line indicating the order of treatment and/or delay times between treatment locations.

In some exemplary embodiments of the invention, a treatment is defined with a time scale of several minutes, hours or days, for example, defining a wait of between 1 and 1010 minutes or between 1 and 20 hours between treatment locations.

It should be noted that diagnosis and/or modeling may be improved by taking into account the effect of treatment. In some exemplary embodiments of the invention, a treatment plan includes a suggestion to recalculate model and/or diagnosis and/or treatment plan, for example, in response to a measurement exceeding a certain threshold or matching a certain pattern and/or otherwise fulfill a rule.

### Examples of Model-Based Diagnosis

Following are some exemplary methods of diagnosing a patient condition using an ANS model, one or more of which may be used in accordance with some embodiments of the invention.

In some embodiments, an ANS model is analyzed to detect changes. For example, changes in ganglion activity and/or reactivity (e.g., change in activity due to a stimulus, optionally measured as a value and/or as a time profile) as compared to other ganglions and/or as compared to baseline values from a same patient and/or a database. Optionally, the amount of change which is meaningful is dependent, for example, on the activity of other components of the ANS, controlled organ and/or physiological indicators. In some exemplary embodiments of the invention, what is compared is statistics to other statistics and/or ranges of values.

In some embodiments, a relationship is determined between ANS activity, size and/or number of ANS components and/or function and/or dysfunction level of an organ or organ part. For example, a highly active ANS with a low organ output may be one indication. In another example, a large ANS associated with controlling a dysfunctional organ portion may be indicative.

In some exemplary embodiments of the invention, what is searched for is a correlation between ANS activity and dysfunction of organ parts (e.g., size, cellular state, electrical dysfunction) and/or dysfunction function of an organ (e.g., food absorption). Such a correlation or other relationship may assist in finding diseases where the ANS serves an important factor in causing and/or maintaining a disease state. Such diseases may, practically speaking, require treatment of the ANS (e.g., and not necessarily or only an affected organ) if healing is to be provided.

In some embodiments, ANS structure and/or functioning is compared to organ structure. For example, a high ANS activity correlated with a disproportionally large muscle indicates chronic over activation.

In some embodiments, ANS models are analyzed to determine if there is sufficient and/or a correct level of coordination between different parts of the ANS and/or organ. For example, a table may be provided indicating expected correlation between activity levels in different parts of the ANS (e.g., between organs and/or within organs). Over-correlation may indicate a confounding excitatory factor. Under-correlation may indicate a communication problem and/or a separate driving factor for at least one of the ANS components.

In some embodiments, what is compared is the correspondence between activity at different levels of the ANS. Unusual levels may indicate an over controlling hierarchy and/or a separately excited level.

In some embodiments, what is analyzed is the dynamics of a model. For example, the inherent frequencies and/or amplitude of changes of activity may be analyzed, and, for example, if exceeding certain limits, indicate pathology. Optionally or alternatively, what is analyzed is change in reactivity, for example, change in degree, direction and/or type of reaction of the model to certain stimulations. For example, a higher than expected or lower than expected reactivity amplitude and/or shorter or longer reaction times and/or shorter or longer durations of reaction, may indicate a disease.

In some exemplary embodiments of the invention, model analysis is used as an input for later monitoring. In one example, failure situations predicted by the model are watched for during monitoring. In another example, correlations between ANS behavior and organ behavior are noted and monitored over time.

In some exemplary embodiments of the invention, analysis of the map is used to plan surgical or other procedures where nervous tissue may be damaged. Optionally, a path which minimizes a functional effect of such damage is chosen based on said model and/or simulation of one or more possible damage types on the model.

In some exemplary embodiments of the invention, model analysis includes advanced analysis of the model, for example, using network theory.

In some methods, stability analysis is applied to detect, for example, one or more of a frequency of expected occurrences, a typical and/or extreme profile of an unstable situation and/or expected triggers and/or conditions which increase the probability of lack of stability. It is expected that in some patients lack of stability may cause transient events, possibly of considerable (e.g., one or more minutes, one or more hours) of abnormal behavior. Examples of an effect of such transients include, a sudden increase or reduction in blood pressure, sudden fluctuations in insulin, sudden fluctuations in alertness level, sudden reductions in strength and/or feelings of nausea.

In some embodiments of the invention, modeling includes modeling a whole body or significant portions thereof. In one example, such a model generates or includes a causal relationship between body parts showing how activity in one part of the body at one intensity causes an effect in a different body part, possibly at a delay.

In some embodiments of the invention, analysis includes analyzing the model to detect missing model parts (e.g., missing ANS components) and/or parameters. For example, methods used in analysis of social networks, maybe used. In some embodiments, the model is created from an existing model, using the input data to tweak the model. Optionally, missing ANS components are “imported” from the base model. Optionally, allowance is made for previously damaged and/or removed ANS components, for example, ganglions damaged during excitable tissue ablation.

In an exemplary embodiment of the invention, diagnosis distinguishes between several cases where the ANS has a significant role, though a combination thereof and also other cases exist:

a. the ANS is faulty and is stimulating the organ for no other reason. In such a case observing other parts of the organ of the ANS that are still normal can assist in selecting a therapy which will negate that primary faulty activity.

b. the ANS is being driven by organ input that change sits response form a damping mode (e.g., mode 2 or mode 1) to an excitatory mode (e.g., mode 3). This may also be due to ANS dysfunction.

c. the ANS has a role in disease creation, but this is due to “normal” activity thereof. In one example, in a patient with Hypertrophic obstructive cardiomyopathy (HOCM) the hypertrophy of the upper part of the intraventricular septum causes a partial obstruction of blood from the left ventricle. Under some conditions this reduced LV blood flow causes reduction of arterial blood pressure which activated a baro-receptor reflex that will cause an increase in sympathetic drive to the heart. The increased sympathetic drive will eventually increase the level of septal hypertrophy thereby reducing blood flow out of the LV even more. This further reduction will increase the sympathetic stimuli to further hypertrophy the septum. In this case the ANS response is completely normal (based on the positive-negative response) however, this “normal” response is actually is crucial in generating the vicious cycle. This may also be the case when an organ exceeds the compensatory functions of the body and the normal operating of the ANS serves to further degrade the organ, rather than shutting down some of the organ activity which would have otherwise allowed it to recover or slow decline thereof. Modulating the ANS may be used to provide such a shutdown/reduction.

Examples of Intra-Organ Closed Loop-Based Diagnosis and/or Treatment

In some embodiments of the invention, diagnosis and/or treatment are based on a model of organ-nervous interaction which includes closed loops. In some exemplary embodiments of the invention, a “healthy” closed loop is assumed to include a significant component of negative and/or positive feedback which maintain the behavior of an organ within a range, while allowing adaptation to changes in conditions however, while positive or negative feedback which cause significant changes in organ behavior may be reasonable at times, in a diseased organ it may exceed a certain threshold and become pathological. In some embodiments of the invention, diagnosis includes identifying such conditions by model analysis. Optionally or alternatively, treatment comprises treating such conditions by treating, e.g., ablating, one or more GP so that it will not drive the organ-nerve system outside of a desirable range of behavior.

In some embodiments of the invention, treatment, for example, of chronic disease conditions is by targeted modulation of closed loop reflex control circuitries within or adjacent to the treated organ.

Referring in greater detail to the model used for modeling organ-ANS interaction, it is assumed that a significant part of control of an organ by the ANS is using a reflex control mechanism as the fundamental way of controlling the function of an organ.

In exemplary embodiments of the invention, the model assumes that the ANS is structured in a typical fashion of:

a. An input arm originating from a sensing apparatus located within the body;

b. An output arm with a termination within the controlled organ; and

c. A controller/processing unit modulating the input to generate an output based on:
(i) Predetermined program of the controller
(ii) Input from other controllers
(iii) The state of the controller, such state can be
   (1) Negative-Negative state (STATE I)
   (2) Positive-Negative state (STATE II)
   (3) Positive-Positive state (STATE III)

In some exemplary embodiments of the invention, data about organ behavior and/or functional imaging data is used to populate such a model (e.g., with GP relative activity and/or GP processing function).

In some embodiments, it is assumed that chronic disease conditions are self-sustained or self-worsening over time and this assumption is translated into an assumption that the state of the controller is (too often and/or too strongly) in STATE I and/or STATE III

In some exemplary embodiments of the invention, a diagnosis database includes set of observations and an indication if the disease is of a STATE I type or STATE III type and/or which GP might be at fault (e.g., based on other patients where treating a certain GP improved the condition). In some cases, what is treated is not the GP but the input to the GP. For example, not eating will change the input to a GP relating to the stomach. In another example, blood hormone levels can be used to increase or reduce ANS activity levels in general. Localized delivery may have a localized effect. In another example, local pain affliction affects local ANS components. In another example, anti-arrhythmia drugs may be provided to “wean” the ANS from STATE III behavior where arrhythmia begets arrhythmia. Optionally, other treatments, such as ablation, electrical and/or direct pharmaceutical injection are used.

In accordance with some embodiments of the invention, apparatus and methods (e.g., as described herein) are provided to detect the presence, location and/or function of the ANS controlling mechanism of a body, an organ and/or part of an organ.

In some exemplary embodiments of the invention, diagnosis and treatment planning include providing for a disease and/or organ a definition of allowed STATE I and/or STATE III behavior (e.g., % time, time profile, duration of periods, synchronization or lack thereof with various triggers and/or events and/or other indicators which may represent, for example, stress on organ and/or interfering with organ activity or physiological output). In exemplary embodiments of the invention, treatment continues and/or is varied until behavior matching this definition is reached.

### Populating a Model

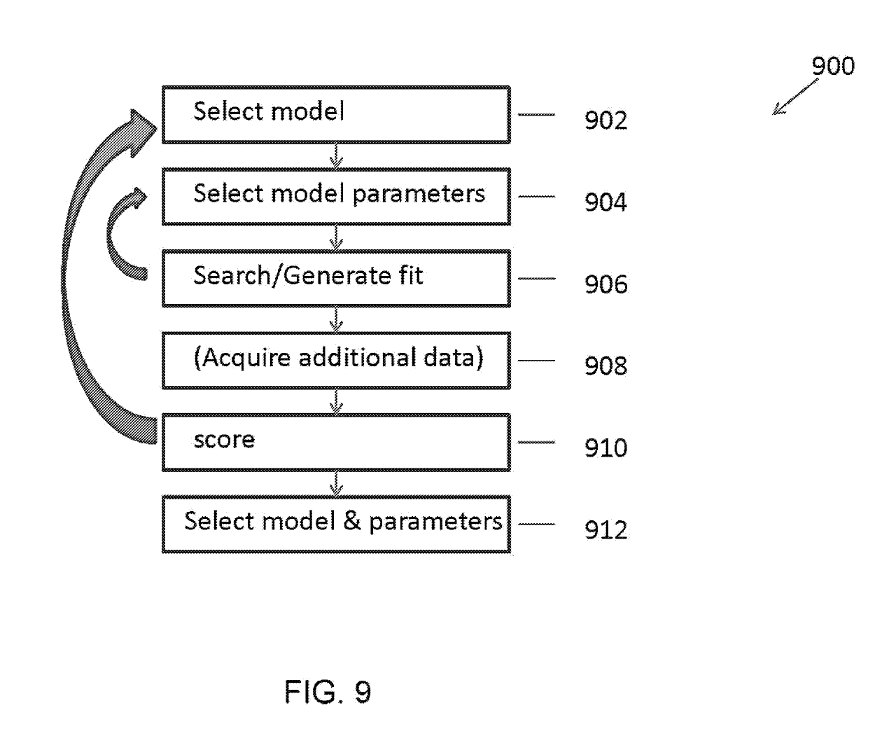

FIG. 9 is a flowchart of an exemplary method 900 of populating a model (e.g., an ANS model) in accordance with exemplary embodiments of the invention. Optionally, this method is computer implemented, for example on a processor.

Optionally, at 902, a model to be populated is selected, for example form a database of available models. Optionally, the model is selected based on, for example, disease, expected diagnosis, patient history, organ and/or other personal and/or physiological information.

In some exemplary embodiments of the invention, the model is created, rather than populated. For example, the model may be created with each detected GP acting as a node and all neighboring GPS interconnected by a link. The initial behavior of each GP can be, for example, a default U shaped behavior (e.g., minimizing output when far from extremes). Optionally or alternatively, one or more GPs may be assumed to have a non-U shaped behavior, for example, be an inverted U behavior or a raising or declining behavior (e.g. increasing output to one or both extremes of input).

Optionally, at 904 initial model parameters are selected, for example based on a database of model values, for example, matched to patient demographics, current physiological condition and/or disease state.

Optionally, at 906 a search of parameter space is made to find a better fit between model parameters and actual physiological measurements. Various search and/or fitting methods known in the art may be used (e.g., various forms of hill climbing for search and least-squares for fitting between a vector of parameters and a vector of the model). In exemplary embodiments of the invention, the fitting attempts to predict measured behavior by the model, when the model is simulated using the parameters. For example, a search may be made to find which single GP is most likely damaged to best predict a certain temporal profile of AF.

New initial parameters may be selected based on the results of the search and/or fit.

Optionally, at 908, if needed, additional data may be acquired. Optionally, only some of the data is used for searching and some of the data is used to test the quality of fit.

Optionally, a scoring is provided at 910, optionally using the fit to data not used for the search (e.g., the system may use some data for searching and some data for testing/scoring a suggested fit). In some embodiments, the score reflects one or more of a best fit, a fit with least chance of incorrectly identifying an incorrect GP as diseased and/or a simplest fit.

A new model may be selected based on the scoring. Optionally, when the models are generated, the new model may be found by searching the potential model space, e.g., using hill climbing or other optimization methods. Optionally, the search searches through topologies of models and/or different modeled GP behaviors.

Optionally, at 912, one or more models and/or parameter values for models are selected, for example, based on scoring.

As may be appreciated, in some exemplary embodiments of the invention, the model is assumed to be a three state model, where each GP acts according to one of three states (e.g., U shaped response=stateII, increasing response=stateIII and decreasing response=stateI).

Examples of Error Based Diagnosis and/or Treatment

In some exemplary embodiments of the invention, it is assumed that a significant part of ANS control is provided using a mechanism of error, in which a GP generates a greater signal where there is a larger difference (“error”) between its input and a reference signal (e.g., possibly an internal state, but typically an input). For example, a GP may generate a control signal which is greater if there is a greater difference between feedback from the organ and a “command” from a higher level of organization in the body, such as the brain. For example, shivering may increase if a temperature command signal form the brain is significantly different from a sensed (by the nerve) temperature signal.

In general, in such a system the GP command changes the state of the network (e.g., ANS and organ), by changing a state thereof in the direction of a minimum “error”. As noted above, this may be in the form of a closed loop.

In some exemplary embodiments of the invention, this insight is used to detect problematic GPs by looking for GPs that generate a strong signal of activity even if the state of the physiology appears stable. If many GPs are so activated, this may indicate over activity of both excitatory and inhibitory GPs (e.g., GPs that generate mainly signals that excite or inhibit, respectively, target tissue). Even if only one type of GP is images, a mismatch over several GPs between the level of activity and effect on physiology may indicate under-reacting organ tissue and/or over reacting inhibitory activity, possibly both, possibly due to chronic over-excitation of a component of the system and/or chronic under-response to excitatory and/or inhibitory input.

In some exemplary embodiments of the invention, this insight is used to specify a measurement of reactivity of a GP to its input and/or analyzing such reactivity to detect a disease condition.

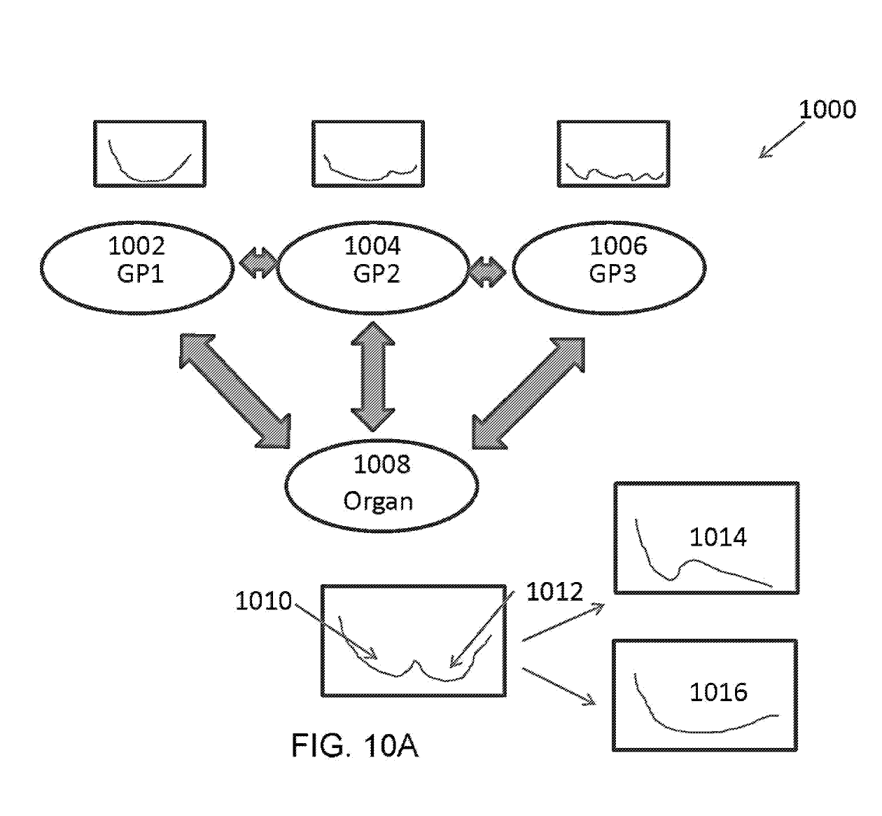

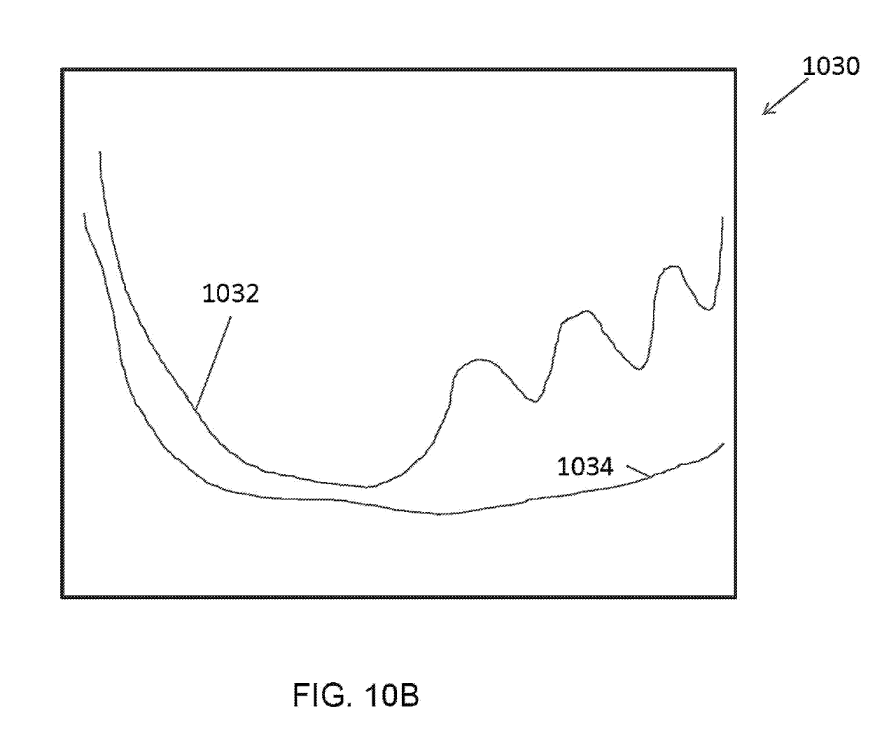

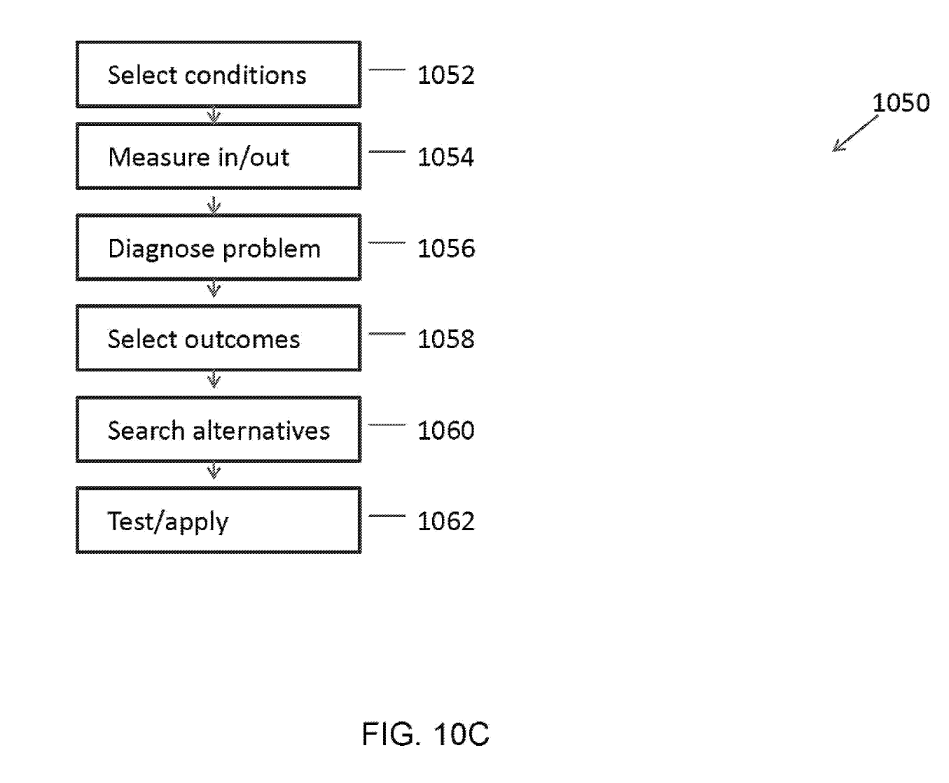

In some exemplary embodiments of the invention, the output signal of a GP is measured over a range (e.g., input dynamic range) of input to the GP. For example, the range can be defined by forcing an organ to act in a certain way (e.g., increase stomach distension) and measuring GP output (e.g., command which is supposed to cause stomach emptying). While described and shown (FIG. 10A, 10B) as one dimensional relationships between input and output, it should be appreciated that the input may be multi-dimensional as may be the output.

In some exemplary embodiments of the invention, for each GP, an attempt is made to measure its output over a range of inputs, for example, using an electrophysiology catheter or electrode or by measuring NM activity over various conditions. This may produce a chart linking input to output. Such a chart may be modeled, for example, to define one or more minima (e.g., to which the GP strives), maximum output(s), general slope, shape (U or other) and/or various artifacts, such as the number of minima, the range of inputs, the range of outputs and/or slope of output. Optionally, a GP is classified by matching its behavior to a library or using a different classification technique. Optionally, a GP may be associated with an expected healthy behavior, so diseased GPs can be detected. However, it is important to note that treatment is sometimes not directed at a diseased or most diseased GP, but rather at a part of the ANS/organ complex where treatment will provide a good chance to return to normal activity and/or avoid or reduce abnormal activity this may mean ablating a healthy GP.

In some exemplary embodiments of the invention, generating the measurements includes forcing the body into various physiological changes and/or applying triggers, including mechanical, chemical and/or electrical, to elicit a desired range of GP and/or organ activities.

FIG. 10A is a diagram shown a simple schematic ANS model simplified to be a GP model 1000, possible behaviors of GPs and an organ and possible outcomes of treatment, in accordance with some exemplary embodiments of the invention. In the models, GPS 1002, 1004 and 1006 interact to act on an organ 1008. The small charts show the response of each GP and the total response of the organ.

As can be seen, the chart of GP 1002 appears healthy, the chart of GP 1004 is diseased and the chart of GP 1006 is pathological. However, what is important is the chart of organ 1008, which includes two local minima 1010 and 1012. This means the organ can be trapped in a wrong and over active minima. In some cases, the existence of multiple minima may be acceptable and there may be a different characteristic of the chart (e.g., organ activity) which it is desirable to change, for example, the stability of a minima (e.g., how high the walls are surrounding it) and/or slope of the chart. Such other parameters can be treated/approximated using same methods as described herein, in accordance with exemplary embodiments of the invention.

This is a “toy” example, so the following is not based on a real analysis. But it can be imaged that an analysis of the system may show, for example, that ablation of GP 1006 may lead to chart 1014, which is unacceptable, as it includes a potential run away at its right end. An alternative 1016, due, for example, to ablation of GP 1004, appears acceptable.

In some exemplary embodiments of the invention, the treatment system can select which GP to ablate based on a simulation of the effect of ablating each GP. Such simulation may look at various characteristics of the result, for example, correctness of total result, loss of control ability, risk of runaway and/or amount of organ activity (e.g., position of minima along horizontal axis). Other treatments may be simulated as well (e.g., systemic or local drug delivery).

Optionally or alternatively, the treatment is selected by temporarily incapacitating a GP (e.g., by cooling) so that charts 1014 and 1016 can be measured.

FIG. 10B shows a different example, reference 1030 is a chart of a prophetic example showing the effect of systemic drug provision to treat an ANS disorder, in accordance with exemplary embodiments of the invention. Under a diseased condition, line 1032 includes multiple minima at a high range of organ activity. This may tax the organ and cause chronic problems and ultimately organ failure.

Treatment, for example, by a systemic drug, will reduce the overall control of the organ, but will specifically disappear the extra minima and the high organ activity at these minima, as shown by line 1034.

FIG. 10C is a flowchart of diagnosis and treatment selection 1050 in accordance with some exemplary embodiments of the invention, which summarizes some of the above described method.

Optionally, at 1052, a range of conditions under which the ANS/organ are to be tested and/or expected to operate correctly are selected.

Optionally, at 1054, measurements of GP and/or organ input and output are made, optionally including forcing of conditions and/or stimulation and/or artificial input to an organ and/or GP.

Optionally, at 1056, a problem, if any, is optionally diagnosed. For example, the problem may be multiple minima, minima at an undesired horizontal location, too high an activity level (vertical location), strong slope and/or danger of runaway.

Optionally, at 1058, one or more desirable outcomes and/or end conditions are optionally selected.

Optionally, at 1060, available treatment options (e.g., GP ablation, drugs) are tested (by simulation) against the model to detect which treatment best approximates a desired outcome and/or is otherwise desirable. Alternatively, a user may suggest a therapy and its outcome and/or desirability shown to the user. It is noted that a combination of therapies (e.g., ablation and drug) may also be tested and/or suggested. It is noted that in some embodiments a treatment effect is translated/mapped into/using measured and/or modeled ANS and/or organ parameters.

Optionally, at 1062, treatment is applied, optionally first testing an effect of such treatment, for example, by temporary deactivation of a GP and testing organ and/or other GP response in its “absence”.

The above has focused on steady state behavior. It is noted that some GPs and/or organs show cyclic and/or semi-repeated or repeated behavior. For example, the ANS has a spike of activity in the heart synchronized to contraction (e.g., measured using an inserted catheter and/or electrode inserted into or near a cardiac nerve. It should be appreciated that an indication of disease may be a mismatch between such expected activity and actual measurement. Similarly, a desired treatment may be to resynchronize the activity to the heart cycle. In the above chart representation, “minima amplitude” can be mapped to difference (e.g., average square of distance) form the desired timing parameters. Other mappings may be used as well, and/or no mapping, with a different analysis method being used than minima on charts. For example, a selected outcome may be defined as minimizing an amount of activity outside of a certain window. Such non-chart definitions may also be provided for non-repeating behavior, for example, a desired outcome in FIG. 10A might be “90% of organ activity below 50% of maximum”.

Referring back to repeating activity, such activity may be averaged, for example, based on cardiac cycle position, possibly using binning to collect together similar parts of a cardiac cycle and/or cluster together similar cardiac cycles. In other tissue which is not so cyclic, traces of activity can be aligned and combined based on a time relative to a trigger event (e.g., contact pressure or sensory input). It is also noted that expected repeated activity by an ANS component may be used for detecting such a component, for example, as described above.

Examples of Treatment Plan Creation and/or Usage

A particular feature of some embodiments of the invention is that there are often multiple treatments which may have a same general therapeutic effect, with different side effects. In addition, there may be a lack of information regarding side effects, efficacy and/or ability to compensate, to allow one to choose between treatments.

Another particular feature of some embodiments of the invention relates to treatments being complex, in that they may involve multiple treatment points, possibly applied in a particular desirable order and/or timing and/or with a desired measurement of feedback during the treatment.

In some exemplary embodiments of the invention, a treatment plan is devised and/or provided in a manner which allows a physician to deal with one or both of the above considerations.

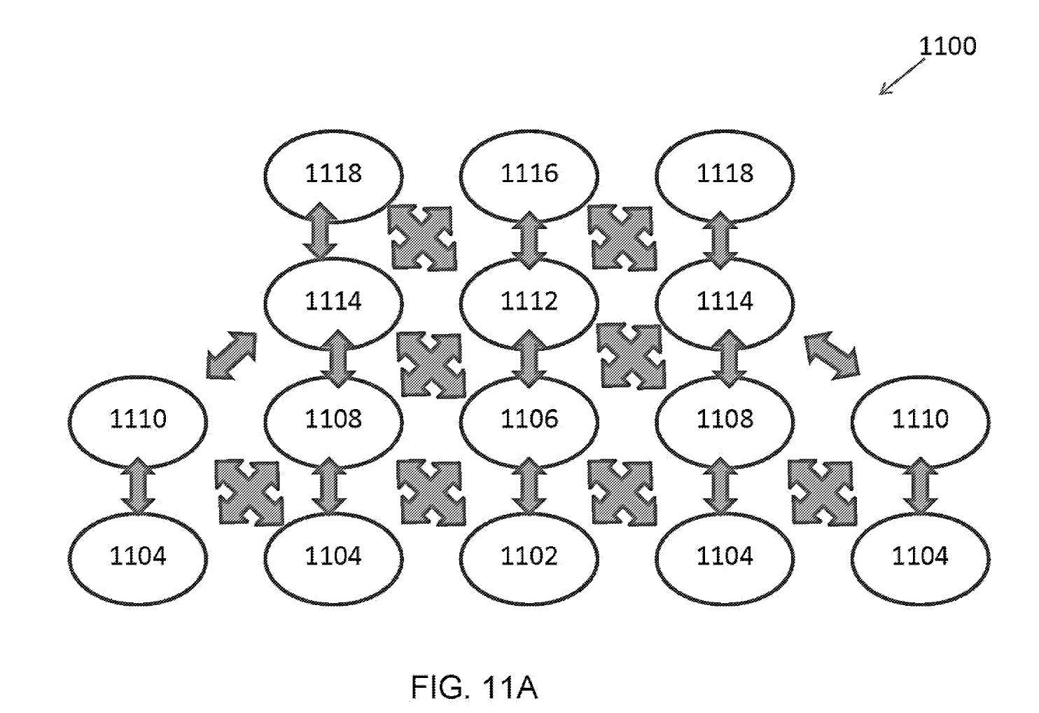

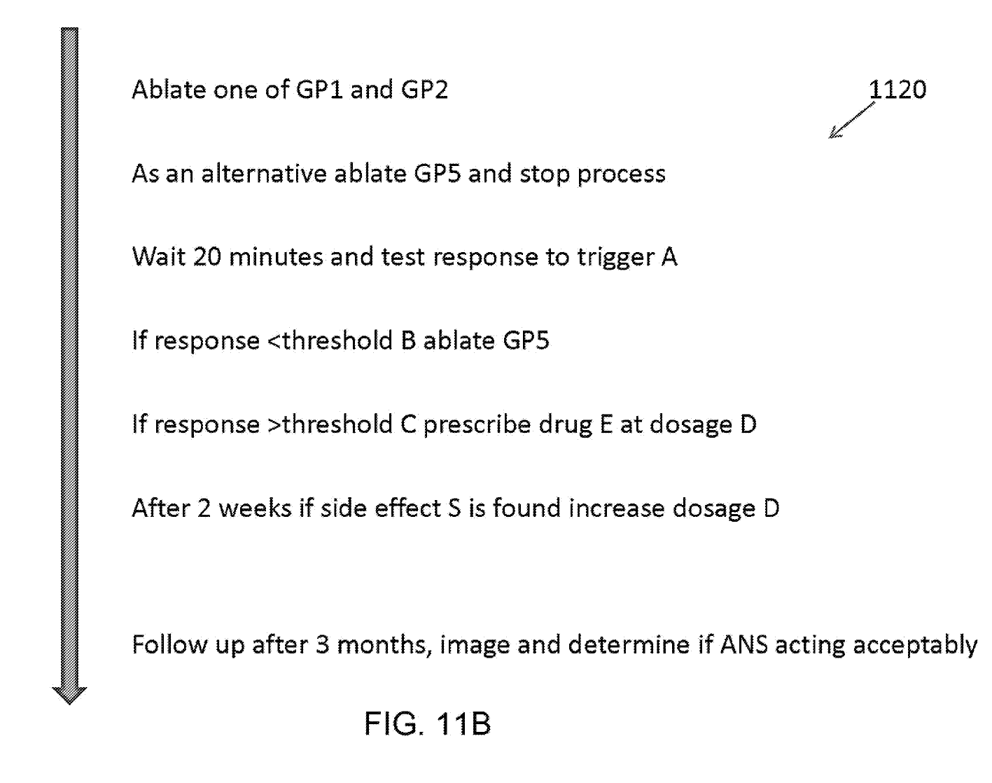

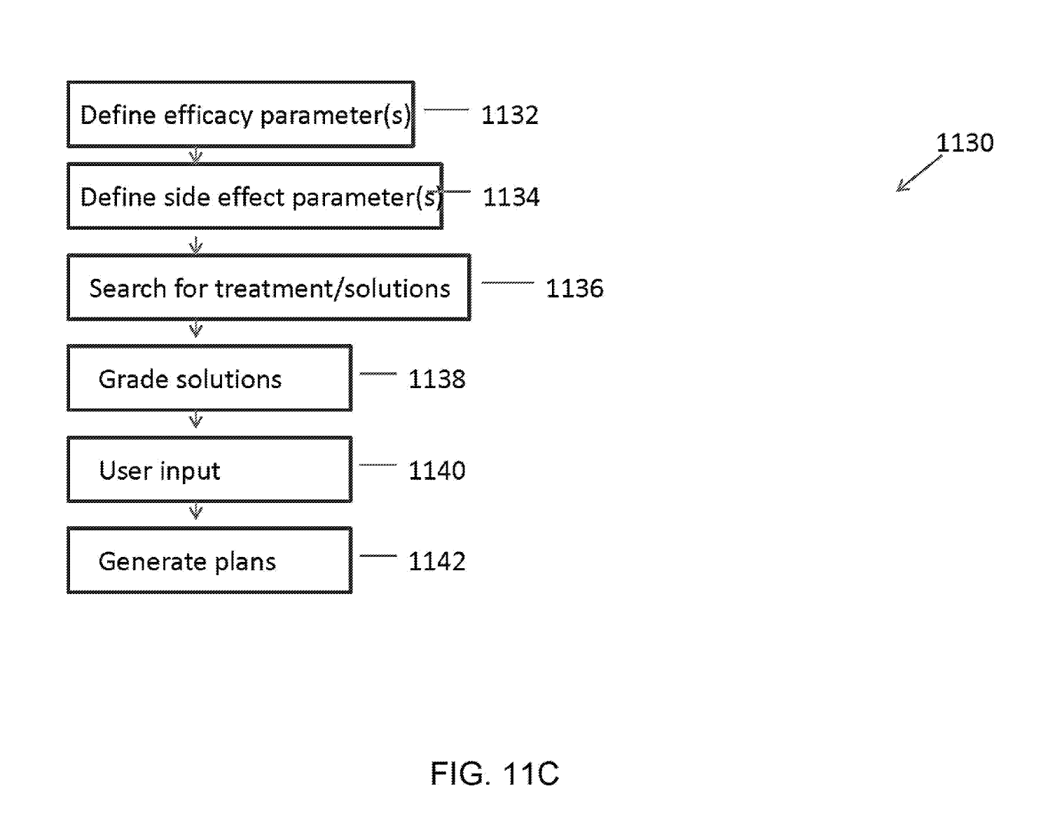

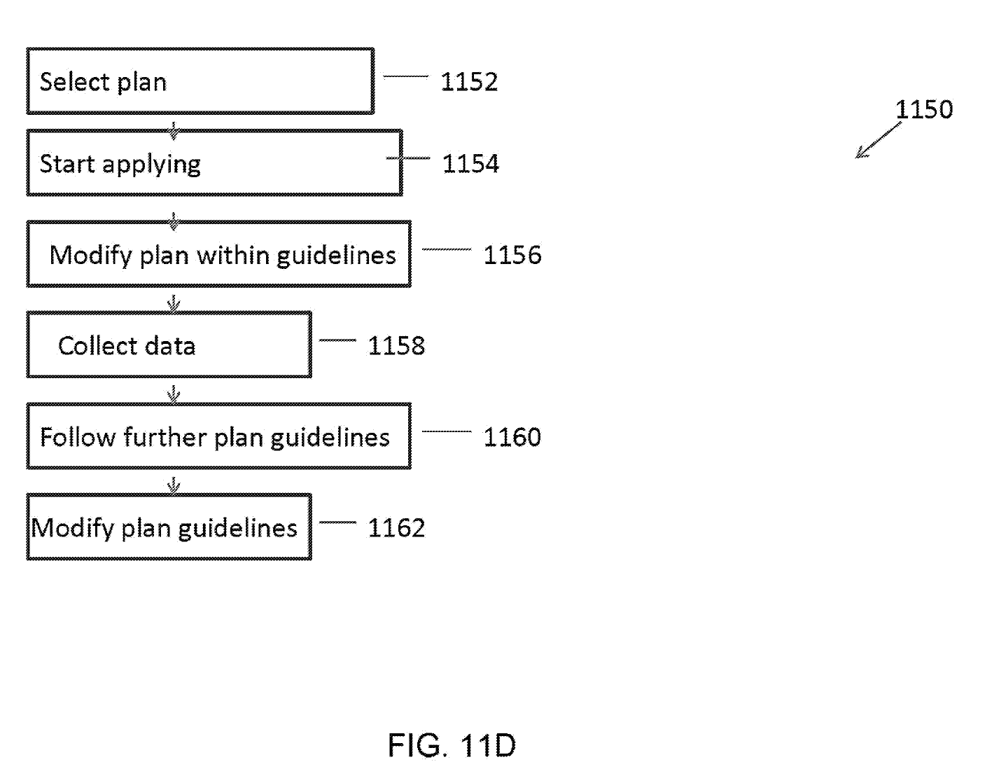

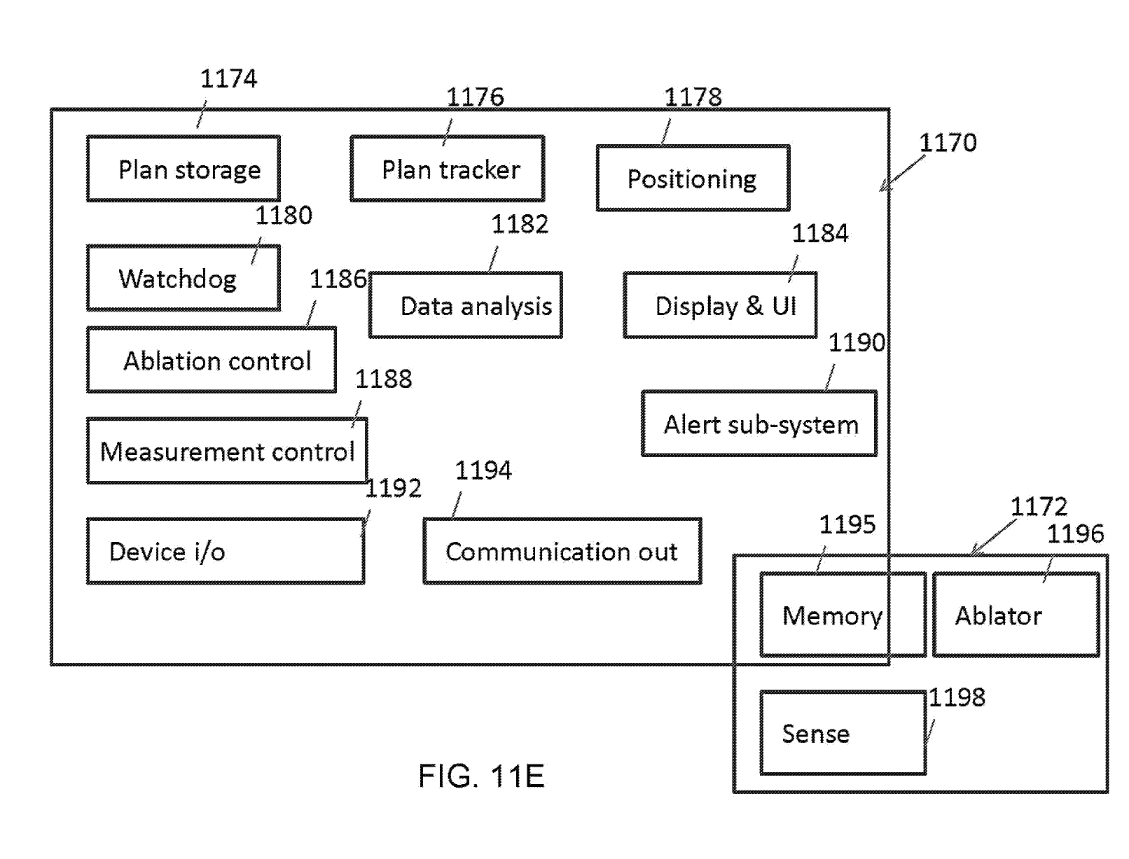

FIG. 11A is a schematic showing a network 1100 of an ANS and organs illustrating the effect of various treatment options, in accordance with exemplary embodiments of the invention. In the figure, the lowest level (1102-1104) represents organs and the higher levels are successively remote GPs. 1102 is the target organ, 1104 are organs that are not supposed to be affected. More remote ANS components 1110 may be minimally or not affected or significantly affected based on the selection of the “level” of intervention (e.g., distance in the network form the target organ 1102). Also, for simplicity is it assumed that the connections are only along arrows and that each connection is symmetrically efferent and afferent. These assumptions change the actual treatment, but do not substantially affect the general analysis that follows.

The autonomic nervous system innervate the heart the lungs and all other internal organs of our body. The innervation of these organs is both for collecting sensory input from these organs as well as transmitting efferent ANS instructions to the organ. The sensory information collected from an organ comes from multiple sensors within the organ, sensing multiple parameters including, for example, pressure, temperature, chemical metabolites, vibration, etc. The information gathered from one location in the organ (1102) is transmitted from that location into the ANS network in a divergent manner (e.g., to 1106, 1108 and then 1114-1112 and then 1116-1118). This divergent distribution relates to the ever growing portion of the ANS potentially affected by the organ. However, generally, the importance of the organ sensing is diluted as the distance from the source increases (e.g., due to multiple inputs that dilute the effect of a single input and/or due to closed loops within GP sets). The information gathered from multiple inputs is processed at certain stations called ganglia (e.g., 1106-1118). The results of processing the multiple inputs is an output, or a set of output from each of the ganglia. The outputs (Efferent activity of the Ganglia) is sent from the ganglia to the organ in a convergent way. The closer to the organ there will be less input from more remote ganglia.

The measuring and/or modeling methods described herein allow the organ to be measured at different states and/or determine or estimate the activity of many stations (ganglia) of the ANS (close and remote to or from the organ). Analysis, for example as described herein, can rate the relevance of particular ganglia for one or both of conveying the afferent signal to higher ganglia and conveying the efferent signal to the organ.

In some exemplary embodiments of the invention, when selecting treatment to manipulate one or more ganglia, these considerations are taken into account.

In some exemplary embodiments of the invention, the selection of one or more treatment points to apply consider one or more of the following considerations (optionally as an optimization and/or search problem, optionally weighting each of the one or more considerations used):
(a) Severity of the clinical problem;
(b) Expected side effects on organs and their severity, including one or both of interference with input from such organs and commands to such organs;
(c) Effect on functioning of target organ;
(d) Availability of ameliorating treatments for the side effects (e.g., pharmaceuticals); and
(e) Expected treatment effect, which may depend, for example, on location of treated target, clinical problem, modeling results and/or prior knowledge of the pathophysiology of the disease state.

In some exemplary embodiments of the invention, treatment planning includes selecting one or more targets, optionally on a per-patient basis, using the model and/or using the above considerations.

In some exemplary embodiments of the invention, treatment planning is used to select a plurality of treatments. Optionally, a treatment database includes a plurality of template treatments and the above search/optimization is applied as perturbations to the treatment templates. Optionally, such a template may define which parts thereof should be more difficult to change during an optimization and process and which parts should be easier to change. For example, the order of two ablations may be allowed to change, while a particular ablation location may not be allowed to change, or vice versa (e.g., depending on the disease).

FIG. 11B is a time line showing an exemplary treatment plan 1120, in accordance with some exemplary embodiments of the invention. As noted, an actual treatment plan may include several alternative complete plans. In some exemplary embodiments of the invention, the plan includes a human readable part (e.g., as described below) and/or a machine readable part, for example, for controlling parameters of ablation, setting thresholds and/or defining safety consideration. For example, the step of ablating GP1 or GP2 (below) may be coded with desirable ablator (e.g., catheter) location and ablation settings. In application, the system may alert if such settings cannot be applied or if the catheter is not located properly and/or if a post-ablation measurement indicates a minimal desired ablation was not achieved.

A first step (after a model is available) is to ablate either GP1 or GP2 (e.g., as marked in model and anatomical map one or both of which are optionally provided with the plan). The physician may determine that one GP is easier to access and/or measure than the other and/or may have a different and possibly less desirable side effect.

As an alternative, GP5 may be ablated, though this may have more serious side effects so it is less preferred.

After a 20 minute wait (optionally enforced by the treatment/ablation system), a trigger A (e.g., electrical stimulation) is applied and a measurement (e.g., arrhythmic effect) is made.

The plan may include a logic, for example to perform another ablation, of GP5 if a threshold is not reached.

The plan may include non-immediate therapy, for example, prescribing drugs if a certain threshold is exceeded. It should be appreciated that conditions to be met in the plan may be defined other than by thresholds. For example, a condition may be defined as a matching of a pattern or using fuzzy logic or being a best match among several possibilities.

The plan may include post plan activities, such as a recommendation to check after a time (e.g., 2 weeks) if a side effect needs to be treated. Optionally, the treatment system generates an alert based on the therapy applied to a patient. Such alert may be, for example, to the patients handling physician or the patient, for example, by email, SMS and/or other messaging technique.

The plan may include a desired time for checking the effect of therapy, for example, three months, after which further treatment may be desirable.

The plan may also be simpler. For example, the plan may include a list of targets. Optionally, the plan includes a desired order or partial order on at least two or all targets. Optionally or alternatively, the plan includes a time delay between two or more targets. Optionally or alternatively, the plan includes one or more measurement for confirmation and/or aiding in further application of plan, between targets.

In some embodiments, the plan includes information about the target, for example, location, nearby landmarks, indication on image, access path, location from which to treat, measurements to confirm that target is reached (e.g., electrical activity of target or of nearby tissue) and/or time (e.g., relative to body cycle or trigger) during which treatment and/or measurement should be applied.

In some cases the plan is pharmaceutical, possibly purely pharmaceutical, optionally using oral, surface, IV (or other transcuteneous) and/or direct injection. Optionally, the plan includes dosing information, a range of doses and/or a suggested ramping plan.

In some embodiments the plan includes several alternatives for treating GP, for example, ablation and injection of drug and electrical stimulation. Optionally, parameters for one or more of these treatments are included.

FIG. 11C is a flowchart of a method 1130 of generating a treatment plan, in accordance with some exemplary embodiments of the invention. While this method is desirably carried out by a processor using databases, this need not be the case and in some cases may be followed, with some changes (e.g., databases accessed manually) by a human.

Optionally, at 1132, one or more efficacy parameters (e.g., as described above) are optionally selected or otherwise defined (e.g., from a menu or automatically, for example, based on a matching between disease and considerations) and/or allowable values set.

Optionally, at 1134, one or more side effect parameters are optionally selected or otherwise defined, for example, in a similar manner.

Optionally, at 1136, the space of possible treatments is generated and/or searched to identify one or more possible treatment targets or series of targets. Optionally, targets which exceed allowed values are not considered and/or given a lower score.

For example, for a given condition, one (human or machine) can determine whether it is better (e.g., by selection of target) to affect efferent or afferent activity from an organ that is either generating pathological input or responding in a pathological way to a normal input. In exemplary embodiments of the invention, the use of a model allows the selection of an intervention depending if it is better to affect the system efferent or afferent and depending on the level of intervention desired (e.g., organ level, sub-system level, sub-organ level). In some cases the intervention should be applied to targets that are more remote from the pathologic organ or system as one would like to address the system effect of a local disease, or the systemic effect of a local treatment. For example, a local effect can be a specific receptor that can be blocked and the model can indicate the distribution of the specific sub type of the receptor that can be blocked for example using a drug and thus its effect. For example the use of highly selective BETA 1 receptor agonist will allow a certain effect to take place compared to the use of a selective BETA 2 blocker.

At 1138, such found solutions or treatments are optionally graded. Optionally, different considerations are given different weights.

At 1140, user input is optionally solicited, optionally to choose between proposals and/or fine tune or provide considerations to use in grading.

At 1142 one or more plan are optionally generated and include, for example, human and/or machine readable information to guide one or more of navigation, order and selection of acts, decision making, treatment parameters, timing expected and/or allowed, values expected and/or allowed for measurements and/or activities, safety and/or post-plan activities. As noted above, values need not be in the form of thresholds, but can be calculable, relative, fuzzy, defined as patterns and/or be otherwise indicated. A plan may be provided with a 2D anatomical and/or schematic map and/or may include settings for stimulations and/or other conditions to apply during treatment.

In a first example, of Renal Hypertension—a process is hypothesized as follows. There is a stenosis of the renal artery—the stenosis causes a reduction of the blood pressure in the distal part of the artery, past the stenosis. The sensors of the ANS that measure the pressure in the renal artery sense a lower blood pressure and transmit an Afferent signal that propagates in a divergent way toward higher ganglia. This message of “low blood pressure”, activates a reflex that causes increased sympathetic discharge and reduced parasympathetic discharge. This reflex sent to all the rest of the body organs is causing increased cardiac output, increased activation of the renin angiotensin system, increased in certain brain hormones that will increase levels of Anti Diuretic hormone (ADH). All the effects will lead to increase systemic blood pressure (so that the local post-stenotic sensing can be “correct”). The treatment of this patient can be achieved in multiple ways including opening the stenosis part of the renal artery, or ablating the pressure sensors of the renal artery or ablating the ganglia that is most proximal to the renal artery, thereby preventing the generation of this “low pressure” signal.

Another example relates to an intervention that eliminates the deleterious effect of the Efferent part of the ANS, for example, in patients with peripheral artery disease (PAD). The arteries in the affected limb are affected by a disease that leads to blockage of the artery due to diffuse atherosclerosis. The narrowed arteries fail to deliver the amount of blood needed for the patient to supply the muscles of the extremity at the beginning at extreme exercise. As PAD progresses and the arteries become even more narrow, the lack of sufficient perfusion to the muscle will be triggered at lower levels of exercise. The treatment of PAD is complex mainly due to the diffuse nature of the disease which prevents the use of stents (such stents are long and ted to break. The other known therapy is abdominal symathetectomy (for treating lower extremity PAD patients). As this is far from the treated organ, there are significant side effects all over the lower body, such as issues with micturition, ejaculation and intestinal motility. In some exemplary embodiments of the invention, the GPs to ablate are selected (and optionally imaged and/or tested first, for example, using a stimulating/cold needle inserted transcutenously) to balance efficacy and side effects.

FIG. 11D is a flowchart of a method 1150 of applying treatment, in accordance with some exemplary embodiments of the invention.

Optionally, at 1152 a plan is selected, for example, from a set of plans provided by the planning system. Optionally, selection is after viewing the plans on a treatment station which is programmed to read, display and/or follow the plans (e.g., generate alerts when the plan is not followed, indicate targets and/or generate stimulations and/or take measurements as indicated by the plan).

Optionally, at 1154, the plan is applied.

Optionally, at 1156 the plan application may be modified, within the plan guidelines and/or alternatives, for example, based on patient response and/or convenience for the operating physician.

At 1158, data is optionally collected, for example, in accordance with the plan. Optionally, the plan includes one or more measurement commands which indicate which data is to be collected and/or desired parameters for such data. Optionally, the command includes actual commands for a measurement device (e.g. if part of the ablator). Optionally or alternatively, a translation between such commands and actual commands understood by a measurement system are provided by the treatment system.

At 1160, further plan guidelines may be followed (e.g., for a complex plan.

At 1162, the plan may be modified beyond its predefined parameters, for example, based on physician oversight and/or due to unexpected patient physiological response.

In some exemplary embodiments of the invention, the plan may be carried out using a treatment apparatus (e.g., an ablation system, with a display). In some exemplary embodiments of the invention, the apparatus includes a volatile and a non-volatile memory and has a network connection or data plug in (e.g., for a memory storage device, e.g., via USB). Optionally, the display is used to indicate to the operator a preferred set of targets (optionally with an image or model or schematic model as a background) generated for example as described herein. Optionally, one or more parameters of the targets are shown as well.

In some embodiments, the treatment system is embodied as a disposable device, for example, as a catheter with a Target Generating ability. Optionally, the generation is actually at a remote location, but the generation is at the “request” of the catheter and/or using authorization provided by the catheter. Optionally, the targets are generated one by one based on the results of treatment or non-treatment of a previous target, which results are optionally acquired by the catheter or by a control unit (e.g., connected to an ECG sensor). In some exemplary embodiments of the invention, the catheter includes a memory storage element and/or a sensor to collect information from its tip or other part thereof to allow a decision system or a physician to decide on the role of a certain GP in the model. For example, a catheter that can record electrical activity, or photo acoustic signal that correspond to the afferent activity and or the efferent activity may be used to collect signals which can be compared against what is proposed to be acquired by the treatment plan, for example, based on a generated and/or populated model. A knowledge of the balance (ratio) of the two activities as a function of the state of the patient may allow a determination of the impact of a treatment at a certain site (e.g., did it affect the afferent signals more than efferent signals). As noted above, each intervention level (e.g., in the GP hierarchy/distance from organ) may have a different effect of the disease of a given patient. Optionally or alternatively, the catheter has storage thereon with information about the patient. In some exemplary embodiments of the invention, when the catheter is connected to the system it is preloaded with the patient information and/or treatment plan. Optionally or alternatively, the catheter is used as an authorization device to download such information from a remote location, for example, using a circuit on the catheter as part of a challenge response system and/or to store an access code. Optionally or alternatively, the catheter is notified by the system of its position in relationship to the patient anatomy, so the catheter can retrieve the relevant treatment parameters for applying at that location.

FIG. 11E is a schematic block diagram of a treatment system, in accordance with some embodiments of the invention, which may be used, for example, for the method described above. As shown a treatment management system 1170 may be used with an ablator (e.g., a catheter) 1172.

In an exemplary embodiment of the invention, Management system 1170 includes one or more of the following components, which may be implemented as separate modules and/or circuitry components and/or two or more of which may be combined:

(a) a plan storage 1174 storing one or more plans to be carried out.

(b) one or more watchdogs 1180, for example, for detecting safety violations and/or violations of plan parameters.

(c) a plan tracker 1176 which tracks progress according to the plan and/or decisions made and/or data collected.

(d) a positioning component 1178, for example, which determines and/or reports the position of a catheter or other probe, for example, relative to a different system component and/or relative to one or more anatomical landmarks.

(e) an ablation control component 1186 which controls one or more ablation parameters, such as time, power and/or spatial and/or temporal envelope. Optionally, this component includes a field generator for use by the ablation device.

(f) a measurement control component 1188, which may be used, for example, to initiate collection and/or collect measurement data.

(g) a device I/O component, for example, for communicating with catheter 1172 and/or other attached devices (e.g., an ECG monitor or an imaging system).

(h) a communication component 1194, for example, for receiving data and/or data analyses from a remote location and/or generating reports thereto and/or communicating with other systems, such as a patient scheduling system, for example, in the form of an internet connection.

(i) an alert subsystem 1190, for example, for generating alerts to a user and/or alerts at a later time to a patient.

(j) a display and/or other UI components 1184, for interacting with a user.

(k) a data analysis component 1182 which can, for example, analyze data results, analyze a position of a catheter to determine its compliance with ablation parameters and/or perform other analysis and/or decision functions.

As noted above, an ablator 1172 can be in the form of a catheter and may include a memory 1195 (e.g., in device, device handle and/or connection to management system) which stores thereon plan details and/or authorization to access a plan. Optionally, ablator 1172 includes one or more sensors 1198, for example, an electrical activity sensor. In an exemplary embodiment of the invention, ablator 1172 includes an ablator element 1196, for example an electrode or RF antenna. In some embodiments, ablator 1172 includes both temporary ablation means (e.g., a cooling element) and permanent ablation means (e.g., a cooling element, possibly same one or an RF antenna).

### Examples of Model-Based Treatment

Following are some exemplary methods of treating a patient condition using an ANS model, one or more of which may be used in accordance with some embodiments of the invention.

In some embodiments, the ANS model is used for diagnosis and then treatment is based on the diagnosis, optionally with no further reference to the model. In one example, an ANS model is used to indicate locations for acupuncture or for vagal nerve stimulation (e.g., tragus stimulation) which may be expected to be effective for certain disease conditions. For example activating the parasympathetic system via one of its branches that are easy to reach, or are specific to a certain condition, or are such that activating them have less unwanted side effects, will help deliver the inhibitory (parasympathetic input) to suppress overactive sympathetic ganglia or organ. In another example, general stimulation may be applied at a high level (such as the vagus nerve) and negative effects of such high level and less specific stimulation are counteracted by stimulation and/or ablation of sympathetic and/or parasympathetic ganglions or axons at a more local level, for example, adjacent to an organ adversely affected by the high level stimulation. In another example, adverse effects of a systemic drug are counteracted by local stimulation. A combination of high level drugs and stimulation may be applied as well, optionally together with more local stimulation and/or ablation at organs to be treated and/or protected form side effects.

In an exemplary embodiment of the invention, a machine learning method which is applied on collected data is used to classify patients as to which therapy is expected to work and/or parameters of such a therapy (e.g., predicting response to beta blockers).

In one example, Thyrotoxicosis, the reason for hyperactivity of the thyroid gland may be either infection or an idiopathic reason. Identifying an over activity of the nerves supplying the sympathetic nerve endings in the gland will suggest an ANS related mechanism. In an exemplary embodiment of the invention, a stimulation approach is used, whereby the parasympathetic system is activated to oppose the effects of the hyperactive sympathetic portions, or an ablative therapy is used to decrease the sympathetic input to the gland.

In some examples, the model is used to identify that there is a problem requirement treatment. Imaging and/or model making may be used, for example, for screening, for example, in a cardiac patient screening may be applied to detect other cardiac or ANS related problems that the patient may be suffering from and/or which may interact with other treatment thereof.

In some examples, the model is used to identify a category of the diseases, for example, Thyrotoxicosis, as discussed above. Different categories of diseases may include, for example, one or more of ANS:non-ANS, sympathetic:parasympathetic and/or ganglion:multi-ganglion.

In some examples, analysis of the model can indicate which interventions may work, which may fail (optionally how) and/or probabilities therefor and/or for side effects. In one example, a drug may be indicated if the disease is caused by over activity of several ganglions and where reducing the activities of other ganglions is not expected to have a significant adverse effect. As noted above, simulation can be used to predict the effect of ablation. Optionally or alternatively, simulation may be used to predict the effect of surgical intervention.

In some examples, the model is used to indicate an anatomical location (or several) which may be treated and/or an expected benefit and/or side effect thereof. This may assist in choosing between different interventions with different risk factors.

In some examples, therapy is guided by simulating what the new equilibrium (and/or extreme behavior) of the ANS and/or organ may be expected to be after therapy.

In some embodiments, guiding therapy comprises overlaying or otherwise indicating or merging on an image both the location of a needle, catheter or other tool and the relevant parts of the ANS and/or organ being treated. Such indication is optionally schematic.

In some embodiments of the invention, therapy is selected to selectively affect sympathetic or parasympathetic nerves and/or ganglion, for example, based on a model analysis and/or model anatomy.

In some embodiments, therapy is selected to modify the balance between sympathetic and parasympathetic activity, at least in some parts of the ANS. Optionally, the therapy is a balancing therapy set to restore an original balance. In some cases, for example, due to organ malfunction or existing triggers, a different balance may be sought.

It should be noted that in some cases therapy is selected for a short term effect, for example, to stop a vicious circle of ANS activity driving organ activity driving ANS activity. Optionally or alternatively, therapy is selected for a desired long term effect, for example, to reduce ANS activity in an organ for a long enough time to encourage remodeling of the organ. For example, therapy may assume that remodeling will take 1-10 hours, 1-10 days, 1-10 weeks or smaller or intermediate durations to be noticeable and/or have a clinically significant effect.

In some exemplary embodiments of the invention, treatment may use feedback in addition to or instead of a model. The model may also be updated in real time, for example, if the therapeutic process itself generates data, such as response to triggers, and/or if there is ongoing data collection.

In one example, ablation of a ganglion is continued or stopped based on an effect of such ablation on its activity and/or the activity and/or responsiveness of other body parts. Optionally, model simulation is used to model an expected activity after the tissue reactions to ablation wear off. Optionally, actual ablation is preluded by temporary ablation (e.g., using cold or an electric current). “Testing” of other ANS components may require waiting for any temporary effect to wear off.

In one example, a catheter with a radioactivity detector is used. It is expected that ablating an MIBG-uptaking ganglion will cause release of MIBG, allowing the mapping of radioactivity level to nervous activity level. Optionally, the readings at an untreated ganglion are used for calibrating the effect.

In another example, electrical activity measurements of an organ (e.g., the stomach, intestines or the heart) indicate the effect of ablating or temporarily ablating an ANS component.

One example of a specific treatment includes treatment of atrial fibrillation, where overactive ganglions near the left atrium may be ablated to reduce reactivity of the muscle and reduce fibrillation and/or ectopic activations.

One example of a specific treatment includes treatment of diabetes, where overactive ganglions near the pancreas may be ablated to reduce reactivity of the beta cells. In another example, obesity is treated, where the hyperactive ganglions to have activity thereof reduced may be located next to the gastric artery.

One example of a specific treatment includes treatment of auto-immune diseases, such as rheumatoid arthritis or Lupus. In some exemplary embodiments of the invention, ablation of one or more ganglion and/or axons near the spleen are used to reduce immune system activity level. Optionally, the ablation type used is such that ablated nerve tissue regrows and the ablation is applied when signs of an attack of the disease appear.

One example of a specific treatment includes treatment of glaucoma, where ablation of ganglions near eye may reduce pressure buildup.

One example of a specific treatment includes body reshaping, where innervations of fat cells are ablated or otherwise treated so that innervations is increase or decreased, potentially increasing or reducing fat storage therein over time.

One example of a specific treatment includes erectile dysfunction, where ANS components in the groin region may be treated to, for example, increase reactivity to sexual stimulation and/or enhance blood flow and/or venous blocking. This may also be used for female sexual dysfunction, for example, to increase fluid flow in the vagina.

One example of a specific treatment includes obesity, where ANS components associated with the stomach and/or other parts of the digestive system may be treated to, for example, increase reactivity to food stimulation and/or enhance or reduce blood flow and/or muscle activity and/or hormone release. In some exemplary embodiments of the invention, the above described imaging methods are used to identify ganglions (possibly one) associated with the gastric artery and/or located between the aorta and the stomach.

One example of a specific treatment includes hypertension, where, in addition to or instead of renal and carotid stimulation, major blood vessels are stimulated and/or ablated to control blood pressure. Optionally or alternatively, general reduction in ANS activity (e.g., of both sympathetic and parasympathetic or only of sympathetic) is used to reduce blood pressure.

One example of a specific treatment includes cancer, where ANS components activity level may be manipulated, for example, to compensate for adverse effects caused by physical or chemical properties of the tumor and/or to correct for effects of cancer therapy. In some cases, ANS components coupled to the cancerous tissue are controlled to reduce organ activity in tissue surrounding a tumor. Local injury may be treated in a similar manner, for example, using temporarily implanted electrodes or a drug eluting device, selected and/or positioned to effect one or more target ANS component associated with the injury and/or a compensatory mechanism therefor.

In some exemplary embodiments of the invention, inflammation is treated by reducing activity of ANS components directly affected by the inflammation. Optionally or alternatively, systemic inflammation may be reduced, for example, by affecting ganglions associated with the spleen. It is hypothesized that the ganglion(s) of the spleen send sympathetic activity to spleen and cause proliferation of certain immune cell lines associated with immune disease response. Ablating the hyperactive ganglions and/or otherwise reducing their activity (e.g., ablating axons or local delivery of treatment) may reduce the number of circulating immune cells causing the autoimmune disease condition.

In some cases, a vicious circle may occur. For example, a herpes virus (or other original cause) may affect an ANS component causing it to become more excitable. This may cause additional activity of other ANS components and/or other tissue, which will then further excite the affected ANS component. In some exemplary embodiments of the invention, ablation or other modulation of a ganglion or axon are used to interrupt this viscous circle, at least for a “rest” period of time.

In an example of diagnosis of Printzmetal angina, it is hypothesized that angina pain and/or vascular spasm is caused by ANS activation. Imaging with or without triggering may be used to detect over active ANS components and/or underactive and/or under- or over-reactive ANS components, to treat.

In an example of diagnosis and/or treatment of heart failure, it is noted that the cause is often unknown (e.g., no mechanical blood flow problems). It is hypothesized that in at least some cases heart failure is caused by ANS malfunction. This is further indicated by the fact that beta-blockers have a positive effect. In an exemplary embodiment of the invention, treatment is by increasing parasympathetic activity and/or reducing sympathetic activity, optionally by ablating one or more ganglions. As a possible mechanism in the case of heart failure, the efferent stimuli associated with local ischemia or local stretch receptors are conveyed via ANS sympathetic and parasympathetic afferent into the Ganglia. In case they are hyperactive ganglia (they may become hyperactive mainly after they have been stimulated for a long period of time (sometimes because of a primary heart disease); these hyperactive ganglia stimulate the sympathetic afferents in a very intense way to increase local metabolism in the heart and increase the stress and accelerate the failing of the myocardium; potentially leading to apoptosis. In an exemplary embodiment of the invention, treatment is by modulating sympathetic and/or parasympathetic activity to prevent or reduce this positive feedback.

Optionally, an ANS model-based approach is used for titrating the beta blocker dose for heart failure patients, for example, by modifying the dose according to the effect predicted by the model, the model optionally including data acquired by, for example, functional imaging.

In an exemplary embodiment of the invention, a product sold to an end-user is an angiographic analysis with additional ANS imaging and analysis.

In one example of a business model, request for model analysis are sent from a device, such as an angiographic device. Such requests are received by a remote server which provided appropriate model analysis for ANS data. Optionally or alternatively, a plurality of analysis requests are pre-purchased and a billing server, for example, keeps track of use thereof.

In an example of a specific treatment and/or diagnosis, beta blockers (optionally in combination with MIBG) are provided to an asthma patient. If this has a significant effect on breathing ability, imaging for locating and assessing ganglions associated with the lungs is carried out. Optionally, the assessment is repeated for situations with and without beta blocker (or other stimulant) application.

In an example of a treatment method, one or more ganglions or axons is ablated. Optionally, ganglion ablation is selected for longer term effects, with ablation of higher level ganglions optionally expected to have a longer term effect than that of lower level ganglions.

As noted above, ablation (or other treatments) may be used to increase or decrease activity. For example, activity may be increased by ablating a ganglion in charge of reducing activity levels.

In another example, drugs, for example eluted by an implant, optionally a controllable drug pump, may be used to deliver ANS-affect drugs to a target ANS component. Example families of drugs include Sympathetic stimulators and blockers, and parasympathetic stimulators and blockers. If correct targeting is used (e.g., based on a model), the volume of active material(s) needed for treatment per target region may be quite small, for example, less than 1 cc/month, less than 0.5 cc/month or less than 0.1 or 0.01 cc/month, or intermediate amounts.

In another example, a long-term acting drug is injected. For example, botulism toxin may be injected into a GP or nerve bundle to temporarily block such a nerve. The duration of such blockage may be several months. Optionally, first a short-acting material is injected and an effect on ANS activity and/or organ and/or other physiological indicators are determined. Then a more permanent dose is injected. It is hypothesized that in many disease conditions, significant improvement can be achieved by preventing the ANS from exacerbating a situation. Such prevention can be, for example, by injecting a toxin into part of the ANS so ANS behavior is dampened, increased and/or otherwise changed in a way that is not compatible with exacerbation, or at least not the exacerbation taking part in the disorder. After a few weeks or months, the condition may change or improve to a degree sufficient such that reactivation of the “suspended” parts of the ANS do not cause exacerbation. In an exemplary embodiment of the invention, injection is between 1 and 200 units, for example, between 20 and 100 units, for example, about 50 units, per GP. Optionally, the injection is in a fluid volume of between 0.1 and 3 ml, for example, about 1 ml. Optionally, after injection a further injection (e.g., saline) is used to spread the toxin. Optionally or alternatively, prior to injection one or more channels are formed in or near the GP for supporting travel of toxin therethrough

In another example, an electrical controller (e.g., a pacemaker, with suitable pulse parameter settings) is used to selectively electrify one or more ANS components, optionally in a synchronized way. Such electrification may be set, for example, to increase or decrease activity. Such a device may be, for example, external or internal or external with internal electrodes. In some cases, ultrasonic waves or RF waves are used to selectively excite or depresses ANS component activity.

Any or all of the above treatments may be combined and/or may use feedback to control their operation. In some exemplary embodiments of the invention, implantation of an electrical or chemical controller are guided by NM imaging, showing activity of ganglions. Optionally, a radioactive marker is provided on the device to assist in implantation. Optionally, such marker is designed to be removed by the body, for example, it being coupled to a water soluble or a metabolizable or excretable material.

### General

As used herein, the term “processor” or “module” may include an electric circuit that performs a logic operation on input or inputs. For example, such a processor/module may include one or more integrated circuits, microchips, microcontrollers, microprocessors, all or part of a central processing unit (CPU), graphics processing unit (GPU), digital signal processors (DSP), field-programmable gate array (FPGA) or other circuit suitable for executing instructions or performing logic operations.

In the methods described herein, computer implemented steps (such as accessing data, analyzing results and/or searching) may be performed by such modules and/or executed on one or more processor.

The instructions executed by the processor/module may, for example, be preloaded into the processor or may be stored in a separate memory unit such as a RAM, a ROM, a hard disk, an optical disk, a magnetic medium, a flash memory, other permanent, fixed, or volatile memory, or any other mechanism capable of storing instructions for the processor/module. The processor(s)/modules may be customized for a particular use, or can be configured for general-purpose use and can perform different functions by executing different software.

If more than one processor is employed, all may be of similar construction, or they may be of differing constructions electrically connected or disconnected from each other. They may be separate circuits or integrated in a single circuit. When more than one processor is used, they may be configured to operate independently or collaboratively. They may be coupled electrically, magnetically, optically, acoustically, mechanically or by other means permitting them to interact.

Optionally, such a processor is in electrical communication with one or more input elements, for example, a keyboard, a mouse, a graphical user interface (GUI), a touchscreen, a microphone for voice recognition, or other input devices. Input elements may be configured to receive inputs from a system operator, e.g., a physician.

Optionally, the processor is in electrical communication with a network, for example, the internet, a local hospital network, a distributed clinical network, or other networks. One or more remote servers may perform some or all of the processing, may store data, may provide upgrades, and/or may be used by remote operators.

Components of the systems and/or sub-systems described herein may be sold together and/or in parts. For example, modules may be sold as software for installation on an existing workstation, for example, downloaded from a network and/or provided on a memory. In another example, a processor, memory, and modules are sold together, for example, as a workstation. In another example, a complete system is sold.

In some embodiments, components of the system may be provided at different locations and/or as separate devices, e.g., data of the detected nervous tissue may be obtained by module(s), stored on a data repository and send to a diagnosis system. The data of the detected nervous tissue may be obtained before the treatment starts.

It is expected that during the life of a patent maturing from this application many relevant spatial and functional data collection methods will be developed and the scope of the terms “imaging” and “data acquisition” are intended to include all such new technologies a priori.

For example, functional data (e.g., SPECT data) may be, for example, a SPECT image captured by a suitable SPECT modality, for example, electrocardiogram-gated SPECT (GSPECT) modality, A-SPECT, SPECT-CT, and/or D-SPECT™ of Spectrum Dynamics modality. The specifications of these modalities are incorporated herein by reference.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers (also) to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes one or more of abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A non-transitory data storage medium having stored thereon a model or an image of a part of an autonomous nervous system (ANS) personalized for a particular patient, said model or image including at least one ganglion indicator.

2. A non-transitory data storage medium according to claim 1, wherein said ganglion indicator comprises a ganglion ID.

3. A non-transitory data storage medium according to claim 1, comprising at least one location indicator indicative of the location of said at least one ganglion.

4. A non-transitory data storage medium according to claim 3, wherein said at least one location indicator indicates the location relative to an anatomical landmark.

5. A non-transitory data storage medium according to claim 4, wherein said at least one location indicator comprises one or both of
an association with an organ portion or function and
a functional connection with another ganglion.

6. A non-transitory data storage medium according to claim 1, comprising dynamic data associated with at least one of said at least one ganglion.

7. A non-transitory data storage medium according to claim 6, wherein said dynamic data comprises data for interaction between a ganglion and one or more of an additional ganglion, organ function, body physiology and a trigger.

8. A non-transitory data storage medium according to claim 1, comprising link data associated with at least one of said at least one ganglion, said link data comprising a functional link.

9. A non-transitory data storage medium according to claim 1, comprising input data associated with the model or image, said input data being indicative of inputs which affect the model or image.

10. A non-transitory data storage medium according to claim 1, comprising innervation data associated with the model or image.

11. A non-transitory data storage medium according to claim 10, wherein said innervation data comprises a linkage 44 between organ portions and a ganglion.

12. A non-transitory data storage medium according to claim 10, wherein said innervation data comprises data indicative of an intensity of innervation of an organ portion.

13. A non-transitory data storage medium according to claim 1, wherein said at least one ganglion comprises a plurality of ganglions arranged as a network.

14. A non-transitory data storage medium according to claim 1, wherein said at least one ganglion indicators comprises a plurality of ganglion indicators stored as a set of parameters for a model of a portion of the ANS.

15. A non-transitory data storage medium according to claim 1, comprising a set of parameters for a model of at least a portion of an organ associated with said ganglions.

16. A non-transitory data storage medium according to claim 1, wherein said at least one ganglion indicator include a plurality of ganglion indicators, indicating ANS ganglions separated at least one synapse from a spinal column and brain.

17. A non-transitory data storage medium according to claim 1, wherein said at least one ganglion indicator includes a plurality of ANS ganglion indicators, each indicating a ganglion of a size between 1 and 10 mm in maximum diameter.

18. A non-transitory data storage medium according to claim 1, comprising an indication of a person from which the model or image was acquired.

19. A non-transitory data storage medium according to claim 1 further storing thereon a treatment plan including an indication of at least one target linked to said model or image of a part of an ANS.

20. A non-transitory data storage medium according to claim 19, wherein said indication of at least one target includes an indication of location indicated using a map, image or anatomical coordinates.

21. A system comprising:
a non-transitory data storage medium according to claim 1, and
a processor device; and
a display device, said processor device being configured to generate a display on said display device using said at least one ganglion indicator.

22. A system comprising a processor device configured to process radioactive emission data to generate a non-transitory data storage medium according to claim 1.

23-27. (canceled)

28. A method of generating body data, comprising creating, by a processor, a model of a portion of the autonomous nervous system (ANS) personalized for a particular patient including a plurality of ganglions associated with an organ or a portion thereof.

29. A method according to claim 28, wherein said model includes the functionality of at least a portion of said organ.

30. A method according to claim 28, wherein creating a model comprises creating a model of behavior of at least one of said plurality of ganglions.

31. A method according to claim 28, wherein creating a model comprises assuming a certain behavior characteristic of at least one ANS component.

32. A method of obtaining a model of a portion of an ANS of a person, comprising:
acquiring data from a portion of body of said person; and
extracting data relating to the ANS of the person from the acquired data.

33. A method according to claim 32, wherein said acquiring comprises acquiring radioactive emission data.

34. A method according to claim 32, wherein said extracting comprises extracting data based on one or both of a model of an organ for which said model is acquired and an expected temporal behavior of components of the ANS.

35. A method according to claim 32, comprising stimulating said ANS in coordination with said acquiring.

36. A method according to claim 32, wherein said acquiring comprises acquiring image data and reconstructing an image based on said data and segmenting said image.

37. A method according to claim 32, comprising matching said extracted data to a model.

38. A method according to claim 32, comprising populating a model using said extracted data.

39. A method according to claim 32, comprising using said extracted data for one or both of
modeling behavior of ANS components and
modeling the relationship between ANS components.

40-62. (canceled)

63. A non-transitory data storage medium having stored thereon a set of ganglion indicators and at least one location indication for a ganglion associated with a ganglion indicator.

64-70. (canceled)
